(19) United States
(12) Patent Application Publication
(10) Pub. No.: US 2019/0186375 A1
(43) Pub. Date: Jun. 20, 2019

(54) Plasma-Distributing Structure and Directed Flame Path in a Jet Engine

(71) Applicant: Plasma Igniter, LLC, Bruceton Mills, WV (US)

(72) Inventors: Andrew D. Lowery, Morgantown, WV (US); James E. Smith, Bruceton Mills, WV (US); Wayne M. Serra, Avon Lake, OH (US)

(21) Appl. No.: 15/848,229

(22) Filed: Dec. 20, 2017

(51) Int. Cl. F02C 7/266; F23R 3/00; F23R 3/42; H01P 7/04; H01P 7/06; H05H 1/46; H05H 1/24

(52) U.S. Cl. CPC F02C 7/266; F23R 3/002; F23R 3/425; H01P 7/04; H01P 7/06; H05H 2001/2412; H05H 1/2406; F23R 2900/00009; F05D 2240/35; F05D 2260/99; H05H 2001/4645; H05H 1/46

(57) ABSTRACT

An example system can include a combustor of a jet turbine engine, a radio-frequency power source, a plasma-distributing structure, and a resonator having a first concentrator. The combustor can include one or more fins protruding into a combustion zone and can be configured to guide combustion of fuel along a flame path defined by the fin(s). The resonator can be configured to provide a plasma corona when excited by the power source. The plasma-distributing structure can be arranged within the combustor and proximate to the plasma corona, and can include a second concentrator. When the resonator is excited, the plasma corona can be provided proximate to the first concentrator. Further, when the plasma corona is provided proximate to the first concentrator and the plasma-distributing structure is at a predetermined voltage, an additional plasma corona can be established proximate to the second concentrator and at least partly within the flame path.

### CROSS-REFERENCE TO RELATED APPLICATIONS

The present application hereby incorporates by reference U.S. Pat. Nos. 5,361,737; 7,721,697; 8,783,220; 8,887,683; 9,551,315; 9,624,898; and 9,638,157. The present application also hereby incorporates by reference U.S. Patent Application Pub. Nos. 2009/0194051; 2011/0146607; 2011/0175691; 2014/0283780; 2014/0283781; 2014/0327357; 2015/0287574; 2017/0082083; 2017/0085060; 2017/0175697; and 2017/0175698. In addition, the present application hereby incorporates by reference International Patent Application Pub. Nos. WO 2011/112786; WO 2011/127298; WO 2015/157294; and WO 2015/176073. Further, the present application hereby incorporates by reference the following U.S. patent applications, each filed on the same date as the present application: “Plasma-Distributing Structure in a Resonator System” (identified by attorney docket number 17-1501); “Magnetic Direction of a Plasma Corona Provided Proximate to a Resonator” (identified by attorney docket number 17-1502); “Fuel Injection Using a Dielectric of a Resonator” (identified by attorney docket number 17-1505); “Jet Engine Including Resonator-based Diagnostics” (identified by attorney docket number 17-1506); “Power-generation Turbine Including Resonator-based Diagnostics” (identified by attorney docket number 17-1507); “Electromagnetic Wave Modification of Fuel in a Jet Engine” (identified by attorney docket number 17-1508); “Electromagnetic Wave Modification of Fuel in a Power-generation Turbine” (identified by attorney docket number 17-1509); “Jet Engine with Plasma-assisted Combustion” (identified by attorney docket number 17-1510); “Jet Engine with Fuel Injection Using a Conductor of a Resonator” (identified by attorney docket number 17-1511); “Jet Engine with Fuel Injection Using a Dielectric of a Resonator” (identified by attorney docket number 17-1512); “Jet Engine with Fuel Injection Using a Conductor of At Least One of Multiple Resonators” (identified by attorney docket number 17-1513); “Jet Engine with Fuel Injection Using a Dielectric of At Least One of Multiple Resonators” (identified by attorney docket number 17-1514); “Plasma-Distributing Structure in a Jet Engine” (identified by attorney docket number 17-1515); “Power-generation Gas Turbine with Plasma-assisted Combustion” (identified by attorney docket number 17-1516); “Power-generation Gas Turbine with Fuel Injection Using a Conductor of a Resonator” (identified by attorney docket number 17-1517); “Power-generation Gas Turbine with Fuel Injection Using a Dielectric of a Resonator” (identified by attorney docket number 17-1518); “Power-generation Gas Turbine with Plasma-assisted Combustion Using Multiple Resonators” (identified by attorney docket number 17-1519); “Power-generation Gas Turbine with Fuel Injection Using a Conductor of At Least One of Multiple Resonators” (identified by attorney docket number 17-1520); “Power-generation Gas Turbine with Fuel Injection Using a Dielectric of At Least One of Multiple Resonators” (identified by attorney docket number 17-1521); “Plasma-Distributing Structure in a Power Generation Turbine” (identified by attorney docket number 17-1522); “Jet Engine with Plasma-assisted Combustion and Directed Flame Path” (identified by attorney docket number 17-1523); “Jet Engine with Plasma-assisted Combustion Using Multiple Resonators and a Directed Flame Path” (identified by attorney docket number 17-1524); “Power-generation Gas Turbine with Plasma-assisted Combustion and Directed Flame Path” (identified by attorney docket number 17-1526); “Power-generation Gas Turbine with Plasma-assisted Combustion Using Multiple Resonators and a Directed Flame Path” (identified by attorney docket number 17-1527); “Plasma-Distributing Structure and Directed Flame Path in a Power Generation Turbine” (identified by attorney docket number 17-1528); “Jet engine with plasma-assisted afterburner” (identified by attorney docket number 17-1529); “Jet engine with plasma-assisted afterburner having Resonator with Fuel Conduit” (identified by attorney docket number 17-1530); “Jet engine with plasma-assisted afterburner having Resonator with Fuel Conduit in Dielectric” (identified by attorney docket number 17-1531); “Jet engine with plasma-assisted afterburner having Ring of Resonators” (identified by attorney docket number 17-1532); “Jet engine with plasma-assisted afterburner having Ring of Resonators and Resonator with Fuel Conduit” (identified by attorney docket number 17-1533); “Jet engine with plasma-assisted afterburner having Ring of Resonators and Resonator with Fuel Conduit in Dielectric” (identified by attorney docket number 17-1534); and “Plasma-Distributing Structure in an Afterburner of a Jet Engine” (identified by attorney docket number 17-1535).

### BACKGROUND

Resonators are devices and/or systems that can produce a large response for a given input when excited at a resonance frequency. Resonators are used in various applications, including acoustics, optics, photonics, electromagnetics, chemistry, particle physics, etc. For example, electromagnetic resonators can be used as antennas or as energy transmission devices. Further, resonators can concentrate a large amount of energy in a relatively small location (for example, as in the electromagnetic waves radiated by a laser).

Aircraft, including jets, can be used to transport cargo and/or passengers from one location to another at high velocities. By providing thrust using a jet engine or a propeller, aircraft can generate lift based on Bernoulli's principle. One way of powering a jet engine or a propeller includes combusting hydrocarbon fuel.

### SUMMARY

In a first implementation, a system is provided. The system includes a combustor of a jet turbine engine. The combustor includes (i) an interior wall defining a combustion zone, and (ii) one or more fins protruding into the combustion zone and configured to guide combustion of fuel along a flame path defined by the one or more fins. The system also includes a radio-frequency power source. The system also includes a resonator configured to be electromagnetically coupled to the radio-frequency power source and having a resonant wavelength. The resonator includes a first conductor, a second conductor, a dielectric between the first conductor and the second conductor, and an electrode. The electrode is configured to be electromagnetically coupled to the first conductor and includes a first concentrator. The resonator is configured to provide a plasma corona proximate to the first concentrator when excited by the radio-frequency power source with a signal having a wavelength proximate to an odd-integer multiple of one-quarter (¼) of the resonant wavelength. The system also includes a plasma-distributing structure including a second concentrator. The plasma-distributing structure is arranged within the combustor and proximate to where the plasma corona is provided by the resonator. When the radio-frequency power source excites the resonator with the signal, an electric field is concentrated at the first concentrator and the plasma corona is provided proximate to the first concentrator. Further, when the plasma corona is provided proximate to the first concentrator and the plasma-distributing structure is at a predetermined voltage, an additional plasma corona is established proximate to the second concentrator and at least partly within the flame path.

In a second implementation, a system is provided. The system includes a combustor of a jet turbine engine, the combustor including (i) an interior wall defining a combustion zone, and (ii) one or more fins protruding into the combustion zone and configured to guide combustion of fuel along a flame path defined by the one or more fins. The system also includes a radio-frequency power source. The system also includes a resonator configured to be electromagnetically coupled to the radio-frequency power source and having a resonant wavelength. The resonator includes a first conductor, a second conductor, a dielectric between the first conductor and the second conductor, and an electrode. The electrode is configured to be electromagnetically coupled to, and disposed at, a distal end of the first conductor. The electrode includes a concentrator disposed within the combustor and having a concentrator shape configured to define a shape of a plasma corona provided by the resonator. The resonator is configured such that, when the resonator is excited by the radio-frequency power source with a signal having a wavelength proximate to an odd-integer multiple of one-quarter of the resonant wavelength, the resonator provides the plasma corona proximate to the concentrator and at least partly within the flame path.

In a third implementation, a method is provided. The method includes exciting a resonator with a radio-frequency signal having a wavelength proximate to an odd-integer multiple of one-quarter of a resonant wavelength of the resonator, such that an electric field is concentrated at a first concentrator of the resonator and a plasma corona is provided proximate to the first concentrator. At least a portion of the resonator is disposed within a combustor of a jet turbine engine. The combustor includes (i) an interior wall defining a combustion zone, and (ii) one or more fins protruding into the combustion zone and configured to guide combustion of fuel along a flame path defined by the one or more fins. The method also includes providing a predetermined voltage at a second concentrator of a plasma-distributing structure that is arranged within the combustor and that is proximate to the plasma corona provided by the resonator, so as to establish an additional plasma corona proximate to the second concentrator and at least partly within the flame path.

Other implementations will become apparent to those of ordinary skill in the art by reading the following detailed description, with reference where appropriate to the accompanying drawings.

### BRIEF DESCRIPTION OF THE FIGURES

FIG. 1A illustrates a cross-sectional view of an internal combustion engine.

FIG. 1B illustrates an isometric view of an example quarter-wave coaxial cavity resonator (QWCCR) structure, according to example implementations.

FIG. 1C illustrates a cutaway side view of a QWCCR structure, according to example implementations.

FIG. 1D illustrates a cross-sectional view of a QWCCR structure, according to example implementations.

FIG. 1E is a cross-sectional illustration of an electromagnetic mode in a QWCCR structure, according to example implementations.

FIG. 1F is a cross-sectional illustration of an electromagnetic mode in a QWCCR structure, according to example implementations.

FIG. 1G is a plot of a quarter-wave resonance condition of a QWCCR structure, according to example implementations.

FIG. 2 illustrates a system that includes a coaxial resonator, according to example implementations.

FIG. 3A illustrates a system that includes a coaxial resonator, according to example implementations.

FIG. 3B illustrates a system that includes a coaxial resonator, according to example implementations.

FIG. 4A illustrates a system that includes a coaxial resonator, according to example implementations.

FIG. 4B illustrates a controller, according to example implementations.

FIG. 5 illustrates a cutaway side view of a QWCCR structure connected to a fuel pump and a fuel tank, according to example implementations.

FIG. 6 illustrates a cross-sectional view of an example coaxial resonator connected to a direct-current (DC) power source through an additional resonator assembly acting as a radio-frequency (RF) attenuator, according to example implementations.

FIG. 7 illustrates a cross-sectional view of an example coaxial resonator connected to a DC power source through an additional resonator assembly acting as an RF attenuator, according to example implementations.

FIG. 8 illustrates an aircraft having a jet engine, according to example implementations.

FIG. 9 illustrates a jet engine, according to example implementations.

FIG. 10A illustrates a combustor, according to example implementations.

FIG. 10B illustrates a combustor, according to example implementations.

FIG. 10C illustrates a combustor, according to example implementations.

FIG. 10D illustrates a combustor, according to example implementations.

FIG. 10E illustrates a combustor, according to example implementations.

FIG. 10F illustrates a combustor, according to example implementations.

FIG. 11 illustrates a partial view of a combustor, according to example implementations.

FIG. 12 illustrates air flow paths through a combustor, according to example implementations.

FIG. 13 illustrates a jet engine including an afterburner, according to example implementations.

FIG. 14A illustrates a side view of an example a plasma-distributing structure arrangement, according to example implementations.

FIG. 14B illustrates a side view of an example a plasma-distributing structure arrangement, according to example implementations.

FIG. 15A illustrates a system that includes a coaxial resonator, multiple plasma-distributing segments, a controller, and multiple DC power sources, according to example implementations.

FIG. 15B illustrates a system that includes a coaxial resonator, multiple plasma-distributing segments, a controller, a DC power source, and multiple switches, according to example implementations.

FIG. 16 illustrates multiple cross-sectional views of a combustion chamber that includes a plasma-distributing structure, according to example implementations.

FIG. 17A illustrates a cutaway view of a combustion chamber that includes a plasma-distributing structure, according to example implementations.

FIG. 17B illustrates a cutaway view of a combustion chamber that includes a plasma-distributing structure, according to example implementations.

FIG. 18 illustrates a cutaway view of a combustion chamber that includes a plasma-distributing structure, according to example implementations.

FIG. 19 illustrates a cutaway view of a combustion chamber that includes a plasma-distributing structure, according to example implementations.

FIG. 20 illustrates a cutaway view of a combustion chamber that includes a plasma-distributing structure, according to example implementations.

FIG. 21A illustrates a top-down view of a combustion chamber that includes a plasma-distributing structure, according to example implementations.

FIG. 21B illustrates a top-down view of a combustion chamber that includes a plasma-distributing structure, according to example implementations.

FIG. 21C illustrates a cutaway view of a combustion chamber that includes a plasma-distributing structure, according to example implementations.

FIG. 22 illustrates a cross-sectional view of a combustion chamber that includes a plasma-distributing structure, according to example implementations.

FIG. 23 illustrates a perspective view of a coaxial resonator, according to example implementations.

FIG. 24 illustrates a perspective view of a coaxial resonator, according to example implementations.

FIG. 25 illustrates a perspective view of a coaxial resonator, according to example implementations.

FIG. 26 illustrates a perspective view of a coaxial resonator, according to example implementations.

FIG. 27 illustrates a perspective view of a coaxial resonator, according to example implementations.

FIG. 28 illustrates a perspective view of a coaxial resonator, according to example implementations.

FIG. 29 illustrates a perspective view of a coaxial resonator, according to example implementations.

FIG. 30 illustrates a perspective view of a coaxial resonator, according to example implementations.

FIG. 31A illustrates a perspective view of a combustor, according to example implementations.

FIG. 31B illustrates cross-sectional views of a combustor, according to example implementations.

FIG. 31C illustrates cross-sectional views of a combustor, according to example implementations.

FIG. 31D illustrates cross-sectional views of a combustor, according to example implementations.

FIG. 31E illustrates cross-sectional views of a combustor, according to example implementations.

FIG. 32A illustrates a perspective view of a combustor, according to example implementations.

FIG. 32B illustrates an end view of a combustor, according to example implementations.

FIG. 32C illustrates a perspective view of a combustor, according to example implementations.

FIG. 32D illustrates a perspective view of a combustor, according to example implementations.

FIG. 32E illustrates a perspective view of a combustor, according to example implementations.

FIG. 33A illustrates a cross-sectional view of a fin, according to example implementations.

FIG. 33B illustrates a perspective view of a fin, according to example implementations.

FIG. 34A illustrates an end view of a combustor, according to example implementations.

FIG. 34B illustrates an end view of a combustor, according to example implementations.

FIG. 34C illustrates an end view of a combustor, according to example implementations.

FIG. 34D illustrates a cross-sectional view of a combustor, according to example implementations.

FIG. 35 is a flow chart depicting operations of a representative method, according to example implementations.

### DETAILED DESCRIPTION

Example methods, devices, and systems are presently disclosed. It should be understood that the word “example” is used in the present disclosure to mean “serving as an instance or illustration.” Any implementation or feature presently disclosed as being an “example” is not necessarily to be construed as preferred or advantageous over other implementations or features. Other implementations can be utilized, and other changes can be made, without departing from the scope of the subject matter presented in the present disclosure.

Thus, the example implementations presently disclosed are not meant to be limiting. Components presently disclosed and illustrated in the figures can be arranged, substituted, combined, separated, and designed in a wide variety of different configurations, all of which are contemplated in the present disclosure.

Further, unless context suggests otherwise, the features illustrated in each of the figures can be used in combination with one another. Thus, the figures should be generally viewed as components of one or more overall implementations, with the understanding that not all illustrated features are necessary for each implementation.

In the context of this disclosure, various terms can refer to locations where, as a result of a particular configuration, and under certain conditions of operation, a voltage component can be measured as close to non-existent. For example, “voltage short” can refer to any location where a voltage component can be close to non-existent under certain conditions. Similar terms can equally refer to this location of close-to-zero voltage (for example, “virtual short circuit,” “virtual short location,” or “voltage null”). In examples, “virtual short” can be used to indicate locations where the close-to-zero voltage is a result of a standing wave crossing zero. “Voltage null” can be used to refer to locations of close-to-zero voltage for a reason other than as result of a standing wave crossing zero (for example, voltage attenuation or cancellation). Moreover, in the context of this disclosure, each of these terms that can refer to locations of close-to-zero voltage are meant to be non-limiting.

In an effort to provide technical context for the present disclosure, the information in this section can broadly describe various components of the implementations presently disclosed. However, such information is provided solely for the benefit of the reader and, as such, does not expressly limit the claimed subject matter. Further, components shown in the figures are shown for illustrative purposes only. As such, the illustrations are not to be construed as limiting. As is understood, components can be added, removed, or rearranged without departing from the scope of this disclosure.

### I. Overview

A resonator can be configured to excite plasma and/or electromagnetic radiation. An example of such a resonator can include a center conductor and a larger, surrounding conductor, which could be separated by a dielectric insulator such as a ceramic material. A resonator configured in this manner can be used as an alternative to other types of igniters in a jet engine.

Using a resonator configured in this manner in a jet engine may be advantageous in a variety of ways. For example, a resonator configured in this manner can be controlled so as to provide a plasma corona in a combustion chamber of a jet engine. The plasma corona can be physically larger (for example, in length, width, radius, and/or overall volumetric extent) than a typical spark from a gap spark plug. The larger ignition area/volume could allow a more lean fuel mixture (also known as lower fuel-to-air ratio) to be burned within a combustion zone of the combustor, as compared with ignition using a gap spark plug. In addition, by using the plasma corona to ignite a fuel mixture within the combustor, stoichiometric ratio fuels may be combusted more fully, as compared with ignition using a gap spark plug. Combusting stoichiometric ratio fuels more fully can, in turn, create fewer regulated pollutants (for example, creating less NOₓ to be expelled as exhaust) and/or leave less unspent fuel.

Further, the above-referenced advantages may be achieved at decreased air pressures and temperatures when compared with the air pressures and temperatures in which a gap spark plug might be used as an ignition source. Hence, using a resonator configured in accordance with the present disclosure to assist with ignition in a jet engine may ease the air pressure and temperature requirements for combustion within the jet engine.

However, even with the above benefits of using a resonator as an ignition source in a jet engine combustor, there is still room for improvement. For instance, various operating characteristics of the jet engine, including fuel efficiency, thrust levels, emissions, and the engine's capability to respond to changes in fuel flow and air speed, may be improved by providing more efficient and thorough combustion of fuel in the combustor.

When fuel is ignited and combusted in a jet engine combustor, combustion may propagate along a flame path that leaves some unspent fuel in the combustor. For instance, combustion may propagate along an approximately straight path from one end of the combustor to the other end of the combustor. In such a scenario, the flame path may be so short that there is not enough time for the flame to completely combust all of the fuel before the fuel and the flame exit the combustor portion of the engine and enters the turbine portion. However, by guiding the flame path, an overall length of the flame path may be increased so that it takes longer for the flame and the fuel to propagate through the combustor, thereby allowing more fuel to combust in the combustor before it reaches the turbine.

In some implementations, a combustor of a jet turbine engine could be configured to include various types of fins that protrude into the combustion zone of the combustor in order to guide combustion of fuel along various elongated flame paths, such as flame paths that deviate from a straight path along the length of the combustor. Guiding combustion can allow a flame to propagate more thoroughly throughout the fuel/air mixture, which can reduce an amount of unspent fuel that exits the combustor through the turbine. Such a combustor could optionally include multiple resonators for providing multiple ignition points in the fuel. By providing multiple ignition points, the fuel may combust concurrently along multiple flame paths that, when considered together, amount to a longer overall flame path for the combustion. However, still further improvements to fuel combustion may be desirable.

Accordingly, the present disclosure provides a mechanism for even further increasing the ignition area/volume within the combustor described above. This mechanism can take the form of one or more “plasma-distributing structures” configured to distribute and sustain a plasma corona at various locations within the combustor, such as locations at least partly within the flame path(s) of the combustor.

A plasma-distributing structure can be arranged proximate to a location where a plasma corona will be excited, such as where a plasma corona will be excited at a resonator and/or at another plasma-distributing structure. The plasma-distributing structure can be at a predetermined voltage with respect to a reference voltage. The predetermined voltage can be selected to cause an electric field concentration that is suitable for excitation of a plasma corona at the plasma-distributing structure. Thus, if a plasma corona is excited at the location where the plasma-distributing structure is arranged, the excited plasma corona can trigger excitation of an additional plasma corona at the plasma-distributing structure, which could represent an extension and/or expansion of the excited plasma corona. As an example, a resonator can excite a plasma corona proximate to an elongated, blade-like plasma-distributing structure that is disposed within the flame path, which can trigger excitation of an elongated plasma corona along the plasma-distributing structure and at least partly within the flame path.

### II. Example Combustion

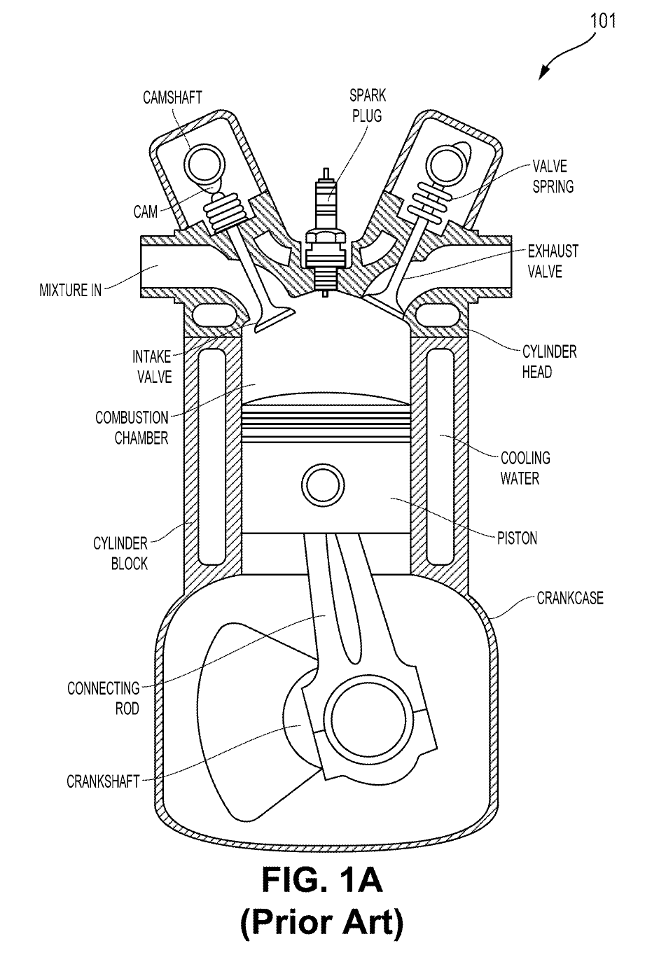

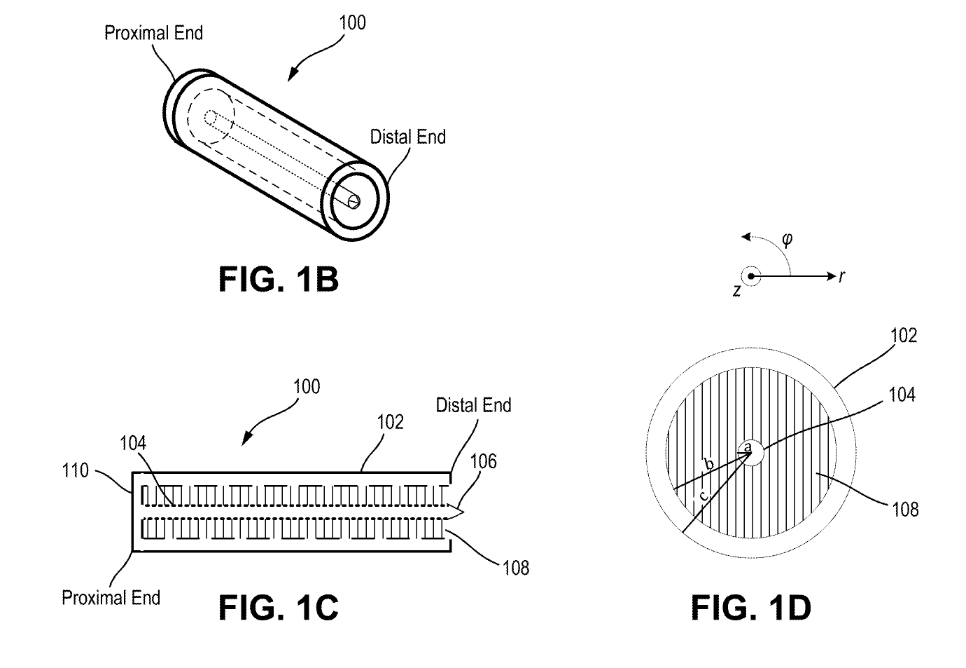

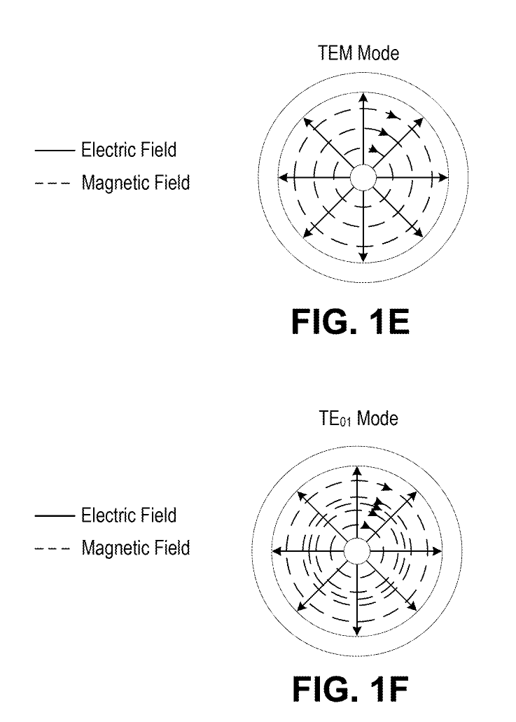

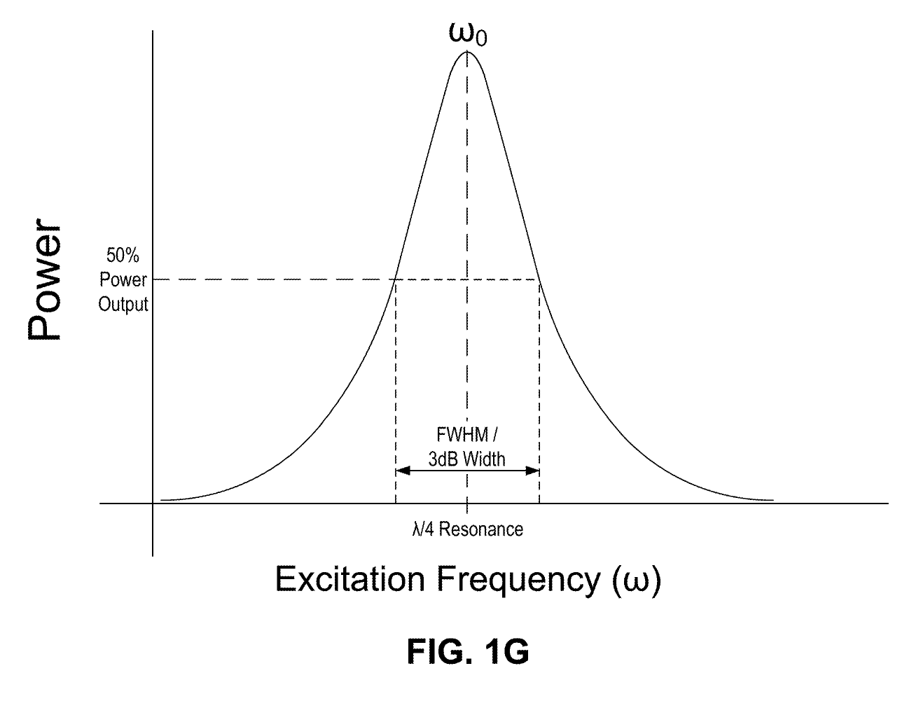

Igniters can be used to ignite a mixture of air and fuel (for example, within a combustion chamber of an internal combustion engine 101, such as that illustrated in cross-section in FIG. 1A). For example, igniters can be configured as gap spark igniters, similar to an automotive spark plug. However, gap spark igniters might not be desirable in some applications and/or under some conditions. For example, a gap spark igniter might not be capable of igniting and initiating combustion of fuel mixtures that have fuel-to-air ratios below a certain threshold. Further, lean mixtures of fuel and air might have significant environmental and economic benefits by making combustion (for example, within a combustor or an afterburner) more efficient, and thus, using a gap spark igniter might preclude achieving such benefits. In addition, higher thermal efficiencies can be achieved by operating at higher power densities and pressures. However, using more energetic or powerful gap spark igniters reduces overall ignition efficiency because the higher energy levels can be detrimental to the gap spark igniter's lifetime. Higher energy levels might also contribute to the formation of undesirable pollutants and can reduce overall engine efficiency.

While gap spark igniters are described above, other types of igniters can generally include glow plugs (for example, in diesel-fueled internal combustion engines), open flame sources (for example, cigarette lighters, friction spark devices, etc.), and other heat sources.

A variety of fuels (for example, hydrocarbon fuels) can be combusted to yield energy within an internal combustion engine, within a power-generation turbine, within a jet engine, or within various other applications. For example, kerosene (also known as paraffin or lamp oil), gasoline (also known as petrol), fractional distillates of petroleum fuel oil (for example, diesel fuel), crude oil, Fischer-Tropsch synthesized paraffinic kerosene, natural gas, and coal are all hydrocarbon fuels that, when combusted, liberate energy stored within chemical bonds of the fuel. Jet fuel, specifically, can be classified by its “jet propellant” (JP) number. The “jet propellant” (JP) number can correspond to a classification system utilized by the United States military. For example, JP-1 can be a pure kerosene fuel, JP-4 can be a 50% kerosene and 50% gasoline blend, JP-9 can be another kerosene-based fuel, JP-9 can be a gas turbine fuel (for example, including tetrahydrodimethylcyclopentadiene) specifically used in missile applications, and JP-10 can be a fuel similar to JP-9 that includes endo-tetrahydrodicyclopentadiene, exo-tetrahydrodicyclopentadiene, and adamantane. Other forms of jet fuel include zip fuel (for example, high-energy fuel that contains boron), SYNTROLEUM® FT-fuel, other kerosene-type fuels (for example, Jet A fuel and Jet A-1 fuel), and naphtha-type fuels (for example, Jet B fuel). It is understood that other fuels can be combusted as well. Further, the fuel type used can depend upon the application. For example, jet engines, internal combustion engines, and power-generation turbines may each burn different types of fuels.

When fuel (for example, hydrocarbon fuel) interacts with electromagnetic radiation, the fuel can change chemical composition. For example, when hydrocarbon fuel interacts with (for example, is irradiated by) microwaves, some of the hydrogen atoms can be ionized and/or one or more hydrogen atoms can be liberated from a hydrocarbon chain. The processes of liberating hydrogen within fuel, ionizing hydrogen within fuel, or otherwise changing the chemical composition of fuel are collectively referred to in the present disclosure as “reforming” the fuel. Reforming the fuel can include exciting the hydrocarbon fuel at one or more of its natural resonant frequencies (for example, acoustic and/or electromagnetic resonant frequencies) to break one or more of the carbon-hydrogen (or other) bonds within the hydrocarbon chain. When hydrogen within a hydrocarbon fuel becomes ionized and/or is liberated from the hydrocarbon chain, the resulting hydrocarbon fuel can require less energy to burn. Thus, a leaner fuel/air mixture that includes reformed fuel can achieve the same output power (for example, within a combustion chamber of a jet engine or a power-generation turbine) as compared to a more rich fuel/air mixture that includes non-reformed fuel, since the reformed fuel can combust more quickly and thoroughly. Analogously, when comparing equal fuel-to-air ratios, less input energy can be required to combust a mixture that includes reformed fuel when compared to a mixture that includes non-reformed fuel.

In addition to reforming fuels, electromagnetic radiation can alter an energy state of fuel and/or of a fuel mixture. In an example implementation, altering the energy state of fuel can include exciting electrons within the valence band of the hydrocarbon chain to higher energy levels. In such scenarios, raising the energy state can also include reorienting polar molecules (for example, water and/or polar hydrocarbon chains) within a fuel/air mixture due to electromagnetic fields applying a torque on polar molecules. Reorienting polar molecules can result in molecular motion, thereby increasing an effective temperature and/or kinetic energy of the molecule, which raises the energy state of fuel. By raising the energy state of fuel, the activation energy for combustion of the fuel can be reduced. When the activation energy for combustion is reduced, the energy supplied by the ignition source can also be decreased, thereby conserving energy during ignition.

Presently disclosed are ignition systems with resonators (for example, QWCCR structures) that use both RF power and DC power. The presently disclosed RF ignition systems provide an alternative to other types of igniters. For example, the QWCCR structure can be used as an igniter (for example, in place of an automotive gap spark plug) in the internal combustion engine 101. Such RF ignition systems can excite plasma (for example, within a corona). If an igniter is configured as one of the RF ignition systems presently disclosed, then more efficient, leaner, cleaner combustion can be achieved. Such increased combustion efficiency can be achieved at decreased air pressures and temperatures when compared with a gap spark igniter (for example, if the RF ignition system is used in a jet engine). Further, such increased combustion efficiency can be achieved at higher air pressures and temperatures when compared with a gap spark igniter. It is understood throughout this disclosure that where reference is made to “RF” or to microwaves, in alternate implementations, other wavelengths of electromagnetic waves outside of the RF range can be used alternatively or in addition to RF electromagnetic waves.

As described above, RF ignition systems can excite plasma. Plasma is one of the four fundamental states of matter (in addition to solid, liquid, and gas). Further, plasmas are mixtures of positively charged gas ions and negatively charged electrons. Because plasmas are mixtures of charged particles, plasmas have associated intrinsic electric fields. In addition, when the charged particles in the mixture move, plasmas also produce magnetic fields (for example, according to Ampere's law). Given the electromagnetic nature of plasmas, plasmas interact with, and can be manipulated by, external electric and magnetic fields. For example, placing a ferromagnetic material (for example, iron, cobalt, nickel, neodymium, samarium-cobalt, etc.) near a plasma can cause the plasma to be attracted to or repelled from the ferromagnetic material (for example, causing the plasma to move).

Plasmas can be formed in a variety of ways. One way of forming a plasma can include heating gases to a sufficiently high temperature (for example, depending on ambient pressure). Additionally or alternatively, forming a plasma can include exposing gases to a sufficiently strong electromagnetic field. Lightning is an environmental phenomenon involving plasma. One application of plasma can include neon signs. Further, because plasma is responsive to applied electromagnetic fields, plasma can be directed according to specific patterns. Hence, plasmas can also be used in technologies such as plasma televisions or plasma etching.

Plasmas can be characterized according to their temperature and electron density. For example, one type of plasma can be a “microwave-generated plasma” (for example, ranging from 5 eV to 15 eV in energy). Such a plasma can be generated by a QWCCR structure, for example.

### III. Example Resonator

An example implementation of a QWCCR structure 100 is illustrated in FIGS. 1B-1D. As illustrated, the QWCCR structure 100 can include an outer conductor 102, an inner conductor 104 with an associated electrode 106, a base conductor 110, and a dielectric 108. Also as illustrated, the QWCCR structure 100 can be shaped as concentric circular cylinders. The inner conductor 104 can have radius ‘a’, the outer conductor 102 can have inner radius ‘b’, and the outer conductor 102 can have outer radius ‘c’, as illustrated in cross-section in FIG. 1D. In alternate implementations, the QWCCR structure 100 can have other shapes (for example, concentric ellipsoidal cylinders or concentric, enclosed, elongated volumes with square or rectangular cross-sections). The inner conductor 104, the outer conductor 102 (or just the inner surface of the outer conductor 102), the electrode 106, and the base conductor 110 can be made of various conductive materials (for example, steel, gold, silver, platinum, nickel, or alloys thereof). Further, in some implementations, the inner conductor 104, the outer conductor 102, and the base conductor 110 can be made of the same conductive materials, while in other implementations, the inner conductor 104, the outer conductor 102, and the base conductor 110 can be made of different conductive materials. Additionally, in some implementations, the inner conductor 104, the outer conductor 102, and/or the base conductor 110 can include a dielectric material coated in a conductor (for example, a metal-plated ceramic). In such implementations, the conductive coating can be thicker than a skin-depth of the conductor at a given excitation frequency of the QWCCR structure 100 such that electricity is conducted throughout the conductive coating.

As illustrated, an electrode 106 can be disposed at a distal end of the inner conductor 104. The electrode 106 can be made of a conductive material as described above (for example, the same conductive material as the inner conductor 104). For example, the electrode 106 can be machined with the inner conductor 104 as a single piece. In some implementations, as illustrated, the base conductor 110, the outer conductor 102, the inner conductor 104, and the electrode can be shorted together. For example, the base conductor 110 can short the outer conductor 102 to the inner conductor 104, in some implementations. When shorted together, these components can be directly electrically coupled to one another such that each of these components is at the same electric potential.

Further, in implementations where the base conductor 110, the outer conductor 102, and the inner conductor 104 (including the electrode 106) are shorted together, the base conductor 110, the outer conductor 102, and the inner conductor 104 (including the electrode 106) can be machined as a single piece. In addition, the electrode 106 can include a concentrator (for example, a tip, a point, or an edge), which can concentrate and enhance the electric field at one or more locations. Such an enhanced electric field can create conditions that promote the excitation of a plasma corona near the concentrator (for example, through a breakdown of a dielectric, such as air, that surrounds the concentrator). The concentrator can be a patterned or shaped portion of the electrode 106, for example. The electrode 106, including the concentrator, can be electromagnetically coupled to the inner conductor 104. In the present disclosure and claims, the electrode 106 and/or the concentrator can be described as being “configured to electromagnetically couple to” the inner conductor 104. This language is to be interpreted broadly as meaning that the electrode 106 and/or the concentrator: are presently electromagnetically coupled to the inner conductor 104, are always electromagnetically coupled to the inner conductor 104, can be selectively electromagnetically coupled to the inner conductor 104 (for example, using a switch), are only electromagnetically coupled to the inner conductor 104 when a power source is connected to the inner conductor 104, and/or are able to be electromagnetically coupled to the inner conductor 104 if one or more components are repositioned relative to one another. For example, the electrode 106 can be “configured to electromagnetically couple to” the inner conductor 104 if the electrode 106 is machined as a single piece with the inner conductor 104, if the electrode 106 is connected to the inner conductor 104 using a wire or other conducting mechanism, or if the electrode 106 is disposed sufficiently close to the inner conductor 104 such that the electrode 106 electromagnetically couples to one or more evanescent waves excited by the inner conductor 104 when the inner conductor 104 is connected to a power source.

As illustrated in FIG. 1C, the electrode 106 and/or a concentrator of the electrode 106 can extend beyond the distal end of the outer conductor 102 and/or the distal end of the dielectric 108. In alternate implementations, the electrode 106 and/or a concentrator of the electrode 106 can be flush with the distal end of the outer conductor 102 and/or the distal end of the dielectric 108. In alternate implementations, the electrode 106 and/or a concentrator of the electrode 106 can be shorter than the outer conductor 102, such that no portion of the electrode 106 and/or concentrator is flush with the distal end of the outer conductor 102 and no portion extends beyond the distal end of the outer conductor 102. The QWCCR structure 100 can be excited at resonance, in some implementations. The resonance can generate a standing voltage quarter-wave within the QWCCR structure 100. If the concentrator, the distal end of the outer conductor 102, and the distal end of the dielectric 108 are each flush with one another, the electromagnetic field can quickly collapse outside of the QWCCR structure 100, thereby concentrating the majority of the electromagnetic energy at the concentrator. In still other implementations, the distal end of the outer conductor 102 and/or the distal end of the dielectric 108 can extend beyond the electrode 106 and/or a concentrator of the electrode 106. The electrode 106 can effectively modify the physical length of the inner conductor 104, which can modify the resonance conditions of the QWCCR structure 100 (for example, can modify the electrical length of the QWCCR structure 100). Various resonance conditions can thus be achieved across a variety of QWCCR structures 100 by varying the geometry of the electrode 106 and/or a concentrator of the electrode 106.

Further, as illustrated in FIG. 1C, the base conductor 110 can be electrically coupled to the outer conductor 102 and the inner conductor 104. In alternate implementations, the inner conductor 104 can be electrically insulated from the outer conductor 102 (rather than shorted together through the base conductor 110).

Plasmas (for example, plasma coronas generated by the QWCCR structure 100) can be used to ignite mixtures of air and fuel (for example, hydrocarbon fuel for use in a combustion process). Plasma-assisted ignition (for example, using a QWCCR structure 100) is fundamentally different from ignition using a gap spark plug. For example, efficient electron-impact excitation, dissociation of molecules, and ionization of atoms, which might not occur in ignition using gap spark plugs, can occur in plasma-assisted ignition. Further, in plasmas, an external electric field can accelerate the electrons and/or ions. Thus, using electric fields, energy within the plasma (for example, thermal energy) can be directed to specific locations (for example, within a combustion chamber).

There are a variety of mechanisms by which plasma can impart the energy necessary to ignite mixtures of air and fuel. For example, electrons can impart energy to molecules during collisions. However, this singular energy exchange might be relatively minor (for example, because an electron's mass is orders of magnitude less than a molecule's mass). So long as the rate at which electrons are imparting energy to the molecules is higher than the rate at which molecules are undergoing relaxation, a population distribution of the molecules (for example, a population distribution that differs from an initial Boltzmann distribution of the molecules) can arise. The molecules having higher energy, along with the dissociation and ionization processes, can emit ultraviolet (UV) radiation (for example, when undergoing relaxation) that affects mixtures of fuel and air. Further, gas heating and an increase in system reactivity can increase the likelihood of ignition and flame propagation. In addition, when the average electron energy within a plasma (for example, within a combustion chamber) exceeds 10 eV, gas ionization can be the predominant mechanism by which plasma is formed (over electron-impact excitation and dissociation of molecules).

Plasma-assisted ignition can have a variety of benefits over ignition using a gap spark plug. For example, in plasma-assisted ignition, a plasma corona that is generated can be physically larger (for example, in length, width, radius, and/or overall volumetric extent) than a typical spark from a gap spark plug. This can allow a more lean fuel mixture (also known as lower fuel-to-air ratio) to be burned once combustion occurs as compared with alternative ignition, for example. Also, because a larger energy can be energized in plasma-assisted ignition, stoichiometric ratio fuels can be combusted more fully, thereby creating fewer regulated pollutants (for example, creating less NOₓ to be expelled as exhaust) and/or leaving less unspent fuel.

Dielectric breakdown of air or another dielectric material near the electrode 106 of the QWCCR structure 100 can be a mechanism by which a plasma corona is excited near the concentrator of the QWCCR structure 100. Factors that impact the breakdown of a dielectric, such as dielectric breakdown of air, include free-electron population, electron diffusion, electron drift, electron attachment, and electron recombination. Free electrons in the free-electron population can collide with neutral particles or ions during ionization events. Such collisions can create additional free electrons, thereby increasing the likelihood of dielectric breakdown. Oppositely, electron diffusion and attachment can each be mechanisms by which free electrons recombine and are lost, thereby reducing the likelihood of dielectric breakdown.

As presently described, a plasma corona can be provided “proximate to” a distal end of the QWCCR structure 100, the electrode 106, and/or a concentrator of the QWCCR structure 100. In other words, the plasma corona could be described as being provided “nearby” or “at” a distal end of the QWCCR structure 100, the electrode 106, and/or a concentrator of the QWCCR structure 100. Further, this terminology is not to be viewed as limiting. For example, while the plasma corona is provided “proximate to” the QWCCR structure 100, this does not limit the plasma corona from extending away from the QWCCR structure 100 and/or from being moved to other locations that are farther from the QWCCR structure 100 after being provided “proximate to” the QWCCR structure 100.

When used to describe a relationship between a plasma corona and a distal end of the QWCCR structure 100, a relationship between a plasma corona and the electrode 106, a relationship between a plasma corona and a concentrator of the electrode 106, or similar relationships, the term “proximate” can describe the physical separation between the plasma corona and the other component. In various implementations, the physical separation can include different ranges. For example, a plasma corona provided “proximate to” the concentrator can be separated from the concentrator (in other words, can “stand off from” the concentrator) by less than 1.0 nanometer, by 1.0 nanometer to 10.0 nanometers, by 10.0 nanometers to 100.0 nanometers, by 100.0 nanometers to 1.0 micrometer, by 1.0 micrometer to 10.0 micrometers, by 10.0 micrometers to 100.0 micrometers, or by 100.0 micrometers to 1.0 millimeter. Additionally or alternatively, a plasma corona provided “proximate to” the concentrator can be separated from the concentrator by 0.01 times a width of the plasma corona to 0.1 times a width of the plasma corona, by 0.1 times a width of the plasma corona to 1.0 times the width of the plasma corona, or by 1.0 times a width of the plasma corona to 10.0 times a width of the plasma corona. Even further, a plasma corona provided “proximate to” the concentrator can be separated from the concentrator by 0.01 times a radius of the concentrator to 0.1 times a radius of the concentrator, by 0.1 times a radius of the concentrator to 1.0 times a radius of the concentrator, or by 1.0 times a radius of the concentrator to 10.0 times a radius of the concentrator.

It is understood that in various implementations, the plasma corona can emit light entirely within the visible spectrum, partially within the visible spectrum and partially outside the visible spectrum, or completely outside the visible spectrum. In other words, even if the plasma corona is “invisible” to the human eye and/or to optics that only sense light within the visible spectrum, it is not necessarily the case that the plasma corona is not being provided.

### IV. Mathematical Description of Example Resonator

In order for dielectric breakdown to occur, an electric field within the dielectric must be greater than or equal to an electric field breakdown threshold. An electric field generated by an alternating current (AC) source can be described by a root-mean-square (rms) value for electric field (Eᵣₘₛ). The rms value for electric field (Eᵣₘₛ) can be calculated according the following equation:

$${E}_{rms} = \sqrt{\frac{1}{{T}_{2} - {T}_{1}} {\int }_{{T}_{1}}^{{T}_{2}} {E}^{2} dt}$$

where T₂−T₁ represents the period over which the electric field is oscillating (for example, corresponding to the period of the AC source generating the electric field). As described mathematically above, the rms value for electric field (Eᵣₘₛ) represents the quadratic mean of the electric field. Using the rms value for electric field, an effective electric field (E_{eff}) can be calculated that is approximately frequency independent (for example, by removing phase lag effects from the oscillating electric field):

$${E}_{eff}^{2} = {E}_{rms}^{2} \frac{{v}_{c}^{2}}{{ω}^{2} + {v}_{c}^{2}}$$

where ω represents the angular frequency of the electric field (for example,

$$ω = \frac{2 π}{{T}_{2} - {T}_{1}} )$$

and v_{c} represents the effective momentum collision frequency of the electrons and neutral particles. The angular frequency (ω) of the electric field can correspond to the frequency of an excitation source used to excite the electric field (for example, the QWCCR structure 100). Using this effective electric field (E_{eff}), DC breakdown voltages for various gases (and potentially other dielectrics) can be related to AC breakdown values for uniform electric fields. For air, v_{c}≈5·10⁹×p, where p represents the pressure (in torr). At atmospheric pressure (for example, around 760 torr) or above and excitation frequencies of below 1 THz, the effective momentum collision frequency of the electrons and neutral particles (v_{c}) will dominate the denominator of the fractional coefficient of Eᵣₘₛ². Therefore, an approximation of the rms breakdown field (E_{b}) can be used. The rms breakdown field (E_{b}), in V/cm, of a uniform microwave field in the collision regime can be given by:

$${E}_{b} = 30 \cdot 297 ( \frac{p}{T} )$$

where T is the temperature in Kelvin.

An analytical description of the electromagnetics of the QWCCR structure 100 follows.

If fringing electromagnetic fields are assumed to be small, the lowest quarter-wave resonance in a coaxial cavity is a transverse electromagnetic mode (TEM mode) (as opposed to a transverse electric mode (TE mode) or a transverse magnetic mode (TM mode)). The TEM mode is the dominant mode in a coaxial cavity and has no cutoff frequency (ω_{c}). In the TEM mode (as illustrated in FIG. 1E), because neither the electric field nor the magnetic field have any components in the z-direction (coordinate system illustrated in FIG. 1D), the electric and magnetic fields can be written, respectively, as:

$$H = {H}_{ϕ} {\hat{a}}_{ϕ} = \frac{{I}_{0}}{2 π r} cos ( β z ) {\hat{a}}_{ϕ}$$

$$E = {E}_{r} {\hat{a}}_{r} = \frac{{V}_{0}}{2 π r} sin ( β z ) {\hat{a}}_{r}$$

where H is a phasor representing the magnetic field vector, E is a phasor representing the electric field vector, â_{φ} represents a unit vector in the φ direction (labeled in FIG. 1D), âᵣ represents a unit vector in the r direction (labeled in FIG. 1D), β represents the wave number (canonically defined as

$$β = \frac{2 π}{λ} ,$$

where λ is the wavelength), I₀ represents the maximum current in the cavity, V₀ represents the maximum voltage in the cavity, and z represents a distance along the QWCCR structure 100 in the z direction (labeled in FIG. 1D).

In various implementations, various electromagnetic modes of the QWCCR structure 100 can be excited in order to achieve various electromagnetic properties. In some implementations, for instance, a single electromagnetic mode can be excited, whereas in alternate implementations, a plurality of electromagnetic modes can be excited. For example, in some implementations, the TE₀₁ mode (as illustrated in FIG. 1F) can be excited.

Quality factor (Q) can be defined as:

$$Q = \frac{ω \cdot U}{{P}_{L}} \to U = \frac{{P}_{L} \cdot Q}{ω}$$

where ω is the angular frequency, U is the time-average energy, and P_{L} is the time-average power loss. Quality factor (Q) can be used to measure goodness of a resonator cavity. Other formulations of goodness measurement can also be used (for example, based on full-width, half-max (FWHM) or a 3 decibel (dB) bandwidth of cavity resonance). In some implementations, the quality factor (Q) can be maximized when the ratio of the inner radius of the outer conductor ‘b’ to the radius of the inner conductor ‘a’ is approximately equal to 4. However, it will be understood that many other ways to adjust and/or maximize quality factor (Q) are possible and contemplated in the present disclosure.

At resonance, the stored energy of the QWCCR structure 100 oscillates between electrical energy (Uₑ) (within the electric field) and magnetic energy (Uₘ) (within the magnetic field). Time-average stored energy in the QWCCR structure 100 can be calculated using the following:

$$U = {U}_{m} + {U}_{e} = \frac{1}{4} {\int }_{vol} μ {\vert H \vert}^{2} + ɛ {\vert E \vert}^{2}$$

where μ is magnetic permeability and E is dielectric permittivity. By inserting the values for electric field and magnetic field from above, and integrating over the entire volume of the QWCCR structure 100, the following expression can be obtained:

$$U = \frac{ln ( \frac{b}{a} ) \cdot λ}{64 π} ( μ \cdot {I}_{0}^{2} + ɛ \cdot {V}_{0}^{2} )$$

where b represents the inner radius of the outer conductor 102 of the QWCCR structure 100 (as illustrated in FIG. 1D), a represents the radius of the inner conductor 104 of the QWCCR structure 100 (as illustrated in FIG. 1D), and λ represents the wavelength of the source (for example, AC source) used to excite the QWCCR structure 100. Because the magnetic energy at maximum is the same as the electric energy at maximum, μ·I₀² can be replaced with ε·V₀², thus resulting in:

$$U = \frac{ln ( \frac{b}{a} ) \cdot λ}{32 π} ( ɛ \cdot {V}_{0}^{2} )$$

Now, by equating the two above expressions for U, the following relationship can be expressed:

$$\frac{{P}_{L} \cdot Q}{ω} = \frac{ln ( \frac{b}{a} ) \cdot λ}{32 π} ( ɛ \cdot {V}_{0}^{2} ) -> {V}_{0} \sqrt{\frac{32 π \cdot Q \cdot {P}_{L}}{ω \cdot ɛ \cdot ln ( \frac{b}{a} ) \cdot λ}}$$

Further, in recognizing that

$$ω = 2 π f = \frac{2 π c}{λ} ,$$

where c is me speed of light;

$$c = \sqrt{\frac{1}{μ \cdot ɛ}} ; and η = \sqrt{\frac{μ}{ɛ}} ,$$

where η is the impedance of the dielectric between the inner conductor 104 and the outer conductor 102 of the QWCCR structure 100, the following relationship for the peak potential (V₀) can be identified:

$${V}_{0} = 4 \sqrt{\frac{η \cdot Q \cdot {P}_{L}}{ln ( \frac{b}{a} )}}$$

Given that electric field decays as the distance from the peak potential (V₀) increases, the largest value of electric field corresponding to the peak potential (V₀) occurs exactly at the surface of the inner conductor (for example, at radius a, as illustrated in FIG. 1D). Using the above equation for phasor electric field (E), the peak value of electric field (Eₐ) can be expressed as:

$${E}_{a} = \frac{{V}_{0}}{2 π a} = \frac{2}{π a} \sqrt{\frac{η \cdot Q \cdot {P}_{L}}{ln ( \frac{b}{a} )}}$$

If the above peak value of electric field (Eₐ) meets or exceeds the above-described rms breakdown field (E_{b}), a dielectric breakdown can occur. For example, a dielectric breakdown of the air surrounding the tip of the QWCCR structure 100 can result in a plasma corona being excited. As indicated in the above equation for peak electric field (Eₐ), the smaller the radius a of the inner conductor 104, the smaller the inner radius b of outer conductor 102, the higher the quality factor (Q) of the QWCCR structure 100, and the larger the time-average power loss (P_{L}), the more likely it is that breakdown can occur (for example, because the peak value of electric field (Eₐ) is larger). A larger excitation power can correspond to a larger time-average power loss (P_{L}) in the QWCCR structure 100, for example.

The power loss (P_{L}) can include ohmic losses (P_{σ}) on conductive surfaces (for example, the surface of the outer conductor 102, the surface of the inner conductor 104, and/or the surface of the base conductor 110, as illustrated in FIG. 1C), dielectric losses (P_{σ}_{ₑ}) in the dielectric 108, and radiation losses (P_{rad}) from a radiating end of the QWCCR structure 100 (for example, the distal end of the QWCCR structure 100). Each of the conductors can have a corresponding surface resistance (R_{S}). The surface resistance (R_{S}) can be the same for one or more of the conductors if the corresponding conductors are made of the same conductive materials. The corresponding surface resistance for each conductor can be expressed as

$${R}_{S} = \sqrt{\frac{ω \cdot {μ}_{c}}{2 \cdot {σ}_{c}}} ,$$

where μ_{c} is the magnetic permeability of the respective conductor and σ_{c} is the conductivity of the respective conductor. The power lost by each conductor can be calculated according to the following:

$${P}_{σ} = \frac{1}{2} {\int }_{A} {R}_{S} {\vert {H}_{//} \vert}^{2}$$

where H_{//} is the magnetic field parallel to the surface of the conductor. Thus, the total power loss in all conductors can be represented by:

$${P}_{σ} = {P}_{inner} + {P}_{outer} + {P}_{base} = \frac{{R}_{S} \cdot {I}_{0}^{2}}{4 π} [ \frac{λ}{8 \cdot a} + \frac{λ}{8 \cdot b} + ln ( \frac{b}{a} ) ]$$

Further, if the dielectric 108 is an isotropic, low-loss dielectric, the dielectric 108 can be characterized by its dielectric constant (ε) and its loss tangent (tan(δₑ)), where the loss tangent (tan(δₑ)) represents conductivity and alternating molecular dipole losses. Using dielectric constant (ε) and loss tangent (tan(δₑ)), an effective dielectric conductivity (σₑ) can be approximately defined as:

σₑ≈ω·ε·tan(δₑ)

Based on the above, the power dissipated in the dielectric can be calculated according to the following:

$${P}_{{σ}_{e}} = \frac{1}{2} {\int }_{vol} {σ}_{e} {\vert E \vert}^{2} = \frac{{σ}_{e} \cdot η \cdot {I}_{0}^{2}}{4 π} ( \frac{ln ( \frac{b}{a} ) \cdot λ}{8} )$$

In order to combine all quality factors of the QWCCR structure 100 into a total internal quality factor (Qᵢₙₜ), the following relationship can be used:

$${Q}_{int} = \frac{1}{( {Q}_{inner}^{- 1} + {Q}_{outer}^{- 1} + {Q}_{base}^{- 1} + {Q}_{{σ}_{e}}^{- 1} )}$$

where Qᵢₙₙₑᵣ⁻¹, Qₒᵤₜₑᵣ⁻¹, Q_{base}⁻¹, and Q_{σ}_{ₑ}⁻¹ are the quality factors of the inner conductor 104, the outer conductor 102, the base conductor 110, and the dielectric 108, respectively. Using the above expression for quality factor (Q) in terms of time-average power loss (P_{L}), angular frequency (ω), and time-average energy (U), the following expression for internal quality factor (Qᵢₙₜ) can be determined:

$${Q}_{int} = {( \frac{{R}_{S}}{2 \cdot π \cdot η} [ \frac{( \frac{b}{a} + 1 )}{\frac{b}{a} \cdot ln ( \frac{b}{a} )} + 8 ] + tan ( {δ}_{e} ) )}^{- 1}$$

Based on the definitions of the individual quality factors above, the individual contribution of the outer conductor quality factor (Qₒᵤₜₑᵣ) to the internal quality factor (Qᵢₙₜ) can be greater than the individual contribution of the inner conductor quality factor (Qᵢₙₙₑᵣ). Thus, to increase the internal quality factor (Qᵢₙₜ), a material with higher conductivity can be used for the inner conductor 104 than is used for the outer conductor 102. Further, the base conductor 110 quality factor (Q_{base}) and the dielectric 108 quality factor (Q_{σ}_{ₑ}) can be unaffected by the geometry of the QWCCR structure 100 (both in terms of

$$\frac{b}{a}$$

and in terms of

$$\frac{b}{λ} ) .$$

The QWCCR structure 100 can also radiate electromagnetic waves (for example, from a distal, non-closed end opposite the base conductor 110). For example, if the QWCCR structure 100 is being excited by an RF power source (for example, a signal generator oscillating at radio frequencies), the QWCCR structure 100 can radiate microwaves from a distal end (for example, from an aperture of the distal end) of the QWCCR structure 100. Such radiation can lead to power losses, which can be approximated using admittance. Assuming that the transverse dimensions of the QWCCR structure 100 are significantly smaller than the wavelength (λ) being used to excite the QWCCR structure 100 (in other words, a<<λ and b<<λ), the real part (Gᵣ) and imaginary part (Bᵣ) of admittance can be represented by:

$${G}_{r} \approx \frac{4 \cdot {π}^{5} \cdot {[ {( \frac{( \frac{b}{λ} )}{( \frac{b}{a} )} )}^{2} - {( \frac{b}{λ} )}^{2} ]}^{2}}{3 \cdot η \cdot {ln}^{2} ( \frac{b}{a} )}$$

$${B}_{r} \approx \frac{16 \cdot π \cdot ( \frac{( \frac{b}{λ} )}{( \frac{b}{a} )} - ( \frac{b}{λ} ) )}{η \cdot {ln}^{2} ( \frac{b}{a} )} \cdot [ E ( \frac{2 \sqrt{\frac{b}{a}}}{1 + \frac{b}{a}} ) - 1 ]$$

where E(x) is the complete elliptical integral of the second kind. Namely:

$$E ( x ) = {\int }_{0}^{\frac{π}{2}} \sqrt{1 - {x}^{2} \cdot {sin}^{2} ( θ )} \cdot d θ$$

Further, the line integral of the electric field from the inner conductor 104 to the outer conductor 102 can be used to determine the potential difference (V_{ab}) across the shunt admittance corresponding to the electromagnetic waves radiated.

$${V}_{ab} {\vert}_{β z = \frac{π}{4}} = {\int }_{a -> b} {E}_{r} = \frac{{V}_{0} ln ( \frac{b}{a} )}{2 π}$$

Using the potential difference (V_{ab}) across the shunt admittance corresponding to the electromagnetic waves radiated, the power going to radiation (P_{rad}) can be represented by:

$${P}_{r ad} = \frac{1}{2} {G}_{r} {V}_{ab}^{2} = \frac{{V}_{0} {{{π}^{3} ( \frac{b}{λ} )}^{4} [ {( \frac{b}{a} )}^{2} - 1 ]}^{2}}{6 {η ( \frac{b}{a} )}^{4}}$$

In addition, using the potential difference (V_{ab}) across the shunt admittance corresponding to the electromagnetic waves radiated, the energy stored during radiation (U_{rad}) can be represented by:

$${U}_{r ad} = \frac{1}{4} ( \frac{{B}_{r}}{ω} ) {V}_{ab}^{2} = \frac{ɛ {V}_{0}^{2} λ ( \frac{b}{λ} ) [ {( \frac{b}{a} )}^{- 1} + 1 ]}{2 {π}^{2}} [ E ( \frac{2 \sqrt{\frac{b}{a}}}{1 + \frac{b}{a}} ) - 1 ]$$

Based on the above, the overall quality factor of the QWCCR structure 100 (Q_{QWCCR}) can be described by the following:

$${Q}_{QWCCR} = \frac{ω ( U + {U}_{ra d} )}{{P}_{inner} + {P}_{outer} + {P}_{base} + {P}_{{σ}_{e}} + {P}_{r ad}}$$

If the energy stored during radiation (U_{rad}) is small compared with the energy stored in the interior of the QWCCR structure 100 (U), the radiation power (P_{rad}) can be treated similarly to the other losses. Further, the energy stored during radiation (U_{rad}) can be neglected in the above equation:

$$Q \approx \frac{ω ( U )}{{P}_{inner} + {P}_{outer} + {P}_{base} + {P}_{{σ}_{e}} + {P}_{r ad}}$$

Still further, the quality factor of the radiation component (Q_{rad}) can be described using the above relationship for quality factors:

$${Q}_{r ad} = \frac{ω U}{{P}_{r ad}} = \frac{3 {( \frac{b}{λ} )}^{4} ln ( \frac{b}{a} )}{8 {{{π}^{3} ( \frac{b}{λ} )}^{4} [ {( \frac{b}{a} )}^{2} - 1 ]}^{2}}$$

Even further, using the above-referenced quality factors, the total quality factor of the QWCCR structure 100 (Q_{QWCCR}) can be approximated by:

$${Q}_{QWCCR} \approx {( \frac{8 {{{π}^{3} ( \frac{b}{λ} )}^{4} [ {( \frac{b}{a} )}^{2} - 1 ]}^{2}}{3 {( \frac{b}{λ} )}^{4} ln ( \frac{b}{a} )} + \frac{{R}_{S}}{2 πη} [ \frac{( ( \frac{b}{a} ) + 1 )}{( \frac{b}{λ} ) ln ( \frac{b}{a} )} + 8 ] + tan ( {δ}_{e} ) )}^{- 1}$$

Based on the above relationships, it can be shown that one method of minimizing losses due to radiation of electromagnetic waves by the QWCCR structure 100 is to minimize the inner radius b of the outer conductor 102 with respect to the excitation wavelength (A). Another way of minimizing losses due to radiation of electromagnetic waves is to select an inner radius b of the outer conductor 102 that is close in dimension to the radius a of the inner conductor 104.

Various physical quantities and dimensions of the QWCCR structure 100 can be adjusted to modify performance of the QWCCR structure 100. For example, physical quantities and dimensions can be modified to maximize and/or optimize the total quality factor of the QWCCR structure 100 (Q_{QWCCR}) In some implementations, different dielectrics can be inserted into the QWCCR structure 100. In one implementation, the dielectric 108 can include a composite of multiple dielectric materials. For example, a half of the dielectric 108 near a proximal end of the QWCCR structure 100 can include alumina ceramic while a half of the dielectric 108 near a distal end of the QWCCR structure 100 can include air. The resonant frequency can be based on the dimensions and the fabrication materials of the QWCCR structure 100. Hence, modification of the dielectric 108 can modify a resonant frequency of the QWCCR structure 100. In some implementations, the resonant frequency can be 2.45 GHz based on the dimensions of the QWCCR structure 100. In other implementations, the resonant frequency of the QWCCR structure 100 could be within an inclusive range between 1 GHz to 100 GHz. In still other implementations, the resonant frequency of the QWCCR structure 100 could be within an inclusive range of 100 MHz to 1 GHz or an inclusive range of 100 GHz to 300 GHz. However, other resonant frequencies are contemplated within the context of the present disclosure.

An RF power source exciting the QWCCR structure 100 can generate a standing electromagnetic wave within the QWCCR structure 100. In some implementations, the resonant frequency of the QWCCR structure 100 can be designed to match the frequency of an RF power source that is exciting the QWCCR structure 100 (for example, to maximize power transferred to the QWCCR structure 100). For example, if a desired excitation frequency corresponds to a wavelength of λ₀, dimensions of the QWCCR structure 100 can be modified such that the electrical length of the QWCCR structure 100 is an odd-integer multiple of quarter wavelengths (for example, ¼λ₀, ¾λ₀, 5/4λ₀, 7/4λ₀, 9/4λ₀, 11/4λ₀, 13/4λ₀, etc.). The electrical length is a measure of the length of a resonator in terms of the wavelength of an electromagnetic wave used to excite the resonator. The QWCCR structure 100 can be designed for a given resonant frequency based on the dimensions of the QWCCR structure 100 (for example, adjusting dimensions of the inner conductor 104, the outer conductor 102, or the dielectric 108) or the materials of the QWCCR structure 100 (for example, adjusting materials of the inner conductor 104, the outer conductor 102, or the dielectric 108).

In other implementations, the resonant frequency of the QWCCR structure 100 can be designed or adjusted such that its resonant frequency does not match the frequency of an RF power source that is exciting the QWCCR structure 100 (for example, to reduce power transferred to the QWCCR structure 100). Analogously, the frequency of an RF power source can be de-tuned relative to the resonant frequency of a QWCCR structure 100 that is being excited by the RF power source. Additionally or alternatively, the physical quantities and dimensions of the QWCCR structure 100 can be modified to enhance the amount of energy radiated (for example, from the distal end) in the form of electromagnetic waves (for example, microwaves) from the QWCCR structure 100. As an example, one or more elements of the QWCCR structure 100 could be movable or otherwise adjustable so as to modify the resonant properties of the QWCCR structure 100. Enhancing the amount of energy radiated might be done at the expense of maximizing the electric field at a concentrator of the electrode 106 at the distal end of the inner conductor 104. For example, some implementations can include slots or openings in the outer conductor 102 to increase the amount of radiated energy despite possibly reducing a quality factor of the QWCCR structure 100.

In still other implementations, the physical quantities and dimensions of the QWCCR structure 100 can be designed in such a way so as to enhance the intensity of an electric field at a concentrator of the electrode 106 of the QWCCR structure 100. Enhancing the electric field at a concentrator of the electrode 106 of the QWCCR structure 100 can result in an increase in plasma corona excitation (for example, an increase in dielectric breakdown near the concentrator), when the QWCCR structure 100 is excited with sufficiently high RF power/current. To increase electric field at a concentrator of the electrode 106 of the QWCCR structure 100, a radius of the concentrator can be minimized (for example, configured as a very sharp structure, such as a tip). Additionally or alternatively, to increase the electric field at a tip of the QWCCR structure 100 (for example, thereby increasing the intensity and/or size of an excited plasma corona), the intrinsic impedance (η) of the dielectric 108 can be increased, the power used to excite the QWCCR structure 100 can be increased, and the total quality factor of the QWCCR structure 100 (Q_{QWCCR}) can be increased (for example, by increasing the volume energy storage (U) of the cavity or by minimizing the surface and radiation losses).

Further, the shunt capacitance (C) of a circular coaxial cavity (for example, in farads/meter, and neglecting fringing fields) can be expressed as follows:

$$C = \frac{2 {πɛ}_{0} {ɛ}_{r}}{ln ( \frac{b}{a} )}$$

where ε₀ represents the permittivity of free space, εᵣ represents the relative dielectric constant of the dielectric 108 between the inner conductor 104 and the outer conductor 102, b is the inner radius of the outer conductor 102, and a is the radius of the inner conductor 104 (as illustrated in FIG. 1D).

Similarly, the shunt inductance (L) of a circular coaxial cavity (for example, in henrys/meter) can be expressed as follows:

$$L = \frac{{μ}_{0} {μ}_{r}}{2 π} ln ( \frac{b}{a} )$$

where μ₀ represents the permeability of free space, μᵣ represents the relative permeability of the dielectric 108 between the inner conductor 104 and the outer conductor 102, b is the inner radius of the outer conductor 102, and a is the radius of the inner conductor 104 (as illustrated in FIG. 1D).

Based on the above, the complex impedance (Z) of a circular coaxial cavity (for example, in ohms, Ω) can be expressed as follows:

$$Z = \sqrt{\frac{R + j ω L}{G + j ω C}}$$

where G represents the conductance per unit length of the dielectric between the inner conductor and the outer conductor, R represents the resistance per unit length of the QWCCR structure 100, j represents the imaginary unit (for example \sqrt{−1}), co represents the frequency at which the QWCCR structure 100 is being excited, L represents the shunt inductance of the QWCCR structure 100, and C represents the shunt capacitance of the QWCCR structure 100.

At very high frequencies (for example, GHz frequencies) the complex impedance (Z) can be approximated by:

$${Z}_{0} = \sqrt{\frac{L}{C}}$$

where Z₀ represents the characteristic impedance of the QWCCR structure 100 (in other words, the complex impedance (Z) of the QWCCR structure 100 at high frequencies).

As described above, the shunt inductance (L) and the shunt capacitance (C) of the QWCCR structure 100 depend on the relative permeability (μᵣ) and the relative dielectric constant (εᵣ), respectively, of the dielectric 108 between the inner conductor 104 and the outer conductor 102. Thus, any modification to either the relative permeability (μᵣ) or the relative dielectric constant (εᵣ) of the dielectric 108 between the inner conductor 104 and the outer conductor 102 can result in a modification of the characteristic impedance (Z₀) of the QWCCR structure 100. Such modifications to impedance can be measured using an impedance measurement device (for example, an oscilloscope, a spectrum analyzer, and/or an AC volt meter).

The above characteristic impedance (Z₀) represents an impedance calculated by neglecting fringing fields. In some applications and implementations, the fringing fields can be non-negligible (for example, the fringing fields can significantly impact the impedance of the QWCCR structure 100). Further, in such implementations, the composition of the materials surrounding the QWCCR structure 100 can affect the characteristic impedance (Z₀) of the QWCCR structure 100. Measurements of such changes to characteristic impedance (Z₀) can provide information regarding the environment (for example, a combustion chamber) surrounding the QWCCR structure 100 (for example, the temperature, pressure, or atomic composition of the environment). A change in the characteristic impedance (Z₀) can coincide with a change in the cutoff frequency, resonant frequency, short-circuit condition, open-circuit condition, lumped-circuit model, mode distribution, etc. of the QWCCR structure 100.

FIG. 1G illustrates a quarter-wave resonance condition of the QWCCR structure 100. The y-axis of the plot corresponds to a power of electromagnetic waves radiated from a distal end of the QWCCR structure 100 and the x-axis corresponds to an excitation frequency (ω) (for example, from a radio-frequency power source that is electromagnetically coupled to the QWCCR structure 100) used to excite the QWCCR structure 100. As illustrated, the shape of the curve can be a Lorentzian.

As illustrated in FIG. 1G the curve has a maximum power at a quarter-wave (λ/4) resonance. This resonance can correspond to excitation frequency (ω) that has an associated excitation wavelength that is four times the length of the QWCCR structure 100. In other words, at the resonant frequency (ω₀) the QWCCR structure 100 is being excited by a standing wave, where one-quarter of the length of the standing wave is equal to the length of the QWCCR structure 100. Although not illustrated, it is understood that the QWCCR structure 100 could experience additional resonances (for example, at odd-integer multiples of the resonant wavelength: ¾λ₀, 5/4λ₀, 7/4λ₀, 9/4λ₀, 11/4λ₀, 13/4λ₀, etc.). Each of the additional resonances could look similar to the resonance illustrated in FIG. 1G (for example, could have a Lorentzian shape).

As illustrated, the power of the electromagnetic waves radiated from the distal end of the QWCCR structure 100 decreases exponentially the further the excitation frequency (ω) is from the resonant frequency (ω₀). However, the power of the electromagnetic waves is not necessarily zero as soon as you move away from resonance. Hence, it is understood that even when excited near the quarter-wave resonance condition (in other words, proximate to the quarter-wave resonance condition), rather than exactly at the resonance condition, the QWCCR structure 100 can still radiate electromagnetic waves with non-zero power and/or provide a plasma corona, depending on arrangement.

When the QWCCR structure 100 is being excited such that it provides a plasma corona proximate to the distal end (for example, at the electrode 106), a plot with a shape similar to that of FIG. 1G could be provided. In such a scenario, a plot of voltage at the electrode 106 versus excitation frequency (ω) could include a Gaussian shape, rather than a Lorentzian shape. In other words, the voltage at the electrode 106 may reach a peak when excited by a resonant frequency. The voltage at the electrode 106 may fall off exponentially according to a Gaussian shape as the excitation frequency moves away from the resonant frequency. It will be understood that the Gaussian and Lorentzian shapes presently described may be based on one or more characteristics of the QWCCR structure 100, such as its shape, quality factor, bias conditions, or other factors.

It is understood that when the term “proximate” is used to describe a relationship between a wavelength of a signal (for example, a signal used to excite the QWCCR structure 100) and a resonant wavelength of a resonator (for example, the QWCCR structure 100), the term “proximate” can describe a difference in length. For example, if the wavelength of the signal is “proximate to an odd-integer multiple of one-quarter of the resonant wavelength,” the wavelength of the signal can be equal to, within 0.001% of, within 0.01% of, within 0.1% of, within 1.0% of, within 5.0% of, within 10.0% of, within 15.0% of, within 20.0% of, and/or within 25.0% of one-quarter of the resonant wavelength. Additionally or alternatively, if the wavelength of the signal is “proximate to an odd-integer multiple of one-quarter of the resonant wavelength,” the wavelength of the signal can be within 0.1 nm, within 1.0 nm, within 10.0 nm, within 0.1 micrometers, within 1.0 micrometers, within 10.0 micrometers, within 0.1 millimeters, within 1.0 millimeters, and/or within 1.0 centimeters of one-quarter of the resonant wavelength, depending on context (for example, depending on the resonant wavelength). Still further, if the wavelength of the signal is “proximate to an odd-integer multiple of one-quarter of the resonant wavelength,” the wavelength of the signal can be a multiple of one-quarter of the resonant wavelength that is an odd number plus or minus 0.5, an odd number plus or minus 0.1, an odd number plus or minus 0.01, an odd number plus or minus 0.001, and/or an odd number plus or minus 0.0001.

The quality factor of the QWCCR structure 100 (Q_{QWCCR}), described above, can be used to describe the width and/or the sharpness of the resonance (in other words, how quickly the power drops off as you excite the QWCCR structure 100 further and further from the resonance condition). For example, a square root of the quality factor can correspond to the voltage modification experienced at the electrode 106 of the QWCCR structure 100 when the QWCRR structure 100 is excited at the quarter-wave resonant condition. Additionally, the quality factor may be equal to the resonant frequency (ω₀) divided by full width at half maximum (FWHM). The FWHM is equal to the width of the curve in terms of frequency between the two points on the curve where the power is equal to 50% of the maximum power, as illustrated). The 50% power maximum point can also be referred to as the −3 decibel (dB) point, because it is the point at which the maximum voltage at the distal end of the QWCCR structure 100 decreases by 3 dB (or 29.29% for voltage) and the maximum power radiated by the QWCCR structure 100 decreases by 3 dB (or 50% for power). In various implementations, the FWHM of the QWCCR structure 100 could have various values. For example, the FWHM could be between 5 MHz and 10 MHz, between 10 MHz and 20 MHz, between 20 MHz and 40 MHz, between 40 MHz and 60 MHz, between 60 MHz and 80 MHz, or between 80 MHz and 100 MHz. Other FWHM values are also possible.

Further, the quality factor of the QWCCR structure 100 (Q_{QWCCR}) can also take various values in various implementations. For example, the quality factor could be between 25 and 50, between 50 and 75, between 75 and 100, between 100 and 125, between 125 and 150, between 150 and 175, between 175 and 200, between 200 and 300, between 300 and 400, between 400 and 500, between 500 and 600, between 600 and 700, between 700 and 800, between 800 and 900, between 900 and 1000, or between 1000 and 1100. Other quality factor values are also possible.

It is understood that, in alternate implementations, alternate structures (for example, alternate quarter-wave structures) can be used to emit electromagnetic radiation and/or excite plasma coronas (for example, other structures that concentrate electric field at specific locations using points or tips with sufficiently small radii). For example, other quarter-wave resonant structures, such as a coaxial-cavity resonator (sometimes referred to as a “coaxial resonator”), a dielectric resonator, a crystal resonator, a ceramic resonator, a surface-acoustic-wave resonator, a yttrium-iron-garnet resonator, a rectangular-waveguide cavity resonator, a parallel-plate resonator, a gap-coupled microstrip resonator, etc. can be used to excite a plasma corona.

Further, it is understood that wherever in this disclosure the terms “resonator,” “QWCCR,” “QWCCR structure,” and “coaxial resonator,” are used, any of the structures enumerated in the preceding paragraph could be used, assuming appropriate modifications are made to a corresponding system. In addition, the terms “resonator,” “QWCCR,” “QWCCR structure,” and “coaxial resonator” are not to be construed as inclusive or all-encompassing, but rather as examples of a particular structure that could be included in a particular implementation. Still further, when a “QWCCR structure” is described, the QWCCR structure can correspond to a coaxial resonator, a coaxial resonator with an additional base conductor, a coaxial resonator excited by a signal with a wavelength that corresponds to an odd-integer multiple of one-quarter (¼) of a length of the coaxial resonator, and other structures, in various implementations.

Additionally, whenever any “QWCCR,” “QWCCR structure,” “coaxial resonator,” “resonator,” or any of the specific resonators in this disclosure or in the claims are described as being “configured such that, when the resonator is excited by the radio-frequency power source with a signal having a wavelength proximate to an odd-integer multiple of one-quarter (¼) of the resonant wavelength, the resonator provides at least one of a plasma corona or electromagnetic waves,” some or all of the following are contemplated, depending on context. First, the corresponding resonator could be configured to provide a plasma corona when excited by the radio-frequency power source with a signal having a wavelength proximate to an odd-integer multiple of one-quarter (¼) of a resonant wavelength of the resonator. Second, the corresponding resonator could be configured to provide electromagnetic waves when excited by the radio-frequency power source with a signal having a wavelength proximate to an odd-integer multiple of one-quarter (¼) of a resonant wavelength of the resonator. Third, the corresponding resonator could be configured to provide, when excited by the radio-frequency power source with a signal having a wavelength proximate to an odd-integer multiple of one-quarter (¼) of a resonant wavelength of the resonator, both a plasma corona and electromagnetic waves.

### V. Example Resonator Systems

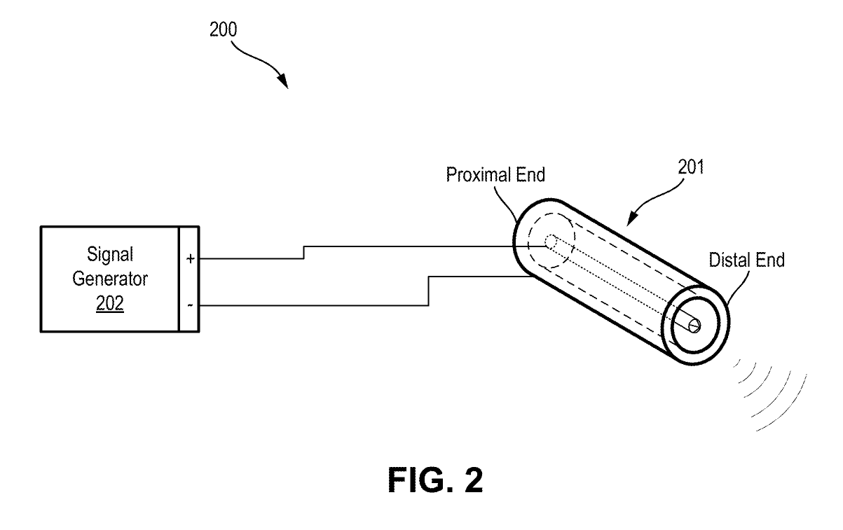

In some implementations, the coaxial resonator 201 can be used as an antenna (for example, instead of or in addition to generating a plasma corona). As an antenna, the coaxial resonator 201 can radiate electromagnetic waves. The electromagnetic waves can consequently influence charged particles. As illustrated in the system 200 of FIG. 2, such electromagnetic waves can be radiated when the coaxial resonator 201 is excited by a signal generator 202. For example, the signal generator 202 can be coupled to the coaxial resonator 201 in order to excite the coaxial resonator 201 (for example, to excite a plasma corona and to produce electromagnetic waves). Such a coupling can include inductive coupling (for example, using an induction feed loop), parallel capacitive coupling (for example, using a parallel plate capacitor), or non-parallel capacitive coupling (for example, using an electric field applied opposite a non-zero voltage conductor end). Further, the electrical distance between the signal generator 202 and the coaxial resonator 201 can be optimized (for example, minimized or adjusted based on wavelength of an RF signal) in order to minimize the amount of energy lost to heating and/or to maximize a quality factor. Further, in some implementations, the coaxial resonator 201 can radiate acoustic waves when excited (for example, at resonance). The acoustic waves produced can induce motion in nearby particles, for example.

The signal generator 202 can be a device that produces periodic waveforms (for example, using an oscillator circuit). In various implementations, the signal generator 202 can produce a sinusoidal waveform, a square waveform, a triangular waveform, a pulsed waveform, or a sawtooth waveform. Further, the signal generator 202 can produce waveforms with various frequencies (for example, frequencies between 1 Hz and 1 THz). The electromagnetic waves radiated from the coaxial resonator 201 can be based on the waveform produced by the signal generator 202. For example, if the waveforms produced by the signal generator 202 are sinusoidal waves having frequencies between 300 MHz and 300 GHz (for example, between 1 GHz and 100 GHz), the electromagnetic waves radiated by coaxial resonator 201 can be microwaves. In various implementations, the signal generator 202 can, itself, be powered by an AC power source or a DC power source.

Depending on the signal used by the signal generator 202 to excite the coaxial resonator 201, the coaxial resonator 201 can additionally excite one or more plasma coronas. For example, if a large enough voltage is used to excite the coaxial resonator 201, a plasma corona can be excited at the distal end of the electrode 106 (for example, at a concentrator of the electrode 106). In some implementations, a voltage step-up device can be electrically coupled between the signal generator 202 and the coaxial resonator 201. In such scenarios, the voltage step-up device can be operable to increase an amplitude of the AC voltage used to excite the coaxial resonator 201.

In some implementations, the signal generator 202 can include one or more of the following: an internal power supply; an oscillator (for example, an RF oscillator, a surface acoustic wave resonator, or a yttrium-iron-garnet resonator); and an amplifier. The oscillator can generate a time-varying current and/or voltage (for example, using an oscillator circuit). The internal power supply can provide power to the oscillator. In some implementations, the internal power supply can include, for example, a DC battery (for example, a marine battery, an automotive battery, an aircraft battery, etc.), an alternator, a generator, a solar cell, and/or a fuel cell. In other implementations, the internal power supply can include a rectified AC power supply (for example, an electrical connection to a wall socket passed through a rectifier). The amplifier can magnify the power that is output by the oscillator (for example, to provide sufficient power to the coaxial resonator 201 to excite plasma coronas). For example, the amplifier can multiply the current and/or the voltage output by the oscillator. Additionally, in some implementations, the signal generator 202 can include a dedicated controller that executes instructions to control the signal generator 202.

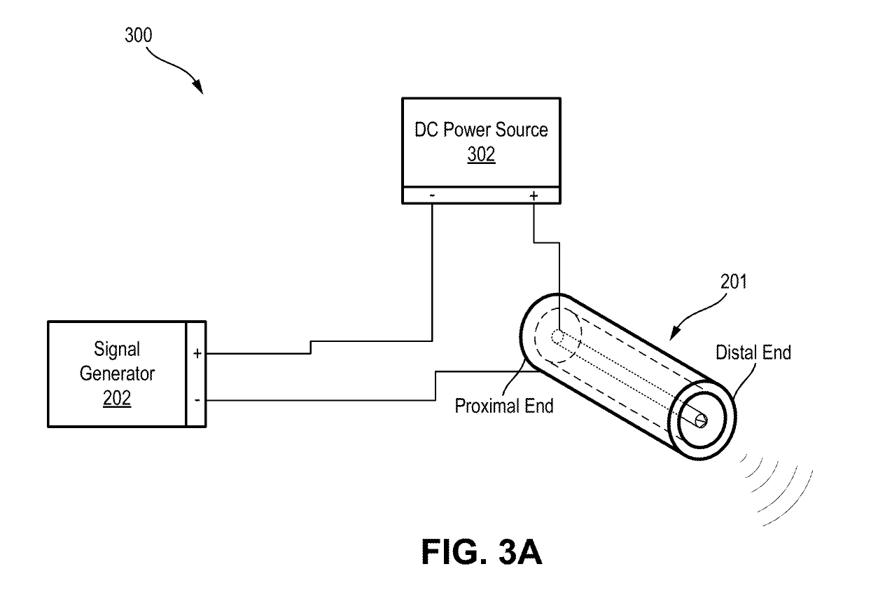

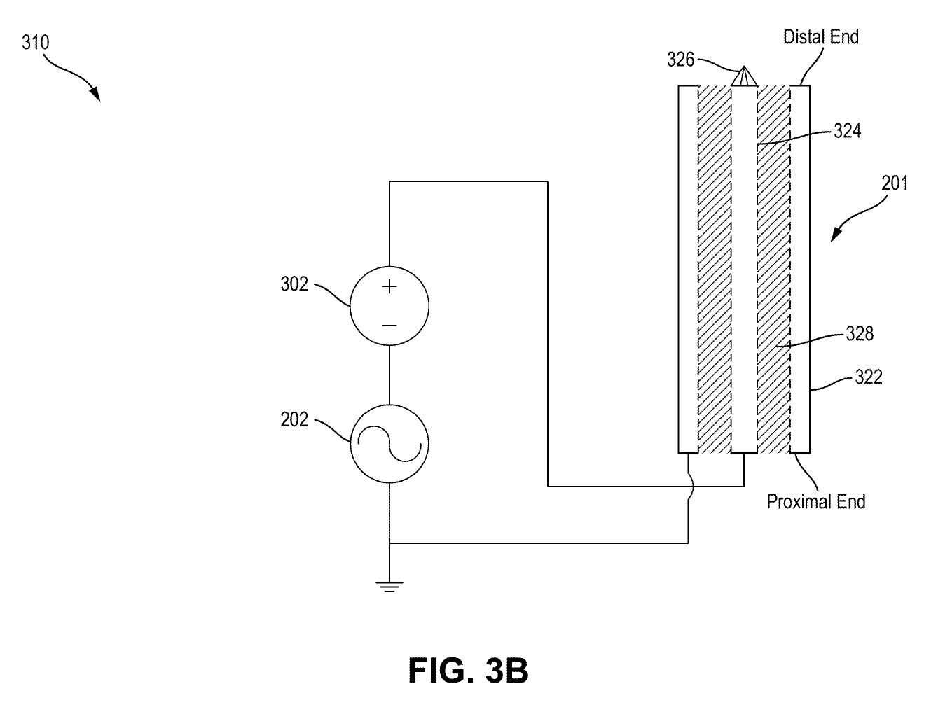

Additionally or alternatively, as illustrated in the system 300 of FIG. 3A, the coaxial resonator 201 can be electrically coupled (for example, using a wired connection or wirelessly) to a DC power source 302. Further, in some implementations, an RF cancellation resonator (not shown) can prevent RF power (for example, from the signal generator 202) from reaching, and potentially interfering with, the DC power source 302. The RF cancellation resonator can include resistive elements, lumped-element inductors, and/or a frequency cancellation circuit.

In some implementations, the DC power source 302 can include a dedicated controller that executes instructions to control the DC power source 302. The DC power source 302 can provide a bias signal (for example, corresponding to a DC bias condition) for the coaxial resonator 201. For example, a DC voltage difference between the inner conductor 104 and the outer conductor 102 of the coaxial resonator 201 in FIG. 3A can be established by the DC power source 302 by increasing the DC voltage of the inner conductor 104 and/or decreasing the DC voltage of the outer conductor 102 (given the orientation of the positive terminal and negative terminal of the DC power source 302). In other implementations, a DC voltage difference between the inner conductor 104 and the outer conductor 102 can be established by the DC power source 302 by decreasing the DC voltage of the inner conductor 104 and/or increasing the DC voltage of the outer conductor 102 (if the orientation of the positive terminal and negative terminal of the DC power source 302 in FIG. 3A were reversed). The bias signal (for example, the voltage of the bias signal and/or the current of the bias signal) output by the DC power source 302 can be adjustable.

By providing the coaxial resonator 201 with a bias signal, an increased voltage can be presented at a concentrator of the electrode 106, thereby yielding an increased electric field at the concentrator of the electrode 106. The total electric field at the concentrator can thus be a sum of the electric field from the bias signal of the DC power source 302 and the electric field from the signal generator 202 exciting the coaxial resonator 201 at a resonance condition (for example, exciting the coaxial resonator 201 at a quarter-wave resonance condition so the electric field of the signal from the signal generator 202 reaches a maximum at the distal end of the coaxial resonator 201). Because of this increased total electric field, an excitation of a plasma corona near the concentrator can be more probable.

As an alternative, rather than using a bias signal, the signal generator 202 can simply excite the coaxial resonator 201 using a higher voltage. However, this might use considerably more power than providing a bias signal and augmenting that bias signal with an AC voltage oscillation.

In some implementations, the DC power source 302 can be switchable (for example, can generate the bias signal when switched on and not generate the bias signal when switched off). As such, the DC power source 302 can be switched on when a plasma corona output is desired from coaxial resonator 201 and can be switched off when a plasma corona output is not desired from coaxial resonator 201. For example, the DC power source 302 can be switched on during an ignition sequence (for example, a sequence where fuel is being ignited within a combustion chamber to begin combustion), but switched off during a reforming sequence (for example, a sequence in which electromagnetic radiation is being used to chemically modify fuel). Further, in some implementations, the electric field at the concentrator of the electrode 106 used to initiate the plasma corona can be larger than the electric field at the concentrator used to sustain the plasma corona. Hence, in some implementations, the DC power source 302 can be switched on in order to excite the plasma corona, but switched off while the plasma corona is maintained by the signal from the signal generator 202.

In alternate implementations, the system 200 of FIG. 2 and/or the system 300 of FIG. 3A can include a plurality of coaxial resonators 201. If the system 200 of FIG. 2 includes a plurality of coaxial resonators 201, the plurality of coaxial resonators 201 can each be electrically coupled to the same signal generator (for example, such that each of the plurality of coaxial resonators 201 is excited by the same signal), can each be electrically coupled to a respective signal generator (for example, such that each of the plurality of coaxial resonators 201 is independently excited, thereby allowing for unique excitation frequency, power, etc. for each of the plurality of coaxial resonators 201), or one set of the plurality of coaxial resonators 201 can be connected to a common signal generator and another set of the plurality of coaxial resonators 201 can be connected to one or more other signal generators, which could be similar or different from signal generator 202. In implementations of the system 300 that include a plurality of coaxial resonators 201, each of the coaxial resonators 201 can be attached to a respective DC power source (for example, multiple instances of DC power source 302) and a common signal generator (for example, such that a bias signal can be independently switchable and/or adjustable for each coaxial resonator 201, while maintaining a common excitation waveform across all coaxial resonators 201 in the system 300), different signal generators and a common DC power source (for example, such that a bias signal can be jointly switchable across all coaxial resonators 201 in the system 300, while maintaining an independent excitation waveform for each coaxial resonator 201), or different DC power sources and different signal generators (for example, such that the bias signal is independently switchable for each coaxial resonator 201, while maintaining an independent excitation waveform for each coaxial resonator 201).

FIG. 3B illustrates a circuit diagram of the system 300 of FIG. 3A, which includes the signal generator 202, the DC power source 302, and the coaxial resonator 201 (illustrated in vertical cross-section). As illustrated, similar to the QWCCR structure 100, the coaxial resonator 201 includes an outer conductor 322, an inner conductor 324 (including an electrode 326), and a dielectric 328. In addition, when the DC power source 302 is switched off, the circuit illustrated in FIG. 3B may not be an open-circuit. Instead, the signal generator 202 can simply be shorted to the inner conductor 324 when the DC power source 302 is switched off As illustrated, the outer conductor 322 can be electrically coupled to ground. Further, the signal generator 202 and the DC power source 302 can be connected in series, with their negative terminals connected to ground. The positive terminals of the signal generator 202 and the DC power source 302 can be electrically coupled to the inner conductor 324. Consequently, the electrode 326 can also be electrically coupled to the positive terminals through an electrical coupling between the inner conductor 324 and the electrode 326.

In alternate implementations, the negative terminals of the signal generator 202 and the DC power source 302 can instead be connected to the inner conductor 324 and the positive terminals can be connected to the outer conductor 322. In this way, the signal generator 202 and the DC power source 302 can instead apply a negative voltage (relative to ground) to the electrode 326 and/or inner conductor 324, rather than a positive voltage (relative to ground). Further, in some implementations, the negative terminals of the DC power source 302 and the signal generator 202 and/or the inner conductor 324 might not be grounded.

As stated above, the DC power source 302 can be switchable. In this way a positive bias signal or a negative bias signal can be selectively applied to the inner conductor 324 and/or the electrode 326 relative to the outer conductor 322. When the DC power source 302 is switched on, a bias condition can be present, and when the DC power source 302 is switched off, a bias condition might not be present. A bias signal provided by the DC power source 302 can increase the electric potential, and thus the electric field, at the electrode 326 (for example, at a concentrator of the electrode 106, such as a tip, edge, or blade). By increasing the electric field at the electrode 326, dielectric breakdown and potentially plasma excitation can be more prevalent. Thus, by switching on the DC power source 302, the amount of plasma excited at a plasma corona can be enhanced.

In some implementations, the voltage of the DC power source 302 can range from +1 kV to +100 kV. Alternatively, the voltage of the DC power source 302 can range from −1 kV to −100 kV. Even further, the voltage of the DC power source 302 can be adjustable in some implementations. Furthermore, the voltage of the DC power source 302 can be pulsed, ramped, etc. For example, the voltage can be adjusted by a controller connected to the DC power source 302. In such implementations, the voltage of the DC power source 302 can be adjusted by the controller according to sensor data (for example, sensor data corresponding to temperature, pressure, fuel composition, etc.).

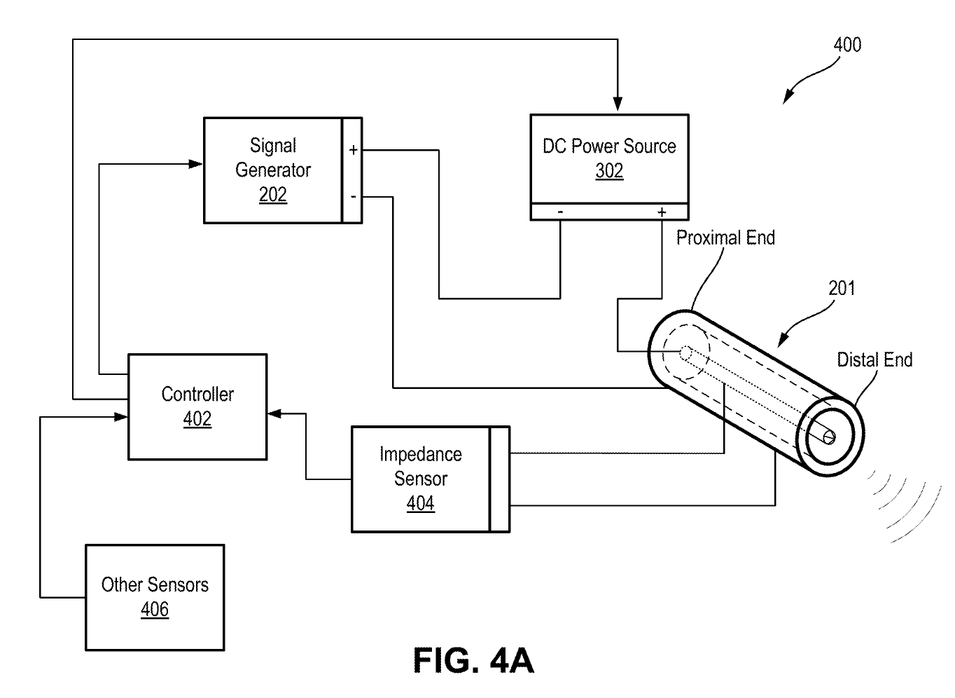

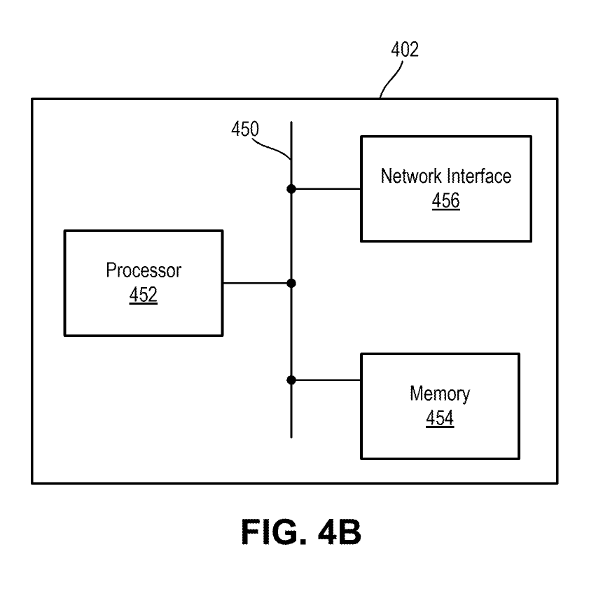

As illustrated in FIG. 4A, an example system 400 can include a controller 402. In various implementations, the controller 402 can include a variety of components. For example, the controller 402 can include a desktop computing device, a laptop computing device, a server computing device (for example, a cloud server), a mobile computing device, a microcontroller (for example, embedded within a control system of a power-generation turbine, an automobile, or an aircraft), and/or a microprocessor. As illustrated, the controller 402 can be communicatively coupled to the signal generator 202, the DC power source 302, an impedance sensor 404, and one or more other sensors 406. Through the communicative couplings, the controller 402 can receive signals/data from various components of the system 400 and control/provide data to various components of the system 400. For example, the controller 402 can switch the DC power source 302 in order to provide a time-modulated bias signal to the coaxial resonator 201 (for example, during an ignition sequence within a combustion chamber adjacent to, coupled to, or surrounding the coaxial resonator 201).

Further, a “communicative coupling,” as presently disclosed, is understood to cover a broad variety of connections between components, based on context. “Communicative couplings” can include direct and/or indirect couplings between components in various implementations. In some implementations, for example, a “communicative coupling” can include an electrical coupling between two (or more) components (for example, a physical connection between the two (or more) components that allows for electrical interaction, such as a direct wired connection used to read a sensor value from a sensor). Additionally or alternatively, a “communicative coupling” can include an electromagnetic coupling between two (or more) components (for example, a connection between the two (or more) components that allows for electromagnetic interaction, such as a wireless interaction based on optical coupling, inductive coupling, capacitive coupling, or coupling though evanescent electric and/or magnetic fields). In addition, a “communicative coupling” can include a connection (for example, over the public internet) in which one or more of the coupled components can transmit signals/data to and/or receive signals/data from one or more of the other coupled components. In various implementations, the “communicative coupling” can be unidirectional (in other words, one component sends signals and another component receives the signals) or bidirectional (in other words, both components send and receive signals). Other directionality combinations are also possible for communicative couplings involving more than two components. One example of a communicative coupling could be the controller 402 communicatively coupled to the coaxial resonator 201, where the controller 402 reads a voltage and/or current value from the resonator directly. Another example of a communicative coupling could be the controller 402 communicating with a remote server over the public Internet to access a look-up table. Additional communicative couplings are also contemplated in the present disclosure.

In some implementations, the controller 402 can control one or more settings of the signal generator 202 (for example, waveform shape, output frequency, output power amplitude, output current amplitude, or output voltage amplitude) or the DC power source 302 (for example, switching on or off or adjusting the level of the bias signal). For example, the controller 402 can control the bias signal of the DC power source 302 (for example, a voltage of the bias signal) based on a calculated voltage used to excite a plasma corona (for example, based on conditions within a combustion chamber). The calculated voltage can account for the voltage amplitude being output by the signal generator 202, in some implementations. The calculated voltage can ensure, for example, that the bias signal has a small effect on any standing electromagnetic wave formed within the coaxial resonator 201 based on an output of the signal generator 202.

The controller 402 can be located nearby the signal generator 202, the DC power source 302, the impedance sensor 404, and/or the one or more other sensors 406. For example, the controller 402 may be connected by a wire connection to the signal generator 202, the DC power source 302, the impedance sensor 404, and/or the one or more other sensors 406. Alternatively, the controller 402 can be remotely located relative to the signal generator 202, the DC power source 302, the impedance sensor 404, and/or the one or more other sensors 406. For example, the controller 402 can communicate with the signal generator 202, the DC power source 302, the impedance sensor 404, and/or the one or more other sensors 406 over BLUETOOTH®, over BLUETOOTH LOW ENERGY (BLE)®, over the public Internet, over WIFI® (IEEE 802.11 standards), over a wireless wide area network (WWAN), etc.

In some implementations, the controller 402 can be communicatively coupled to fewer components within the system 400 (for example, only communicatively coupled to the DC power source 302). Further, in implementations that include fewer components than illustrated in the system 400 (for example, in implementations, having only the coaxial resonator 201, the signal generator 202, and the controller 402), the controller 402 can interact with fewer components of the system 400. For instance, the controller can interact only with the signal generator 202.

The impedance sensor 404 can be connected to the coaxial resonator 201 (for example, one lead to the inner conductor 324 of the coaxial resonator 201 and one lead to the outer conductor 322 of the coaxial resonator 201) to measure an impedance of the coaxial resonator 201. In some implementations, the impedance sensor 404 can include an oscilloscope, a spectrum analyzer, and/or an AC volt meter. The impedance measured by the impedance sensor 404 can be transmitted to the controller 402 (for example, as a digital signal or an analog signal). In some implementations, the impedance sensor 404 can be integrated with the controller 402 or connected to the controller 402 through a printed circuit board (PCB) or other mechanism. The impedance data can be used by the controller 402 to perform calculations and to adjust control of the signal generator 202 and/or the DC power source 302.

Similarly, the other sensors 406 can also transmit data to the controller 402. Analogous to the impedance sensor 404, in some implementations, the other sensors 406 can be integrated with the controller 402 or connected to the controller 402 through a PCB or other mechanism. The other sensors 406 can include a variety of sensors, such as one or more of: a fuel gauge, a tachometer (for example, to measure revolutions per minute (RPM)), an altimeter, a barometer, a thermometer, a sensor that measures fuel composition, a gas chromatograph, a sensor measuring fuel-to-air ratio in a given fuel/air mixture, an anemometer, a torque sensor, a vibrometer, an accelerometer, or a load cell.

In some implementations, the controller 402 can be powered by the DC power source 302. In other implementations, the controller 402 can be independently powered by a separate DC power source or an AC power source (for example, rectified within the controller 402).

As an example, a possible implementation of the controller 402 is illustrated in FIG. 4B. As illustrated, the controller 402 can include a processor 452, a memory 454, and a network interface 456. The processor 452, the memory 454, and the network interface 456 can be communicatively coupled over a system bus 450. The system bus 450, in some implementations, can be defined within a PCB.

The processor 452 can include one or more central processing units (CPUs), such as one or more general purpose processors and/or one or more dedicated processors (for example, application-specific integrated circuits (ASICs), digital signal processors (DSPs), or network processors). The processor 452 can be configured to execute instructions (for example, instructions stored within the memory 454) to perform various actions. Rather than a processor 452, some implementations can include hardware logic (for example, one or more resistor-inductor-capacitor (RLC) circuits, flip-flops, latches, etc.) that performs actions (for example, based on the inputs from the impedance sensor 404 or the other sensors 406).

The memory 454 can store instructions that are executable by the processor 452 to carry out the various methods, processes, or operations presently disclosed. Alternatively, the method, processes, or operations can be defined by hardware, firmware, or any combination of hardware, firmware, or software. Further, the memory 454 can store data related to the signal generator 202 (for example, control signals), the DC power source 302 (for example, switching signals), the impedance sensor 404 (for example, look-up tables related to changes in impedance and/or a characteristic impedance of the coaxial resonator 201 based on certain environmental factors), and/or the other sensors 406 (for example, a look-up table of typical wind speeds based on elevation).

The memory 454 can include non-volatile memory. For example, the memory 454 can include a read-only memory (ROM), electrically erasable programmable read-only memory (EEPROM), a hard drive (for example, hard disk), and/or a solid-state drive (SSD). Additionally or alternatively, the memory 454 can include volatile memory. For example, the memory 454 can include a random-access memory (RAM), flash memory, dynamic random-access memory (DRAM), and/or static random-access memory (SRAM). In some implementations, the memory 454 can be partially or wholly integrated with the processor 452.

The network interface 456 can enable the controller 402 to communicate with the other components of the system 400 and/or with outside computing device(s). The network interface 456 can include one or more ports (for example, serial ports) and/or an independent network interface controller (for example, an Ethernet controller). In some implementations, the network interface 456 can be communicatively coupled to the impedance sensor 404 or one or more of the other sensors 406. Additionally or alternatively, the network interface 456 can be communicatively coupled to the signal generator 202, the DC power source 302, or an outside computing device (for example, a user device). Communicative couplings between the network interface 456 and other components can be wireless (for example, over WIFI®, BLUETOOTH®, BLUETOOTH LOW ENERGY (BLE)®, or a WWAN) or wireline (for example, over token ring, t-carrier connection, Ethernet, a trace in a PCB, or a wire connection).

In some implementations, the controller 402 can also include a user-input device (not shown). For example, the user-input device can include a keyboard, a mouse, a touch screen, etc. Further, in some implementations, the controller 402 can include a display or other user-feedback device (for example, one or more status lights, a speaker, a printer, etc.) (not shown). That status of the controller 402 can alternatively be provided to a user device through the network interface 456. For example, a user device such as a personal computer or a mobile computing device can communicate with the controller 402 through the network interface 456 to retrieve the values of one or more of the other sensors 406 (for example, to be displayed on a display of the user device).

VI. Resonators with Fuel Injection

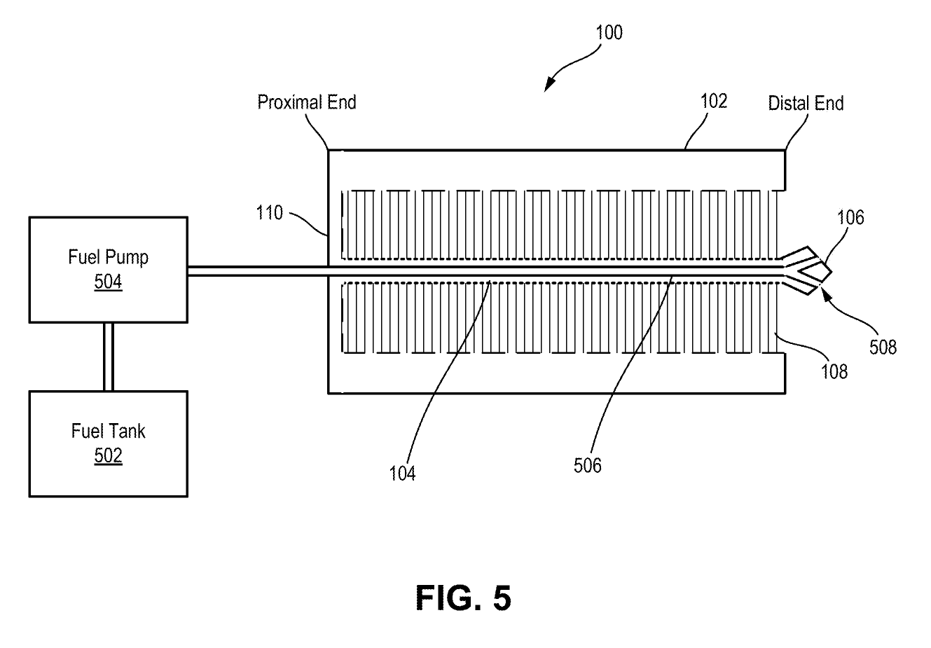

As illustrated in FIG. 5, in some implementations, the QWCCR structure 100 (or the coaxial resonator 201) can be attached to a fuel tank 502. The fuel tank 502 can provide a fuel source for a combustion chamber or other environment, for example. The fuel tank 502 can contain or be connected to a fuel pump 504 through a fuel-supply line (for example, a hose or a pipe). The fuel pump 504 can transfer fuel from the fuel tank 502 into the fuel-supply line and propel the fuel through a fuel conduit 506 defined by or disposed within the inner conductor 104 of the QWCCR structure 100. For example, the fuel pump 504 can include a mechanical pump (for example, gear pump, rotary vane pump, diaphragm pump, screw pump, peristaltic pump) or an electrical pump. In some implementations, the fuel tank 502 can include various sensors (for example, a pressure sensor, a temperature sensor, or a fuel-level sensor). Such sensors can be electrically connected to the controller 402 in order to provide data regarding the status of the fuel tank 502 to the controller 402, for example. Additionally or alternatively, the fuel pump 504 can be connected to the controller 402. Through such a connection, the controller 402 could control the fuel pump 504 (for example, to switch the fuel pump on and off, set a fuel injection rate, etc.).

In some implementations, the fuel conduit 506 can inject fuel (for example, into a combustion chamber) at one or more outlets 508 defined within the electrode 106 (for example, within a concentrator of the electrode 106). By conveying fuel through the fuel conduit 506 and out one or more outlets 508, fuel can be introduced proximate to a source of ignition energy (for example, proximate to a plasma corona generated near a concentrator of the electrode 106), which can allow for efficient combustion and ignition. In alternate implementations, one or more outlets can be defined with other locations of the fuel conduit 506 (for example, so as not to interfere with the electric field at the concentrator of the electrode 106).

In some implementations, the fuel conduit 506 can act, at least in part, as a Faraday cage (for example, by encapsulating the fuel within a conductor that makes up the fuel conduit 506) to prevent electromagnetic radiation in the QWCCR structure 100 from interacting with the fuel while the fuel is transiting the fuel conduit 506. In other structures, the fuel conduit 506 can allow electromagnetic radiation to interact with (for example, reform) the fuel within the fuel conduit 506.

In some implementations, the QWCCR structure 100 can include multiple fuel conduits 506 (for example, multiple fuel conduits running from the proximal end of the QWCCR structure 100 to the distal end of the QWCCR structure 100). Additionally or alternatively, one or more fuel conduits 506 can be positioned within the dielectric 108 or within the outer conductor 102. As described above, the outlet(s) 508 of the fuel conduit(s) 506 can be oriented in such as a way as to expel fuel toward concentrators (for example, tips, edges, or points) of one or more electrodes 106 (for example, toward regions where plasma coronas are likely to be excited).

### VII. Additional Resonator Implementations

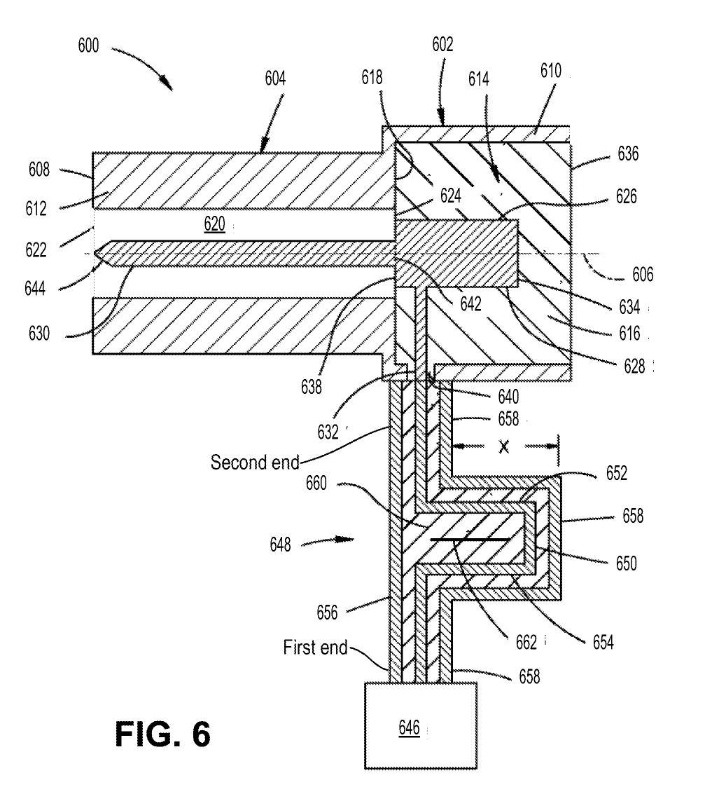

FIG. 6 illustrates a cross-sectional view of an example alternative coaxial resonator 600 connected to a DC power source through an additional resonator assembly acting as an RF attenuator, in accordance with example implementations. The coaxial resonator 600 is an assembly of two quarter-wave coaxial cavity resonators that are coupled together. More specifically, the coaxial resonator 600 includes a first resonator 602 and a second resonator 604 electrically coupled in a series arrangement along a longitudinal axis 606. In some implementations, the coaxial resonator 600 includes a DC bias condition established at a node of the voltage standing wave (for example, between quarter-wave segments). In such implementations, there may be no impedance mismatch. Because there is no impedance mismatch, the diameters of the inner conductor and the outer conductor of the first resonator 602 can be different than the diameters of the inner conductor and the outer conductor of the second resonator 604, respectively, without impacting the quality factor (Q). In such a way, the DC bias condition might not affect or interact with the AC signal coming from a signal generator.

The first resonator 602 and the second resonator 604 are defined by a common outer conductor wall structure 608. The outer conductor wall structure 608 includes a first cylindrical wall 610 and a second cylindrical wall 612 centered on the longitudinal axis 606. The first cylindrical wall 610 is constructed of a conducting material and surrounds a first cylindrical cavity 614 centered on the longitudinal axis 606. The first cylindrical cavity 614 is filled with a dielectric 616 having a relative dielectric constant approximately equal to four (εᵣ≈4), for example.

In the example implementation of FIG. 6, the first resonator 602 and the second resonator 604 adjoin one another in a connection plane 618 that is perpendicular to the longitudinal axis 606. In other examples, the connection plane 618 might not be perpendicular to the longitudinal axis 606, and can instead be designed with a different configuration that maintains constant impedance between the first resonator 602 and the second resonator 604.

The second cylindrical wall 612 is constructed of a conducting material and surrounds a second cylindrical cavity 620 that is also centered on the longitudinal axis 606. The second cylindrical cavity 620 is coaxial with the first cylindrical cavity 614, but can have a greater physical length. The second cylindrical wall 612 provides the second cylindrical cavity 620 with a distal end 622 spaced along the longitudinal axis 606 from a proximal end 624 of the second cylindrical cavity 620.

A center conductor structure 626 is supported within the conductor wall structure 608 of the coaxial resonator 600 by the dielectric 616. The center conductor structure 626 includes a first center conductor 628, a second center conductor 630, and a radial conductor 632.

The first center conductor 628 reaches within the first cylindrical cavity 614 along the longitudinal axis 606. In the example implementation shown in FIG. 6, the first center conductor 628 has a proximal end 634 adjacent a proximal end 636 of the first cylindrical cavity 614, and has a distal end 638 adjacent the distal end 624 of the first cylindrical cavity 614. The radial conductor 632 projects radially from a location adjacent the distal end 638 of the first center conductor 628, across the first cylindrical cavity 614, and outward through an aperture 640.

The second center conductor 630 has a proximal end 642 at the distal end 638 of the first center conductor 628. The second center conductor 630 projects along the longitudinal axis 606 to a distal end 644 configured as an electrode tip located at or in close proximity to the distal end 622 of the second cylindrical cavity 620.

To reduce any mismatch in impedances between the first resonator 602 and the second resonator 604, the relative radial thicknesses between both the cylindrical walls 610, 612 and the respective center conductors 628, 630 are defined in relation to the relative dielectric constant of the dielectric 616 and the dielectric constant of the air or gas that fills the second cylindrical cavity 620. In the example implementation of FIG. 6, the physical length of the second center conductor 630 along the longitudinal axis 606 is approximately twice the physical length of the first center conductor 628 along the longitudinal axis 606. However, based at least in part on the dielectric 616 having a relative dielectric constant approximately equal to four, the electrical lengths of the two center conductors 628 and 630 are approximately equal.

In example implementations, any gaps between any of the center conductors 628, 630 and any outer conductor could be filled with a dielectric and/or the gap (for example, the second cylindrical cavity 620) could be large enough to reduce arcing (in other words, large enough such that the electric field is not of sufficient intensity to result in a dielectric breakdown of air or the intervening dielectric). As further shown in FIG. 6, the dielectric 616 fills the first cylindrical cavity 614 around the first center conductor 628 and the radial conductor 632.

In the illustrated example, a DC power source 646 is connected to the center conductor structure 626 through the radial conductor 632 connected adjacent to a virtual short-circuit point of the DC power source 646.

An RF control component, specifically, an RF frequency cancellation resonator assembly 648 is disposed between the radial conductor 632 and the DC power source 646 to restrict RF power from reaching the DC power source 646. The RF frequency cancellation resonator assembly 648 is an additional resonator assembly having a center conductor 650. The center conductor 650 has a first portion 652 and a second portion 654, each of which has the same electrical length “X” illustrated in FIG. 6 (and the same electrical length as the first center conductor 628 and the second center conductor 630).

In an example implementation, the electrical length “X” depicted in FIG. 6 can be sized such that the center conductor 650 is an odd-integer multiple of half wavelengths (for example, ½λ₀, 3/2λ₀, 5/2λ₀, 7/2λ₀, 9/2λ₀, 11/2λ₀, 13/2λ₀, etc.) out of phase (in other words, 180° out of phase) with the outer conducting wall 656 and the outer conducting wall 658, simultaneously, where λ₀ is the resonant wavelength, and where the resonant wavelength λ₀ is inversely related to the frequency of the RF power. In alternative implementations, a similar “folded” structure to the electrical length “X” could be located within the cylindrical cavity 614 to achieve a similar phase shift between the inner conductor and the outer conductor.

The RF frequency cancellation resonator assembly 648 also has a short outer conducting wall 656 and a long outer conducting wall 658. The short outer conducting wall 656 has first and second ends on opposite ends of the RF frequency cancellation resonator assembly 648. The long outer conducting wall 658 also has first and second ends on opposite ends of the RF frequency cancellation resonator assembly 648. The first and second ends of the short outer conducting wall 656 are each on the opposite side of the RF frequency cancellation resonator assembly 648 from the corresponding first and second ends of the long outer conducting wall 658.

In an example implementation, the difference in electrical length between the short outer conducting wall 656 and the long outer conducting wall 658 is substantially equal to the combined electrical length of the first portion 652 and the second portion 654. In this example, the combined electrical length of the first portion 652 and the second portion 654 is substantially equal to twice the electrical length of the first center conductor 628.

In an example implementation, the short outer conducting wall 656 and the long outer conducting wall 658 surround a cavity 660 filled with a dielectric. In operation, with this example implementation, electric current running along the outer conductor of the RF frequency cancellation resonator assembly 648 primarily follows the shortest path and run along the short outer conducting wall 656. Accordingly, electric current on the outer conductor of the RF frequency cancellation resonator assembly 648 travels two fewer quarter-wavelengths than current running along the center conductor 650 of the RF frequency cancellation resonator assembly 648.

In examples, the RF frequency cancellation resonator assembly 648 can also have an internal conducting ground plane 662 disposed within the cavity 660 and between the first portion 652 and the second portion 654 of the center conductor 650. Based on the geometry of the cancellation resonator assembly 648, this configuration provides a frequency cancellation circuit connected between the DC power source 646 and the radial conductor 632.

Further, in examples, the RF frequency cancellation resonator assembly 648 is configured to shift a voltage supply of RF energy 180 degrees out of phase relative to the ground plane 662 of the coaxial resonator 600 due to the difference in electrical length between the short outer conducting wall 656 and the center conductor 650 of the RF frequency cancellation resonator assembly 648.

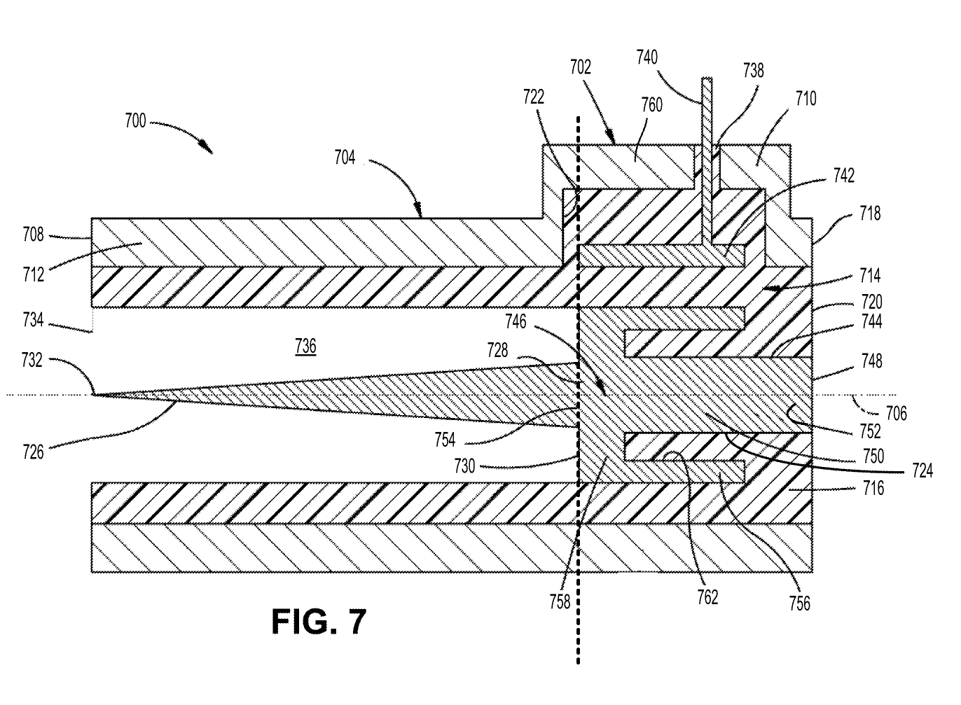

FIG. 7 illustrates a cross-sectional view of another example alternative coaxial resonator 700 connected to a DC power source through an additional resonator assembly acting as an RF attenuator, in accordance with an example implementation. The coaxial resonator 700 includes a first resonator portion 702 and a second resonator portion 704 electrically coupled in a series arrangement along a longitudinal axis 706.

As depicted in FIG. 7, the first resonator portion 702 and the second resonator portion 704 are defined by a common outer conductor wall structure 708. The wall structure 708 includes a first cylindrical wall portion 710 and a second cylindrical wall portion 712 centered on the longitudinal axis 706. The first cylindrical wall portion 710 is constructed of a conducting material and surrounds a first cylindrical cavity 714 centered on the longitudinal axis 706. In this example implementation, the first cylindrical cavity 714 is filled with a dielectric 716.

An annular edge 718 of the first cylindrical wall portion 710 defines a proximal end 720 of the first cylindrical cavity 714. A proximal end of the second cylindrical wall portion 712 adjoins a distal end 722 of the first cylindrical cavity 714.

The coaxial resonator 700 further includes a first center conductor portion 724 and a second center conductor portion 726 (the center conductor portions 724, 726 represented by the densest cross-hatching in FIG. 7). For illustration, the first center conductor portion 724 and the second center conductor portion 726 are separated by the vertical dashed line in FIG. 7. In some implementations, both the first center conductor portion 724 and the second center conductor portion 726 can correspond to an odd-integer multiple of quarter wavelengths based on the frequency of an RF power source used to excite the coaxial resonator 700. The second center conductor portion 726 has a proximal end 728 adjoining a distal end 730 of the first center conductor portion 724. The second center conductor portion 726 projects along the longitudinal axis 706 to a distal end configured as a concentrator 732 (for example, a tip) of an electrode located at or in close proximity to a distal end 734 of a second cylindrical cavity 736.

The coaxial resonator 700 has an aperture 738 that reaches radially outward through the first cylindrical wall portion 710. A radial conductor 740 extends out through the aperture 738 from the longitudinal axis 706 to be connected to an RF power source (for example, the signal generator 202) by an RF power input line. The end of the radial conductor 740 that is closer to the longitudinal axis 706 connects to a parallel plate capacitor 742 that is in a coupling arrangement to a center conductor structure 744. The parallel plate capacitor 742 is also in a coupling arrangement to an inline folded RF attenuator 746. The spacing between the parallel plate capacitor 742 and the center conductor structure 744 can depend on the materials used for fabrication (for example, the materials used to fabricate the parallel plate capacitor 742, the center conductor structure 744, and/or the dielectric 716).

In an example, the DC power source 646 described above is connected to the center conductor structure 744 at a proximal end 748 of the center conductor structure 744 with a DC power input line. The inline folded RF attenuator 746 is disposed between the second resonator portion 704 and the DC power source 646 to restrict RF power from reaching the DC power source 646.

The inline folded RF attenuator 746 includes an interior center conductor portion 750 having a proximal end 752 and a distal end 754. The inline folded RF attenuator 746 also includes an exterior center conductor portion 756 and a transition center conductor portion 758 that connects or couples the interior center conductor portion 750 and the exterior center conductor portion 756.

The exterior center conductor portion 756 has a proximal end largely in the same plane as the proximal end 752, and a distal end largely in the same plane as the distal end 754. For example, in the cross-sectional illustration of FIG. 7, the plane of the proximal end 752 and the plane of the proximal end of the exterior center conductor portion 756 can be the plane of the cross-section that is illustrated. In this example implementation, the transition center conductor portion 758 is located proximal to the distal end 754. The exterior center conductor portion 756 surrounds the interior center conductor portion 750.

In this example, the exterior center conductor portion 756 resembles a cylindrical portion of conducting material surrounding the rest of the interior center conductor portion 750. The longitudinal lengths of the interior center conductor portion 750 and the exterior center conductor portion 756 are substantially equal to the longitudinal length of the parallel plate capacitor 742 with which they are in a coupling arrangement. The electrical length between the proximal end 752 to the distal end 754, for both the interior center conductor portion 750 and the exterior center conductor portion 756, is substantially equal to one quarter-wavelength. The second center conductor portion 726 and the second cylindrical wall portion 712 are both configured to have an electrical length of one quarter-wavelength.

The wall structure 708 includes a short outer conducting portion 760 which has a proximal end largely in the same plane as the proximal end 752, and a distal end largely in the same plane as the distal end 754. An outer conducting path runs from the distal end of the wall structure 708 (that is substantially coplanar with the distal end 734 of the second cylindrical cavity 736), along the short outer conducting portion 760, and stops at the proximal end 720 of the first cylindrical wall portion 710. In this example, the outer conducting path has an electrical length of two quarter-wavelengths.

An inner conducting path runs from the concentrator 732 to the proximal end 728 of the second center conductor portion 726, along the outside of the transition center conductor portion 758, then along the outside from the distal end to the proximal end of the exterior center conductor portion 756, then along an interior wall 762 of the exterior center conductor portion 756 from its proximal end to its distal end, then along the interior center conductor portion 750 from its distal end to its proximal end. In this example, the electrical length of this inner conducting path is four quarter-wavelengths, or two half wavelengths. The difference in electrical lengths between the inner conducting path and the outer conducting path is one half wavelength.

With this configuration, the inline folded RF attenuator 746 operates as a radio-frequency control component connected between the DC power source 646 and the voltage supply of RF energy. The inline folded RF attenuator 746 is configured to shift a voltage supply of RF energy 180 degrees out of phase relative to the ground plane of the coaxial resonator 700.

The particular arrangement depicted in FIG. 7 is not limiting with respect to the orientation of the inline folded RF attenuator 746. In other examples, the entire arrangement depicted in FIG. 7 can be “stretched,” with the inline folded RF attenuator 746 being disposed further away from the concentrator 732 and not directly coupled to the parallel plate capacitor 742. For example, the inline folded RF attenuator 746 could be separated by one quarter-wavelength from the portion of the center conductor that would remain in direct coupling arrangement with the parallel plate capacitor 742. The coaxial resonator 700 can achieve a maximize efficiency when (i) the inline folded RF attenuator 746 is an odd-integer multiple of quarter wavelengths from the concentrator 732; and (ii) the inline folded RF attenuator 746 is an odd-integer multiple of quarter wavelengths in electrical length.

In another example, the arrangement depicted in FIG. 7 could be more compressed, with the exterior center conductor portions 756 of the inline folded RF attenuator 746 extending longitudinally as far as the parallel plate capacitor 742 and also surrounding the portion of center conductor exposed for plasma creation. This can be implemented by arranging the center conductor structure 744 in the middle so that the exterior center conductor portions 756 extends in either direction longitudinally. Any particular geometry of this arrangement can involve adjusting the various parameters of dielectrics to ensure impedance matching and full 180 degree phase cancellation.

In one example, the arrangements described with respect to FIGS. 6 and 7 and the particular combination of components that provide the RF signal to the coaxial resonators are contained in a body dimensioned approximately the size of a gap spark igniter and adapted to mate with a combustor (for example, of an internal combustion engine). As an example for illustration, a microwave amplifier could be disposed at the resonator, and the resonator could be used as the frequency determining element in an oscillator amplifier arrangement. The amplifier/oscillator could be attached at the top or back of an igniter, and could have the high voltage supply also integrated in the module with diagnostics. This example permits the use of a single, low-voltage DC power supply for feeding the module along with a timing signal.

### VIII. Jet Engines

The above coaxial resonators could be usefully employed in the context of a gas turbine such as a jet turbine configured to power an aircraft. For example, a coaxial cavity resonator similar to the coaxial resonator 201 illustrated in FIG. 2 could be used in a gas turbine. While reference is made to “QWCCR,” “QWCCR structure,” and “coaxial resonator” elsewhere in the description, it will be understood that other types of resonators are possible and contemplated.

An example gas turbine includes a compressor coupled to a turbine through a shaft, and the gas turbine also includes a combustion chamber or area, called a combustor. In operation, atmospheric air flows through a compressor that brings the air to higher pressure. Energy is then added by spraying fuel into the air and igniting it so the combustion generates a high-temperature, high-pressure gas flow. The high-temperature, high-pressure gas enters a turbine, where it expands down to an exhaust pressure, producing a shaft work output at the shaft coupled to the turbine in the process.

The shaft work output is used to drive the compressor and other devices (for example, an electric generator) that can be coupled to the shaft. The energy that is not used for shaft work comes out in the exhaust gases that can include a high temperature and/or a high velocity. Gas turbines can be utilized to power aircraft, trains, ships, electrical generators, pumps, gas compressors, and tanks, among other machines.

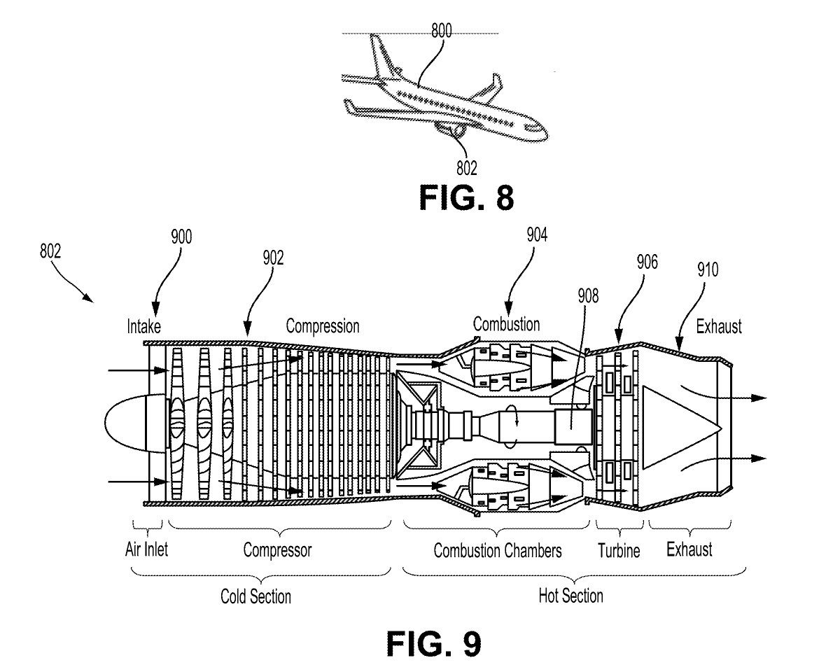

FIG. 8 illustrates an aircraft 800 having a jet engine 802, according to example implementations. To help propel the aircraft 800 through the air, the aircraft 800 includes a propulsion system operable to generate thrust. The jet engine 802 is a gas turbine engine that is part of the propulsion system of the aircraft 800. The aircraft 800 can include several jet engines (for example, 2 or 4) similar to the jet engine 802 coupled to wings of the aircraft 800, for example. The jet engine 802 includes several components of a gas turbine such as the compressor, the combustor, and the turbine.

FIG. 9 illustrates several components of the jet engine 802, according to an example implementation. As illustrated, the jet engine 802 is configured as a gas turbine engine. Large amounts of surrounding air (free stream) are continuously brought into an inlet or intake 900. At the rear of the intake 900, the air enters a compressor 902 (axial, centrifugal, or both). The compressor 902 operates as many rows of airfoils, with each row producing an increase in pressure. At the exit of the compressor 902, the air is at a much higher pressure than free stream at the intake 900.

Fuel is mixed with the compressed air exiting the compressor 902, and the fuel-compressed air mixture is burned in a combustor 904, generating a flow of hot, high pressure gas. The hot, high pressure gas exiting the combustor 904 then passes through a turbine 906, which extracts energy from the flow of gas by making turbine blades spin in the flow. The energy extracted by the turbine 906 is then used to turn the compressor 902 by coupling the compressor 902 and the turbine 906 by a central shaft 908.

The turbine 906 transforms or converts some energy of the hot gas to drive the compressor 902, but there is enough energy left over to provide thrust to the jet engine 802 by increasing velocity of the flow of gas through a nozzle 910 disposed adjacent the turbine 906. Because the exit velocity is greater than the free stream velocity, thrust is created and the aircraft 800 is propelled.

Several variations could be made to the jet engine 802. For instance, the jet engine 802 could be configured as a turbofan engine or a turboprop engine where additional components are added to the several components illustrated in FIG. 9.

The combustor 904, which can also be referred to as a burner, combustion chamber, or flame holder, comprises the area of the jet engine 802 where combustion takes place. The combustor 904 is configured to contain and maintain stable combustion despite high air flow rates. As such, in examples, the combustor 904 is configured to mix the air and fuel, ignite the air-fuel mixture, and then mix in more air to complete the combustion process.

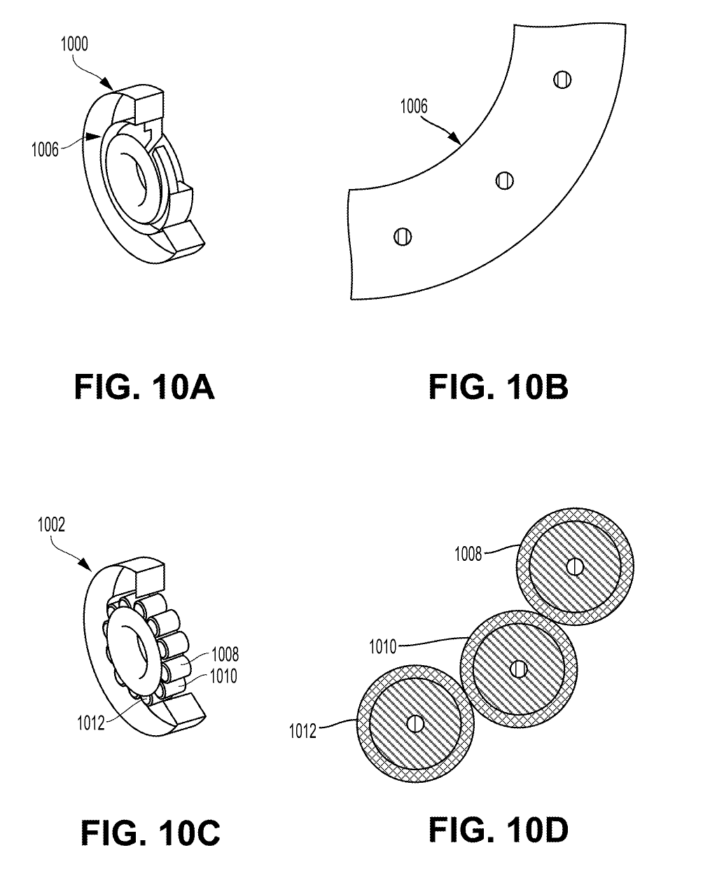

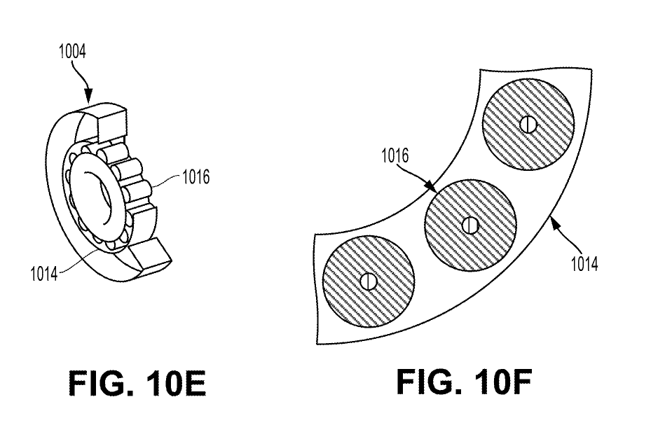

FIGS. 10A, 10B, 10C, 10D, 10E, 10F illustrate example types of combustors, according to example implementations. In particular, FIG. 10A illustrates a partial perspective view of an annular combustor 1000, and FIG. 10B illustrates a partial frontal view of the annular combustor 1000. FIG. 10C illustrates a partial perspective view of a tubular or can combustor 1002, and FIG. 10D illustrates a partial frontal view of the can combustor 1002. FIG. 10E illustrates a partial perspective view of a can-annular combustor 1004, and FIG. 10F illustrates a partial frontal view of the can-annular combustor 1004.

The annular combustor 1000 shown in FIGS. 10A-10B has an annular cross section and has a liner sitting inside an outer casing, which has been peeled open in FIG. 10A for illustration. The annular combustor 1000 does not define separate combustion zones, but rather has a continuous liner and casing forming a ring 1006 (the annulus).

The can combustor 1002 shown in FIGS. 10C and 10D includes multiple combustion cans such as combustion cans 1008, 1010, and 1012 arranged in a radial array about a central shaft. Each combustion can is a self-contained cylindrical combustion chamber that has both a liner and a casing. Each combustion can has its own fuel injector, igniter, liner, and casing. The primary air from the compressor 902 is guided into each individual combustion can, where it is decelerated, mixed with fuel, and then ignited. Secondary air also comes from the compressor 902, where it is fed outside of the liner. The secondary air is then fed, for example, through slits in the liner, into the combustion zone to cool the liner using thin film cooling.

In example implementations, multiple combustion cans are arranged around the jet engine 802, and their shared exhaust is fed to the turbine 906. However, the can combustor 1002 can weigh more than other combustor configurations and can be characterized by higher pressure drop across the combustion cans than other combustor configurations.

The can-annular combustor 1004 shown in FIGS. 10E-10F includes an annular casing 1014 and can-shaped liners, such as liner 1016. The can-annular combustor 1004 has discrete combustion zones contained in separate liners with their own fuel injectors. Unlike the can combustor 1002, the combustion zones of the can-annular combustor 1004 share a common ring (annulus) casing (for example, annular casing 1014). Each combustion zone of the can-annular combustor 1004 does not operate as a separate pressure vessel; rather, the combustion zones “communicate” with each other through liner holes or connecting tubes that allow some air to flow circumferentially between the combustion zones. Further, rather than having separate igniters for each combustion can, once combustion takes place in one or two combustion cans of the can-annular combustor 1004 cans, combustion could spread to and ignite the other combustion cans due to communication between the combustion zones through the liner holes or connecting tubes.

Regardless of the type of combustor, the combustion process inside the combustor 904 can determine, at least partially, many of the operating characteristics of the jet engine 802, such as fuel efficiency, levels of emissions, and transient response (the response to changing conditions such a fuel flow and air speed). Further, also regardless of the type of combustor, the combustor 904 has several components that can be used, and these several components are described below.

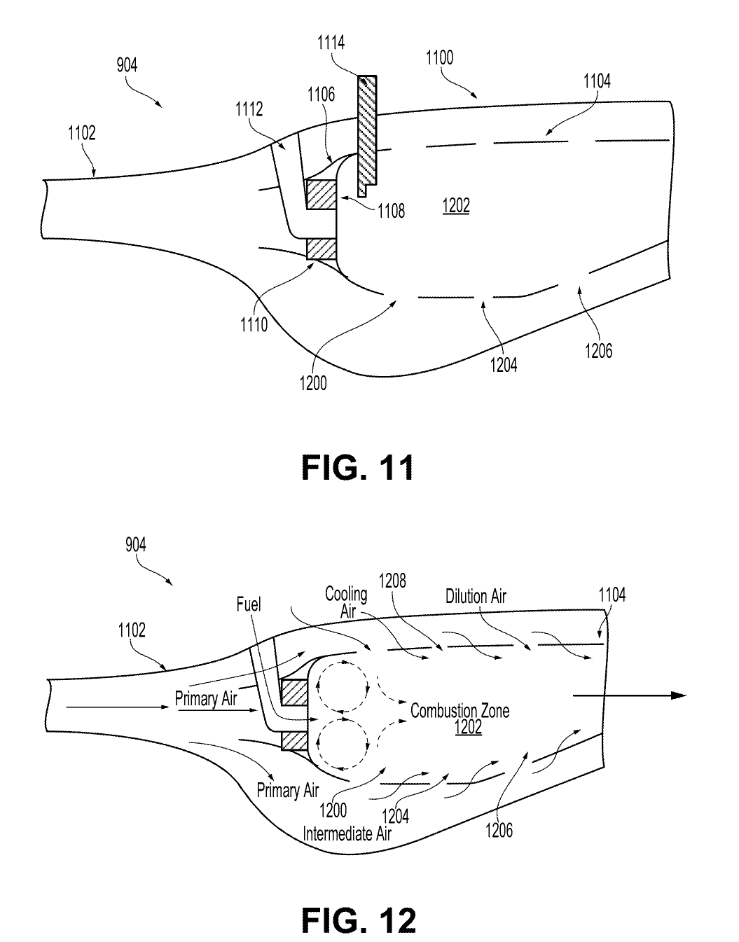

FIG. 11 illustrates a schematic diagram of a partial view of the combustor 904, according to an example implementation. The combustor 904 includes a casing 1100 that is configured as an outer shell of the combustor 904. The casing 1100 can be protected from thermal loads by the air flowing in it, and can operate as a pressure vessel that withstands the difference between the high pressures inside the combustor 904 and the lower pressure outside the combustor 904.

The combustor 904 also includes a diffuser 1102 that is configured to slow the high speed, highly compressed air from the compressor 902 to a velocity optimal for the combustor 904. Reducing the velocity results in a loss in total pressure, and the diffuser 1102 is configured to limit such loss of pressure. The diffuser 1102 is also configured to limit flow distortion by avoiding flow effects like boundary layer separation.

The combustor 904 further includes a liner 1104 that contains the combustion process and is configured to withstand extended high temperature cycles, and therefore can be made from superalloys. Furthermore, the liner 1104 is cooled with air flow. In some example implementations, in addition to air cooling, the combustor 904 can include thermal barrier coatings to further cool the liner 1104.

FIG. 12 illustrates air flow paths through the combustor 904, according to an example implementation. Primary air is the main combustion air and is highly compressed air from the compressor 902. The primary air can be decelerated using the diffuser 1102 and is fed through primary air holes 1200. This air is mixed with fuel, and then combusted in a combustion zone 1202.

Intermediate air is the air injected into the combustion zone 1202 through intermediate air holes 1204. The air injected through the intermediate air holes 1204 completes the combustion processes, cooling the air down and diluting concentrations of carbon monoxide (CO) and hydrogen (H₂).

Dilution air is air injected through dilution air holes 1206 in the liner 1104 at the end of the combustion zone 1202 to help cool the air to before it reaches the turbine 906. The dilution air can be used to produce the uniform temperature profile desired in the combustor 904.

Cooling air is air that is injected through cooling air holes 1208 in the liner 1104 to generate a layer (film) of cool air to protect the liner 1104 from the high combustion temperatures. The combustor 904 is configured such that the cooling air does not directly interact with the combustion air and combustion process.

Referring back to FIG. 11, the combustor 904 further includes a snout 1106, which is an extension of a dome 1108. The snout 1106 operates as an air splitter, separating the primary air from the secondary air flows (intermediate, dilution, and cooling air).

The dome 1108 and a swirler 1110 are the components of the combustor 904 through which the primary air flows as it enters the combustion zone 1202. The dome 1108 and the swirler 1110 are configured to generate turbulence in the flow to rapidly mix the air with fuel. The swirler 1110 establishes a local low pressure zone that forces some of the combustion products to recirculate, creating high turbulence. However, the higher the turbulence, the higher the pressure loss is for the combustor 904, so the dome 1108 and the swirler 1110 are configured to not generate more turbulence than is sufficient to mix the fuel and air. In some examples, with the resonators disclosed in the present disclosure, the combustor 904 can be configured without the dome 1108 and the swirler 1110. In other examples, the dome 1108 and the swirler 1110 can be made smaller when the combustor resonators disclosed in the present disclosure are used because the flame front propagation can be faster than when a conventional igniter is used.

The combustor 904 further includes a fuel injector 1112 configured to introduce fuel to the combustion zone 1202 and, along with the swirler 1110, is configured to mix the fuel and air. The fuel injector 1112 can be configured as any of several types of fuel injectors including: pressure-atomizing, air blast, vaporizing, and premix/prevaporizing injectors.

Pressure atomizing fuel injectors rely on high fuel pressures (as much as 1200 pounds per square inch (psi)) to atomize the fuel. When using this type of fuel injector, the fuel system is configured to be sufficiently robust to withstand such high pressures. The fuel tends to be heterogeneously atomized, resulting in incomplete or uneven combustion, which generates pollutants and smoke.

The air-blast injector “blasts” fuel with a stream of air, atomizing the fuel into homogeneous droplets, and can cause the combustor 904 to be smokeless. This air blast injector can operate at lower fuel pressures than the pressure atomizing fuel injector.

The vaporizing fuel injector is similar to the air-blast injector in that the primary air is mixed with the fuel as it is injected into the combustion zone 1202. However, with the vaporizing fuel injector the fuel-air mixture travels through a tube within the combustion zone 1202. Heat from the combustion zone 1202 is transferred to the fuel-air mixture, vaporizing some of the fuel to enhance the mixing before the mixture is combusted. This way, the fuel is combusted with low thermal radiation, which helps protect the liner 1104. However, the vaporizer tube can have low durability because of the low fuel flow rate within it causing the tube to be less protected from the combustion heat.

The premixing/prevaporizing injector is configured to mix or vaporize the fuel before it reaches the combustion zone 1202. This way, the fuel is uniformly mixed with the air, and emissions from the jet engine 802 can be reduced. However, fuel can auto-ignite or otherwise combust before the fuel-air mixture reaches the combustion zone 1202, and the combustor 904 can thus be damaged.

In some example implementations, a resonator could be configured with fuel passages disposed within the resonator, such that the resonator integrates operations of the fuel injector 1112 with operations of an igniter described below. In these examples, the resonator could be configured to perform the atomization and vaporization of the fuel in addition to mixing and preparing the fuel for combustion. The fuel would then be passed through a formed plasma to ensure ignition. Further, the presence of electromagnetic waves radiated by the resonator could be used to energize the air-fuel mixture and stimulate combustion.

The combustor 904 also includes an igniter 1114 configured to ignite air-fuel mixture to cause combustion. In examples, the igniter 1114 can be configured as an electrical spark igniter, similar to an automotive spark plug. However, there are several disadvantages to such configuration as described below. The igniter 1114 is disposed proximate to the combustion zone 1202 where the fuel and air are already mixed, but is located upstream from the combustion location so that it is not damaged by the combustion itself. In example implementations, once combustion is initially started by the igniter 1114, the combustion is self-sustaining and the igniter 1114 is no longer used. In the annular combustor 1000 and the can-annular combustor 1004, the flame can propagate from one combustion zone to another, so igniters might not be used at each combustion zone.

However, in some examples, combustion can stop due to operating conditions that are not favorable to sustaining combustion. For example, the aircraft 800 can operate at high altitude with low air density, which might affect combustion. In another example, a speed of the aircraft 800 can be sufficiently low to stop the combustion process. Other operating conditions could cause the combustion to stop. In these examples, the igniter 1114 could also be used to restart combustion.

In some systems, ignition-assisting techniques can be used to restart combustion. One such method is oxygen injection, where oxygen is fed to the ignition area, helping the fuel to easily combust. This is particularly useful in some aircraft applications where the jet engine 802 may have to restart at high altitude. Further, described in the present disclosure are igniters and systems that could lower the probability of stopping and having to restart combustion. Particularly, the igniter 1114 could be configured as any of the resonators described in the present disclosure to enhance combustion. In some examples, if the igniter 1114 is configured as a coaxial resonator, the coaxial resonator could be used as a sensor to obtain real-time measurements of the conditions inside the combustor 904 and could be used to predict when combustion would stop (for example, when a flameout would occur). Once such a prediction is made, flameout can be precluded (or its likelihood reduced) by proactively performing operations such as adding more fuel, providing additional plasma, and/or increasing compression using the compressor 902, among other possible operations.

In some example implementations of the jet engine 802, combustion can take place in locations within the jet engine 802 other than the combustor 904. For example, in order for an aircraft to fly faster than the speed of sound, the aircraft needs to generate a high thrust to overcome a sharp rise in drag near the speed of sound. To achieve such high thrust, an afterburner can be added to the jet engine. The afterburner can be considered another type of combustor.

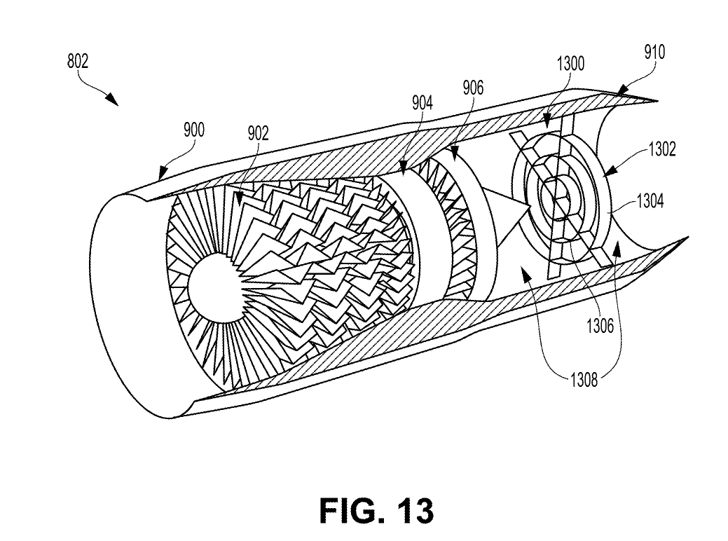

FIG. 13 illustrates the jet engine 802 including an afterburner 1300 downstream of the turbine 906, in accordance with an example implementation. As described above with respect to FIG. 9, some of the energy of the exhaust gas from the combustor 904 is used to turn the turbine 906. The afterburner 1300 is used to add energy to generate more thrust by injecting fuel directly into the hot exhaust gas exiting the turbine 906.

The nozzle 910 of the jet engine 802, as illustrated in FIG. 13, is extended or moved downstream in the jet engine 802 to enable placing flame holders 1302 between the turbine 906 and the exit of the jet engine 802. As shown in FIG. 13, the flame holders 1302 can include multiple hoops, such as hoops 1304, 1306. In another arrangement, the flame holders 1302 can include multiple parallel gutters that extend across an afterburner channel 1308 and perpendicular to the engine axis. In yet another arrangement, the flame holders 1302 can include multiple gutters extending radially from the internal surface of the afterburner channel 1308 in a star pattern with respect to the engine axis. The gutters of the flame holders 1302 can be configured with a u- or v-shaped cross section that is open on a downstream side of the gutter. The flame holders 1302 provide a zone of low velocity air so as to retain gases during their combustion in the afterburner channel 1308.

In some examples, when the afterburner 1300 is turned on, additional fuel is injected through, between, or around the flame holders 1302 and into the gas exiting the turbine 906. In other examples, fuel is injected in the afterburner 1300 upstream of the flame holders 1302. The fuel burns and produces additional thrust.

After passing the turbine 906, the gas from the turbine 906 expands, thus losing temperature. The gas from the turbine 906 is an input gas to the afterburner 1300. Fuel is injected into the input gas from the turbine 906 to produce a fuel-air mixture within an afterburner channel 1308. Combustion of the fuel within the fuel-air mixture within the afterburner channel 1308 results in an exhaust gas from the afterburner 1300 having a temperature and pressure greater than a temperature and pressure, respectively, of the gas from the turbine 906. The exhaust gas resulting from combustion within the afterburner channel 1308 passes through the nozzle 910 at a higher velocity, thereby generating additional thrust.

In some examples, ignition within the afterburner 1300 may be hard to achieve. In particular, because velocities and temperatures do not substantially change at the inlet of the afterburner 1300, ignition in the afterburner 1300 may be difficult to achieve when the aircraft 800 is flying at high altitudes. The difficulty is associated with the low pressure in the afterburner 1300 that affects ignition directly. Therefore, it can be desirable to have a system that better prepares the fuel for easier ignition in the afterburner 1300 at higher altitude.

Further, the exhaust gas from the turbine 906 that enters the afterburner 1300 has reduced oxygen and is not highly compressed due to previous combustion at the combustor 904. Therefore, combustion in the afterburner 1300 is generally fuel-inefficient compared with combustion in the combustor 904. Thus, the afterburner 1300 increases thrust at the cost of increased fuel inefficiency, thereby limiting its practical use to short bursts or intermittent operation. As such, the afterburner 1300 is turned on selectively when the extra thrust is used, but is otherwise turned off. It can thus be desirable to have an afterburner that is more efficient to enable using the afterburner more often and more efficiently to enable persistent, as opposed to intermittent operation.

The combustion taking place at the combustor 904 and the combustion taking place in the afterburner 1300 of the jet engine 802 can affect many of the operating characteristics of the jet engine 802. As examples, combustion determines fuel efficiency, thrust levels, and levels of emissions and transient response (the response to changing conditions such a fuel flow and air speed). It can thus be desirable to have an ignition system that prepares the fuel for efficient and thorough combustion, facilitates starting and restarting ignition when desired regardless of altitude, and enables combustion of a lean fuel mixture at high compression ratios to increase efficiency.

### IX. Example Plasma-Distributing Structures

In the following description, reference will be made to a coaxial resonator, similar to the coaxial resonator 201 illustrated in FIG. 2, for example. However, it will be understood that the principles described in the present disclosure can apply to other types of resonators as well, such as a dielectric resonator, a crystal resonator, a ceramic resonator, a surface-acoustic-wave resonator, a yttrium-iron-garnet resonator, a rectangular-waveguide cavity resonator, a parallel-plate resonator, or a gap-coupled microstrip resonator.

As noted above, in some implementations, a plasma-assisted ignition system can include a plasma-distributing structure, such as a conductor configured to sustain and distribute a plasma corona within an environment. To facilitate this, the plasma-distributing structure can include its own concentrator, or “plasma-distributing concentrator.” The concentrator can concentrate and enhance the electric field at one or more locations of the plasma-distributing structure when a power source causes the plasma-distributing structure, and thus the plasma-distributing concentrator, to be at a particular predetermined voltage. As such, in the context of electric field concentration, the plasma-distributing structure can function similar to the electrode of a coaxial resonator.

Furthermore, the plasma-distributing structure may be arranged in the environment such that its plasma-distributing concentrator is proximate to the plasma corona that will be excited at the coaxial resonator. In some implementations, for instance, the plasma-distributing structure may be arranged near the electrode of the coaxial resonator such that at least a portion of the plasma-distributing concentrator is a predetermined distance away from the electrode. For example, the predetermined distance may be approximately equal to: a predicted length of the plasma corona, a predicted width of the plasma corona, or a predicted radius of the plasma corona, among other possibilities.

Additionally or alternatively, the plasma-distributing structure may be arranged such that at least a portion of the plasma-distributing concentrator is at, or within a predetermined distance away from, a location to which the plasma corona will be directed from the plasma corona's initial location upon generation. The initial location, for example, may be at the concentrator of the electrode of the coaxial resonator.

In practice, various techniques can be used to direct the corona to the plasma-distributing concentrator. These techniques can be used individually or in conjunction with one another. As an example, the frequency of the coaxial resonator, the RF power being delivered to the coaxial resonator, the environmental pressure, and/or other operating conditions of the coaxial resonator can be changed to increase the intensity and/or size of the plasma corona such that the plasma corona reaches the plasma-distributing concentrator. As another example, the coaxial resonator can be arranged in the environment such that aerodynamic effects (natural air flow through the environment and/or fan-generated air flow, for instance) can “blow” the plasma corona from one location to another. Further, as another example, electromagnets and/or ferromagnets can be used to move, bend, or otherwise influence the shape and/or direction of the plasma corona such that the plasma corona reaches the plasma-distributing concentrator. In particular, for electromagnets, a controller can be used to increase the strength of a magnetic field of an electromagnetic coil, which can in turn stretch or “shoot” the plasma corona from the electrode of the coaxial resonator to another location, such as the plasma-distributing concentrator. The process of stretching or “shooting” the plasma corona may in some scenarios disassociate the plasma corona from the electrode, such as when the coaxial resonator is powered down to a certain degree, or shut off entirely, once the plasma corona has been directed to a new location. In other scenarios, however, the plasma corona may remain at the electrode as well. For instance, the plasma corona can extend from its original location to at least the new location, or separate plasma coronas can be sustained, one at its original location and another at the new location.

With the plasma-distributing structure arranged in the manner discussed above, when a plasma corona is excited at the coaxial resonator, the close proximity of the plasma-distributing structure to the plasma corona can result in dielectric breakdown at the plasma-distributing concentrator, provided that the plasma-distributing concentrator is at a high enough predetermined voltage and therefore has a high electric field concentration. In turn, this can effectively establish an additional plasma corona at the plasma-distributing structure. Without limitation, an additional plasma corona can include a new plasma corona that is established at the plasma-distributing concentrator and separate from the original plasma corona that is used to excite the additional plasma corona, and/or can include an extension of the original plasma corona that is used to excite the additional plasma corona.

In practice, the predetermined voltage at the plasma-distributing concentrator could take various forms. For example, the predetermined voltage can be a breakdown voltage of a dielectric (air, for instance) between the electrode and the plasma-distributing concentrator, within a predefined threshold of the breakdown voltage (within 10% of the breakdown voltage, for instance), or at another voltage estimated to be sufficient to cause the plasma corona to be established proximate to the plasma-distributing concentrator. Further, the predetermined voltage may be selected based on a predicted air pressure to which the plasma-distributing structure will be exposed. For instance, a higher voltage may be desirable at higher air pressure, and a lower voltage may be sufficient a lower air pressure.

In some examples, the predetermined voltage can range from 20 kV to 100 kV, relative to a ground voltage, or from −20 kV to −100 kV, relative to a ground voltage. In other examples, the predetermined voltage can be smaller than 20 kV or −20 kV. In some implementations, the predetermined voltage can be adjusted, such as by a controller configured to control a power source that provides a bias signal to the plasma-distributing structure. It will be understood that the voltages described above could provide a desired electric field between the plasma-distributing concentrator and the ground plane or another ground/reference voltage location. As an example, the electric fields contemplated in this disclosure could approach, but not exceed, the dielectric breakdown strength of various dielectric materials. For example, the electric fields could be on the order of a few kV/mm or more.

The plasma-distributing structure may be configured to be electromagnetically coupled to a power source configured to maintain the plasma-distributing concentrator at the predetermined voltage, such as a DC power source. Although implementations in the present disclosure are described primarily with respect to a DC power source, it should be understood that, in some implementations, the power source for maintain the plasma-distributing concentrator at the predetermined voltage could be an AC power source.

In an example implementation, a conducting conduit (for example, a wire or metallic rod) can run from the DC power source and can couple to the plasma-distributing concentrator at a location within the area of influence of the plasma corona (namely, within the charged volume/electron cloud). For instance, a hole can be disposed within the plasma-distributing structure, including the plasma-distributing concentrator, and the conduit can run through the hole, within the plasma-distributing structure, and can couple to an interior of the plasma-distributing concentrator (namely, an interior surface created from the hole disposed within the plasma-distributing concentrator), such as at a location proximate to the tip of the plasma-distributing concentrator. Alternatively, the conduit can run along an outside of the plasma-distributing structure and can couple to an exterior of the plasma-distributing concentrator. Other examples are possible as well, such as an implementation in which a portion of the conduit runs along an exterior of the plasma-distributing structure, and another portion of the conduit runs through an interior of the plasma-distributing structure.

In some implementations, a first DC power source can be connected to the plasma-distributing structure and configured to maintain the plasma-distributing structure at the predetermined voltage, whereas a second, different DC power source (such as DC power source 302) can be connected to the coaxial resonator and configured to power the coaxial resonator. Alternatively, a common DC power source can be connected to both the coaxial resonator and the plasma-distributing structure and can be configured to maintain both structures at the same voltage (or perhaps, with other intervening components, at different voltages).

The plasma-distributing concentrator can be designed so that it is configured to create a high electric field concentration. To facilitate this, the plasma-distributing concentrator can taper, at one or more locations, to an edge or point at which there can be a high electric field concentration. As a specific example, the plasma-distributing concentrator can include a thin blade, such as a blade having a thickness that ranges from 0.1 mm to 1 mm. In some examples, the blade might have a thickness that ranges from 0.01 mm to 0.1 mm, if mechanically feasible.

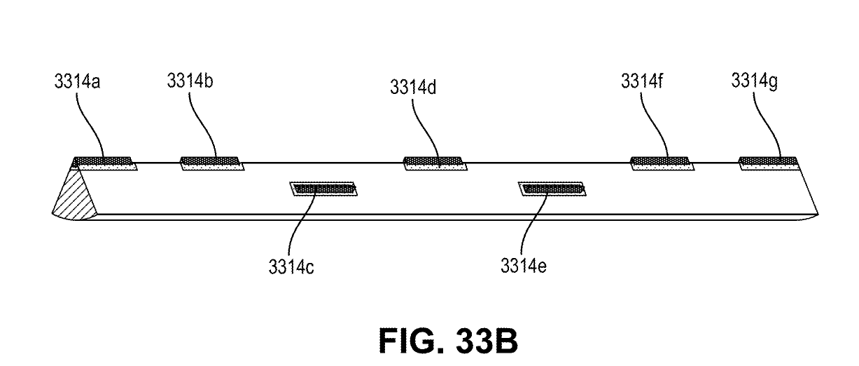

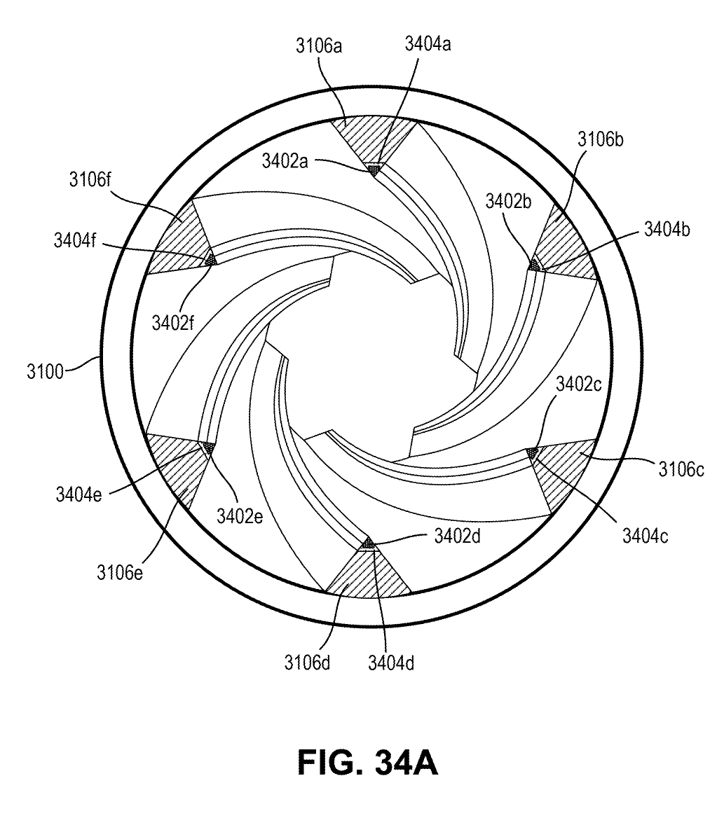

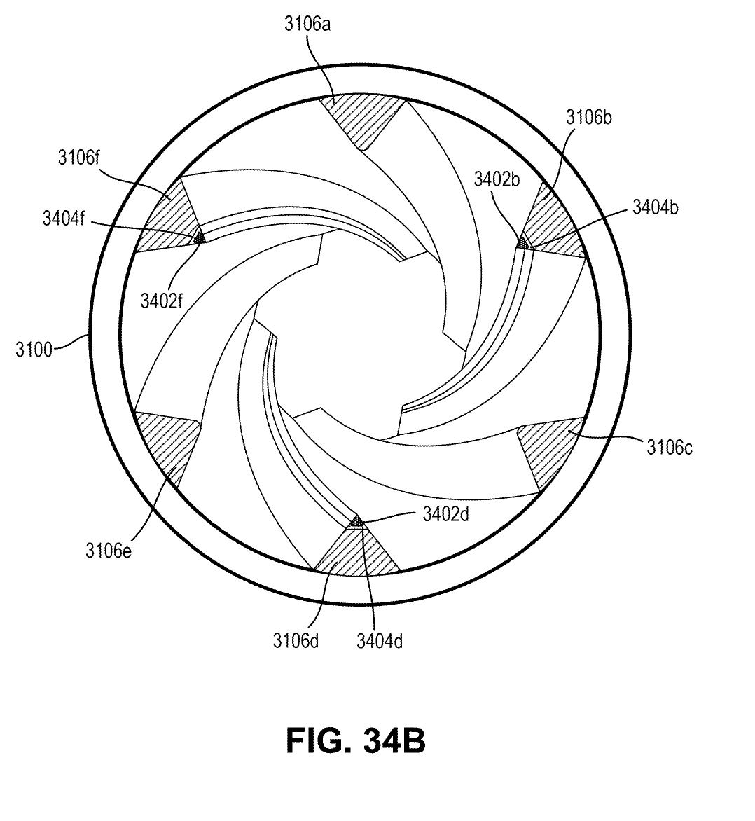

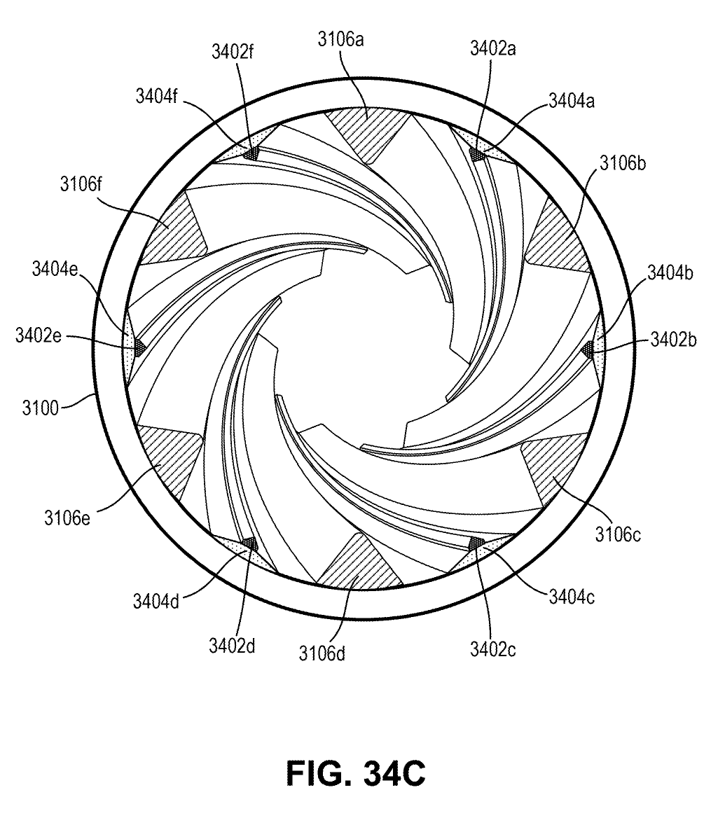

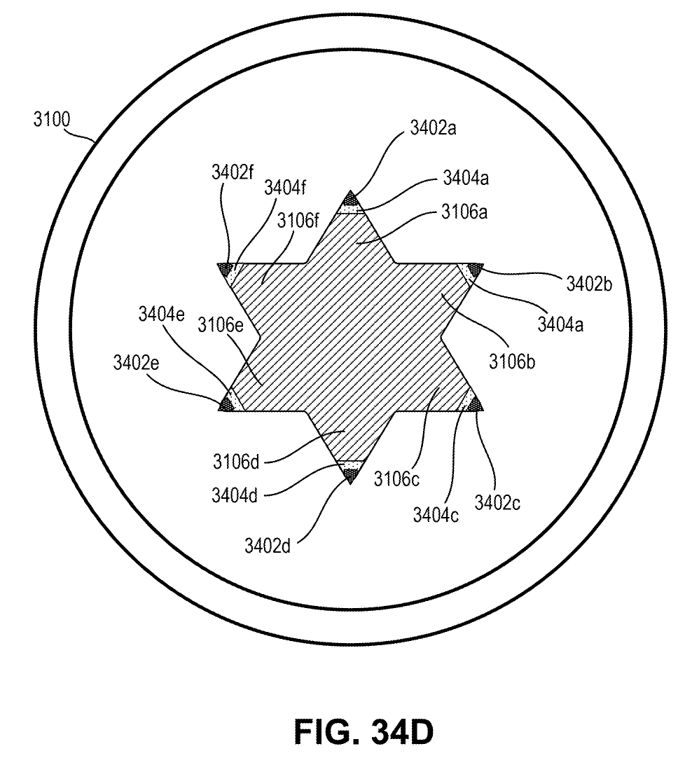

As a general matter, and in line with the discussion above, the electric field concentration at the plasma-distributing concentrator can be represented by the following formula:

$$E = \frac{{V}_{m ax} - {V}_{m i n}}{d}$$

where E is the electric field concentration, Vₘₐₓ is the voltage at the plasma-distributing structure, Vₘᵢₙ is a ground plane voltage, and d is a distance separating the plasma-distributing structure and the ground plane. The present disclosure describes many example implementations in which the ground plane is a surface of an interior wall of a combustion chamber. However, it should be understood that the ground plane can take other forms as well. By way of example, the ground plane can be one or more conducting rails suspended near the plasma-distributing structure, such as at a location between the plasma-distributing structure and a center of the combustion chamber, a location at the center of the combustion chamber, a location at the same distance from the interior wall as the plasma-distributing concentrator, or at a location between the interior wall and the plasma-distributing concentrator. Such rails can have a similar shape as the plasma-distributing structure, or can have a different shape. Further, such rails can be arranged such that they project in the same direction as the plasma-distributing structure, though this is not required. Still further, a flat, conducting sheet can be used as an alternative to a rail. As another example, the ground plane can be an intermediate surface located between the interior wall of the combustion chamber and the plasma-distributing concentrator. As yet another example, the ground plane can be a strut or other structure configured to house, hold, or otherwise support the plasma-distributing structure in the combustion chamber. As yet another example, the ground plane can be a surface of a fin structure included in the combustion chamber, such as any of example fins 3106a-f described with regard to FIGS. 33A-33B or FIGS. 34A-34D. Other examples are possible as well. In any of these examples, the separation, d, between the plasma-distributing structure and the ground plane should be selected such that dielectric breakdown between the plasma-distributing structure and the ground plane does not occur.

In some implementations, a plasma-distribution system can include a dielectric, or other type of insulating material, configured to electrically insulate the plasma-distributing structure from other portions of the environment. For instance, the insulating material can be a high-density polyethylene, Teflon™, or can take other forms.

In an example implementation, when plasma distribution is to occur in a combustion chamber having an interior wall that is a conductor, the insulating material can be coupled to the interior wall, and the plasma-distributing structure can in turn be coupled to the insulating material. In such implementations, the insulating material can have predetermined dimensions configured to separate the plasma-distributing structure from the interior wall far enough so that the plasma-distribution structure is electrically insulated from the interior wall and/or so that dielectric breakdown between the plasma-distributing structure and the interior wall does not occur. Additionally or alternatively, the insulating material can be configured to have a predetermined dielectric strength that will reduce or eliminate the chances of breakdown. In any event, a breakdown may lead to the plasma-distributing structure being shorted to the interior wall, and thus the plasma-distributing concentrator might not be able to be maintained at the predetermined voltage. In practice, the insulating dielectric selected for use in separating the plasma-distributing structure from the interior wall of the combustion chamber (or other ground plane) need not be the same type of dielectric that is used in the coaxial resonator.

The plasma-distributing structure can be coupled to the insulating material in various ways. By way of example, a portion of the plasma-distributing structure can include one or more holes such as blind holes and/or through holes. Further, the insulating material can include one or more dimples or other protrusions configured to fit into to the one or more holes of the plasma-distributing structure and thereby lock the plasma-distributing structure into the insulating material. Additionally or alternatively, each of a portion of the plasma-distributing structure and a portion of the insulating material can include respective threading configured to fasten the plasma-distributing structure to the insulating material. Additionally or alternatively, the plasma-distributing structure and the insulating material can be coupled using a tongue in groove technique, with the plasma-distributing structure including a groove and the insulating material including a tongue, or vice versa. Additionally or alternatively, the plasma-distributing structure and the insulating material can be coupled using pressure fittings, mechanical clips, rivets, screws, and/or other fasteners. Other techniques for coupling the plasma-distributing structure and the insulating material to each other are possible as well, each of which can include mechanical fixtures or other mechanical-based techniques for coupling. Furthermore, the insulating material and the interior wall of the combustion chamber can be coupled using any one or more of the techniques described above, and/or other techniques.

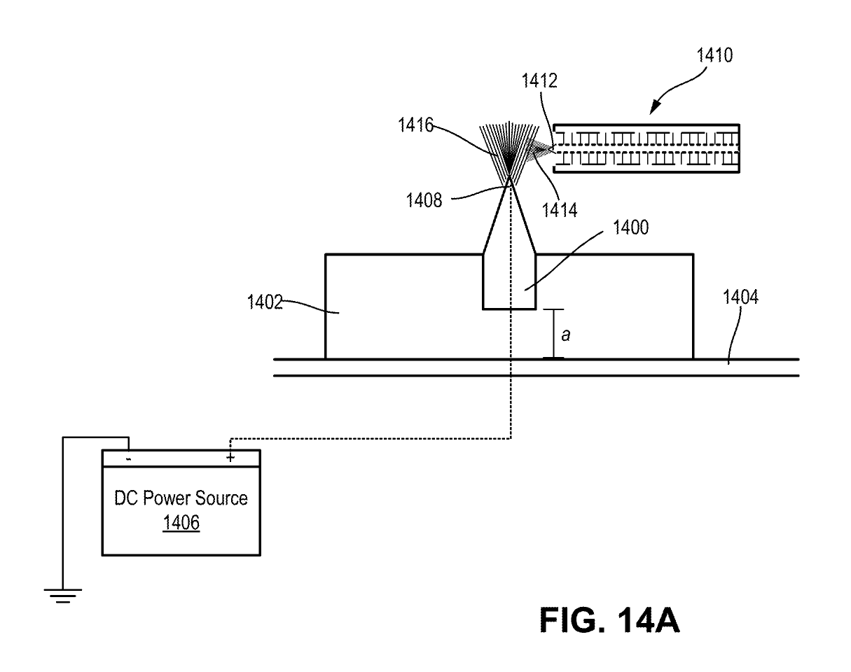

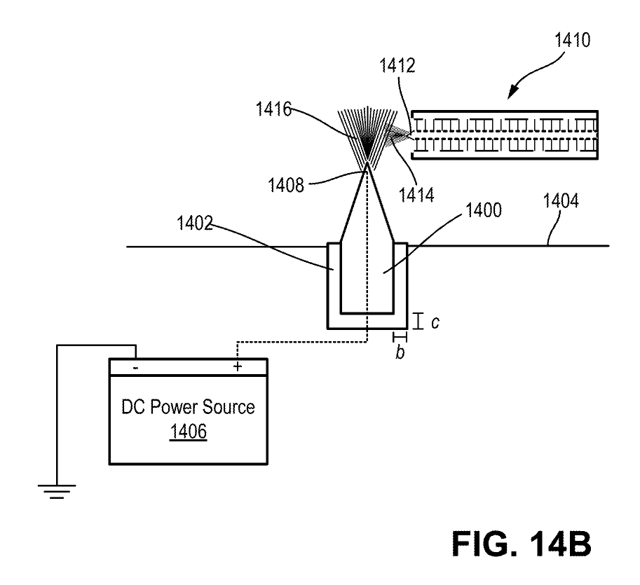

FIG. 14A illustrates a side view of an example arrangement in which a plasma-distributing structure 1400 is coupled to an insulating dielectric 1402 and the dielectric 1402 is in turn coupled to an interior wall 1404 of a combustion chamber. As shown, a DC power source 1406 is connected to a plasma-distributing concentrator 1408 of the plasma-distributing structure 1400. In particular, a wire is connected to the DC power source 1406 and runs through the interior wall 1404, through the insulating dielectric 1402, up through the plasma-distributing structure 1400, and connects to the plasma-distributing concentrator 1408 at a tip of the plasma-distributing structure 1400.

Further, in line with the discussion above, the dielectric 1402 can be selected to be comprised of a material having desirable dielectric strength to avoid breakdown of the dielectric. In addition, the thickness, a, of the dielectric 1402 that separates the plasma-distributing structure 1400 from the interior wall 1404, can be selected to be a desirable thickness to avoid breakdown of the dielectric 1402. In some examples, the dielectric 1402 can include multiple insulating dielectrics, each having desirable dielectric strengths.

Also shown in FIG. 14A is a coaxial resonator 1410 having a concentrator 1412. Although not explicitly shown, the coaxial resonator 1410 could, in practice, be provided in the environment in a variety of manners. As discussed above, the coaxial resonator 1410 can be located such that a plasma corona excited at the coaxial resonator 1410 is proximate to the plasma-distributing concentrator 1408. For example, the coaxial resonator 1410 can be coupled to the interior wall 1404 and run along a side of the plasma-distributing structure 1400 such that the concentrator 1412 of the coaxial resonator 1410 is proximate to the plasma-distributing concentrator 1408. In this example, the coaxial resonator 1410 can either be coupled to an insulator that is in turn coupled to the side of the plasma-distributing structure 1400, or can be coupled near (for example, within the electromagnetic area of influence), but not physically touching, the side of the plasma-distributing structure 1400 without being coupled to an insulator. As another example, the coaxial resonator 1410 can be located farther away from the plasma-distributing concentrator 1408, perhaps at a distance far enough such that it may be desirable to stretch, bend, shoot, blow, or otherwise direct the plasma corona excited at the coaxial resonator 1410 to a location of the plasma-distributing concentrator 1408 using one of the techniques discussed above. The coaxial resonator 1410 can be disposed in the combustion chamber environment in other ways as well.

In operation, when a plasma corona 1414 is excited proximate to a concentrator 1412 of the coaxial resonator 1410, and the plasma-distributing concentrator 1408 is at a predetermined voltage, an additional plasma corona 1416 can be distributed proximate to the plasma-distributing concentrator 1408.

FIG. 14B illustrates a side view of an alternate arrangement in which a portion of the plasma-distributing structure 1400 is disposed in a slot in the interior wall 1404 of the combustion chamber. As shown, the dielectric 1402 is also disposed into the slot and is located between the plasma-distributing structure 1400 and the combustion chamber such that the dielectric 1402 partially encloses the plasma-distributing structure 1400. Further, the plasma-distributing structure 1400 is separated from the interior wall 1404 by a portion of the dielectric 1402 having a first thickness, b, and by another portion of the dielectric 1402 having a second thickness, c. Similar to thickness a in FIG. 14A, thicknesses b and c of the dielectric 1402 can be selected to avoid breakdown of the dielectric 1402. In line with the discussion above, the dielectric 1402 can include multiple insulating dielectrics, each having desirable dielectric strengths.

In some implementations, a plasma-distributing structure can include multiple segments that are each configured to sustain a respective plasma corona. In effect, each segment can be configured as a plasma-distributing structure at which an additional plasma corona can be established. Each segment can include a respective plasma-distributing concentrator and can be connected, in one of the ways discussed above, to a DC power source. In some examples, each segment can be paired with a coaxial resonator and arranged such that excitation of a plasma corona at the coaxial resonator can trigger excitation of an additional plasma corona to the concentrator of the segment. Additionally or alternatively, a single coaxial resonator can be used to trigger plasma distribution to two or more segments. For example, a coaxial resonator can be arranged proximate to two or more segments, such as between two segments. Additionally or alternatively, one segment can be used to distribute an additional plasma corona to another segment. For example, once a first plasma corona is excited at a coaxial resonator and an additional plasma corona is excited at a first segment, various techniques can be used to direct the additional plasma corona to a second segment, thereby distributing yet another plasma corona to the second segment. For instance, such techniques can include aerodynamic effects, ferromagnetism, electromagnetism, and/or other techniques discussed above. Other operations for distributing additional plasma coronas to multiple segments are possible as well.

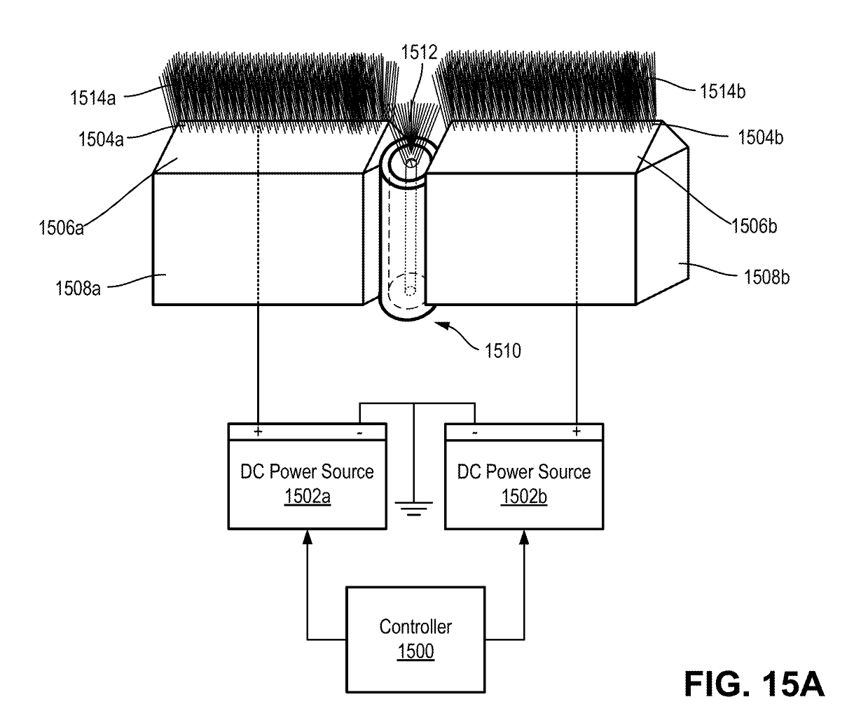

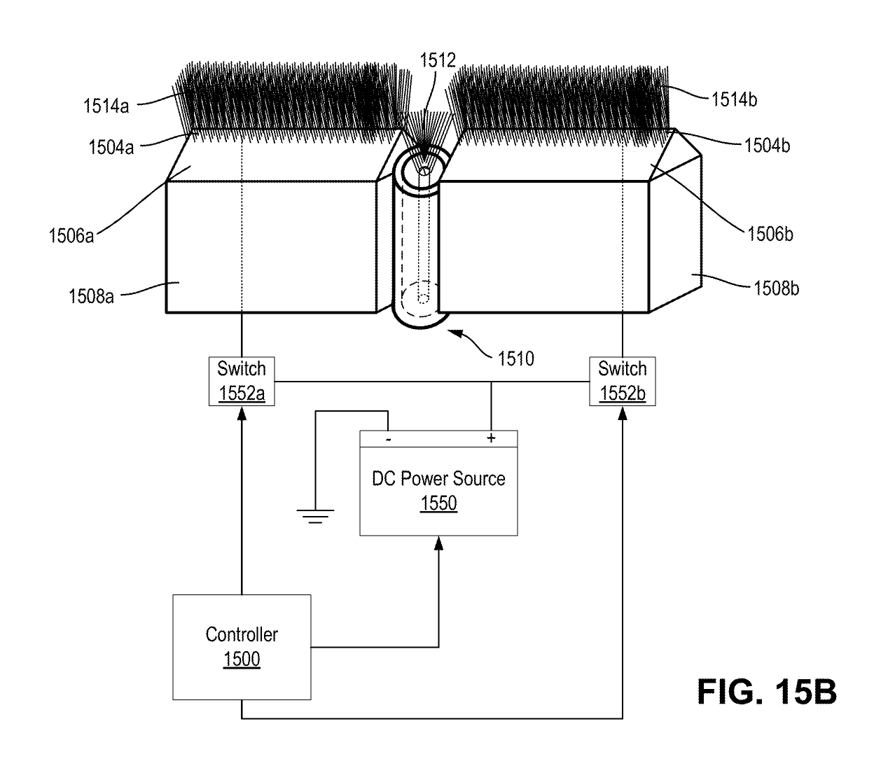

In multi-segment plasma distribution implementations, a control system can provide power to each segment by way of at least one power source. FIGS. 15A and 15B illustrate examples of such implementations.

In particular, FIG. 15A illustrates a controller 1500 configured to control two separate DC power sources: DC power source 1502a and DC power source 1502b. As shown, DC power source 1502a is connected to a first plasma-distributing concentrator 1504b of a first plasma-distributing structure segment 1506a, and DC power source 1502b is connected to a second plasma-distributing concentrator 1504b of a second plasma-distributing structure segment 1506b. Further, segment 1506a is coupled to dielectric 1508a and segment 1506b is coupled to dielectric 1508b. Both dielectric 1508a and 1508b can be coupled to an interior wall (not shown) of a combustion chamber or to another type of surface in an environment. Still further, shown between segment 1506a and segment 1506b is a coaxial resonator 1510, which can be configured as discussed above, connected to a signal generator (not shown) and power source (not shown), etc.

With concentrators 1504a and 1504b maintained at the predetermined voltage, a plasma corona 1512 can be excited at the coaxial resonator 1510, which can trigger excitation of additional plasma coronas 1514a and 1514b proximate to concentrators 1504a and 1504b, respectively. Alternatively, if concentrator 1504A is maintained at the predetermined voltage, but concentrator 1504b is not, the plasma corona 1512 can trigger an additional plasma corona proximate to concentrator 1504a but not concentrator 1504b, and vice versa.

Next, FIG. 15B illustrates controller 1500 connected to, and configured to control, a single DC power source 1550 and two switches, 1552a and 1552b. As shown, DC power source 1550 is connected to switches 1552a and 1552b, switch 1552a is connected to concentrator 1504a, and switch 1552b is connected to concentrator 1504b. With this arrangement, when controller 1500 causes switch 1552a to be on, a bias signal from DC power source 1550 can cause concentrator 1504a to be at the predetermined voltage, whereas, when controller 1500 causes switch 1552a to be off, the bias signal from DC power source 1550 cannot be provided to concentrator 1504a. Likewise, when controller 1500 causes switch 1552b to be on, a bias signal from DC power source 1550 can cause concentrator 1504b to be at the predetermined voltage, whereas, when controller 1500 causes switch 1552b to be off, the bias signal from DC power source 1550 cannot be provided to concentrator 1504b. In other implementations, a plasma-distribution system can include another type of device as an alternative to a switch, such as a variable resistor or other mechanism for controlling how much voltage goes to each concentrator. A variable resistor, for instance, can operate similarly to a switch, particularly by being configured to vary the resistance as a way to control when the bias signal from DC power source 1550 is provided to a given concentrator. For instance, when it is desirable to provide the bias signal to the concentrator, the controller 1500 can control the variable resistor to decrease the resistance to be below a predetermined threshold, whereas when it is desirable not to provide the bias signal to the concentrator, the controller 1500 can control the variable resistor to increase the resistance to be above a predetermined threshold.

It should be noted that, in some implementations, the manner in which the plasma-distributing structures are depicted in the figures, can be exaggerated in scale. For instance, although plasma-distributing structure 1400 is depicted as having a wide, triangular shape, the plasma-distributing structure 1400 can be much thinner in practice, such as a blade that is less than a millimeter in width.

For implementations in which multiple plasma-distributing structures are present in an environment, a dedicated controller, such as controller 402 or a similarly-configured controller, can be configured to control when each such structure is maintained at a respective predetermined voltage. As such, the controller can control when plasma coronas are excited at each structure, since, when a bias signal is removed from a structure, the electric field generated by that structure can collapse, and thus the plasma corona at that structure can disappear. By way of example, the controller can be configured to determine data indicative of a desired plasma-distribution sequence. Alternatively, the controller can be programmed with, receive from another device, or otherwise have access to, the data without determining the plasma-distribution sequence. In any event, this data can specify with varying granularity when to provide each structure with a bias signal with respect to at least one other structure. For example, the data can specify that a bias signal should be provided to one structure at the same time as another structure, twenty seconds after another structure, etc. As a more particular example, in a scenario in which three plasma-distributing segments are present, the data can specify that a bias signal should first be transmitted to a first segment, then to a second segment, and then to a third segment, with ten seconds between transmission of each such signal. Other examples are possible as well.

In implementations in which the controller determines the data indicative of the plasma-distribution sequence, the controller can do so in various ways. For example, the controller can be configured to consider sensor data and/or other types of data indicative of (i) locations within the environment in which a plasma-distributing structure is present and at which a plasma corona may be desired and (ii) an optimal or desired time at which to excite the plasma corona at the location (for instance, within thirty seconds after a flameout is detected. Based on the considerations, the controller can be programmed to determine the data indicative of the plasma-distribution sequence. Other examples are possible as well.

With the data indicative of the plasma-distribution sequence, the controller can then cause one or more DC power sources to provide bias signals to respective plasma-distributing structures according to the determined plasma-distribution sequence. Further, if one or more coaxial resonators in the environment have excited plasma coronas that are proximate to the plasma-distributing structures, the provision of bias signals can lead to excitation of additional plasma coronas to the plasma-distributing structures in the determined plasma-distribution sequence as well. For example, given a plurality of plasma-distributing structure segments, the controller can cause a DC power source to provide a bias signal to respective segments of the plurality, thereby distributing additional plasma coronas to the segments according to the sequence.

In an example implementation, each plasma-distributing structure can be associated with a particular coaxial resonator, and the controller can cause one or more RF power sources to excite plasma coronas at the coaxial resonators in the determined plasma-distribution sequence, or perhaps in a different sequence.

In some scenarios, it may be desirable to use one or more coaxial resonators to excite a plasma corona, thus causing excitation of an additional plasma corona or coronas that have a predetermined shape and occupy a larger space in an environment than the plasma corona that each coaxial resonator generates. For instance, if a plasma-distributing structure having a plasma-distributing concentrator that is three meters in length is located proximate to where a coaxial resonator will excite a plasma corona, the coaxial resonator's excitation of the plasma corona can trigger excitation of an additional plasma corona that is three meters in length, along the plasma-distributing concentrator, even if the coaxial resonator excites the original plasma corona at a concentrator of the coaxial resonator that is millimeters wide or long. In essence, the plasma-distributing structure thus spreads an additional plasma corona across the three-meter length of the structure's plasma-distributing concentrator. By contrast, in some implementations, a plasma-distributing structure can include a plasma-distributing concentrator that can be approximately the same size as the coaxial resonator's concentrator (or perhaps smaller), in which case the additional plasma corona that the plasma-distributing structure distributes might be approximately the same size as the original, coaxial resonator-excited plasma corona. Other implementations are possible as well, such as those where the additional plasma corona is smaller than the original plasma corona.

As a general matter, plasma distribution can occur in various environments. For example, in a combustion chamber environment, it may be desirable to distribute and then sustain a plasma corona that has a predetermined shape and occupies a large space within the combustion chamber. As such, a shape of the plasma-distributing structure and/or a shape of the plasma-distributing concentrator can be selected such that the additional plasma corona excited at the structure has a predetermined shape within the combustion chamber. By way of example, the shape of the plasma-distributing structure can be configured to have the same shape as an interior wall of the combustion chamber. For instance, if the interior wall of the combustion chamber is annular, an annular plasma-distributing structure can be used to distribute an annular “loop” of plasma corona around at least a portion of the combustion chamber. Alternatively, the shape of the plasma-distributing structure can be configured to have a shape different than an interior wall of the combustion chamber. For instance, the interior wall of the combustion chamber can be rectangular, but the plasma-distributing structure can be annular. Other examples are possible as well.

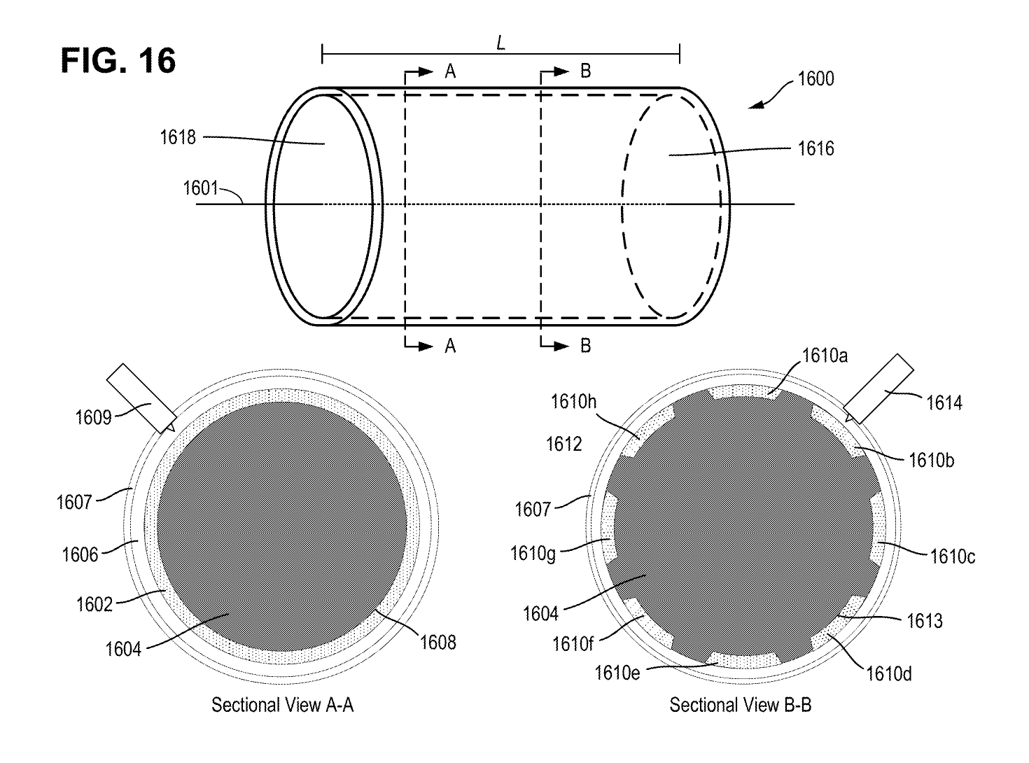

Example plasma-distributing structure configurations will now be described, particularly (by way of example) in the context of a cylindrical combustion chamber, by reference to FIGS. 16, 17A, 17B, 18, 19, 20, 21A, 21B, 21C, and 22. It should be noted, however, that any such configuration can exist in the context of environments other than combustion chambers. In addition, it should be noted that other combustion chamber configurations are possible as well, including combustion chambers of different shapes, such as rectangular-shaped combustion chambers, funnel-shaped combustion chambers, etc.

For each of the configurations shown in FIGS. 16, 17A, 17B, 18, 19, 20, 21A, 21B, 21C, and 22, at least a portion of one or more coaxial resonators could be coupled to and/or located within and/or proximate the respective combustion chamber and used to trigger excitation of one or more additional plasma coronas at each illustrated plasma-distributing structure (including each plasma-distributing structure segment) within the combustion chamber.

FIG. 16 illustrates multiple cross-sectional views of a combustion chamber 1600. In particular, each cross-sectional view shows a cross-section of the combustion chamber 1600 at a different point along a length of the combustion chamber 1600, the length running longitudinally and parallel to a longitudinal axis 1601 of the combustion chamber 1600. In some implementations, the combustion chamber 1600 depicted in FIG. 16 can be a portion of a larger (for instance, longer) combustion chamber 1600.

Sectional view A-A, for instance, shows an annular plasma-distributing structure 1602 is disposed in an interior space 1604 of the combustion chamber 1600, and is coupled to an annular dielectric 1606. The annular dielectric 1606 is in turn coupled to the interior wall 1607 of the combustion chamber 1600. Further, as shown, the annular plasma-distributing structure 1602 is disposed along a circumference of the interior wall 1607 (or, more particularly, along a circumference of the annular dielectric 1606, which is in turn coupled to the interior wall 1607).

The portion of the annular plasma-distributing structure 1602 depicted in sectional view A-A includes a terminus edge 1608 of the annular plasma-distributing structure 1602 (namely, the edge to which the plasma-distributing concentrator can taper, and where the plasma-distributing concentrator of the annular plasma-distributing structure 1602 terminates). For instance, the annular plasma-distributing structure 1602 can be a thin, annular blade having an annular terminus blade edge. Other concentrator forms are possible as well.

Also shown in sectional view A-A is a representative coaxial resonator 1609 configured to excite a plasma corona that is proximate to the annular plasma-distributing structure 1602. In other implementations, one or more other coaxial resonators can be arranged at other locations proximate to the annular plasma-distributing structure 1602. As such, two or more coaxial resonators can be used to provide plasma coronas and distribute an additional plasma corona to the annular plasma-distributing structure 1602, or one coaxial resonator can be used as a backup in case the other coaxial resonator is rendered inoperable.

In some implementations, multiple plasma-distributing structures similar to the structure shown in cross-sectional view A-A can be included at various points along the length of the combustion chamber 1600. Additionally or alternatively, other, different types of structures can be included along the length of the combustion chamber 1600. For instance, sectional view B-B shows eight segments, 1610a-h, of a segmented annular plasma-distributing structure disposed in an interior 1604 of the combustion chamber 1600 and coupled to an annular dielectric 1612. The annular dielectric 1606 is in turn coupled to the interior wall 1607 of the combustion chamber 1600. As shown, the eight segments are arranged in an annular fashion at various points along a circumference of the interior wall 1607 (or, more particularly, along a circumference of the annular dielectric 1612, which is in turn coupled to the interior wall 1607).

The portion of the segments 1610a-h depicted in sectional view B-B each include such a terminus edge for each such segment (namely, the respective edge to which each segment can taper, and where the segment terminates), such as representative terminus edge 1613 of segment 1610d. Each of the segments 1610a-h can be a thin, annular blade having a terminus blade edge. Other concentrator forms are possible as well.

Also shown in sectional view B-B is a representative coaxial resonator 1614 configured to excite a plasma corona that is proximate to segment 1610b. Although not shown in sectional view B-B, multiple other coaxial resonators may be included and each coaxial resonator can be configured to provide plasma coronas proximate to at least one other segment. For instance, the coaxial resonators can be excited in a particular defined sequence to cause sequential excitation of plasma coronas at the segments. Alternatively, the coaxial resonators can be excited simultaneously to cause simultaneous excitation of plasma coronas at the segments.

In some implementations, any given plasma-distributing structure (or segment of a plasma-distributing structure) can be disposed in a manner in which the structure is angled in a direction towards one end 1616 of the combustion chamber or a direction towards another end 1618 of the combustion chamber. For instance, in a scenario where air flows through the combustion chamber, it can be desirable to angle the structure in a direction of air flow through the combustion chamber 1600 so that the air flow does not negatively affect a plasma corona excited at, and sustained at, the structure. As such, if the air flow is from end 1618 to end 1616, the structure can be angled towards end 1616.

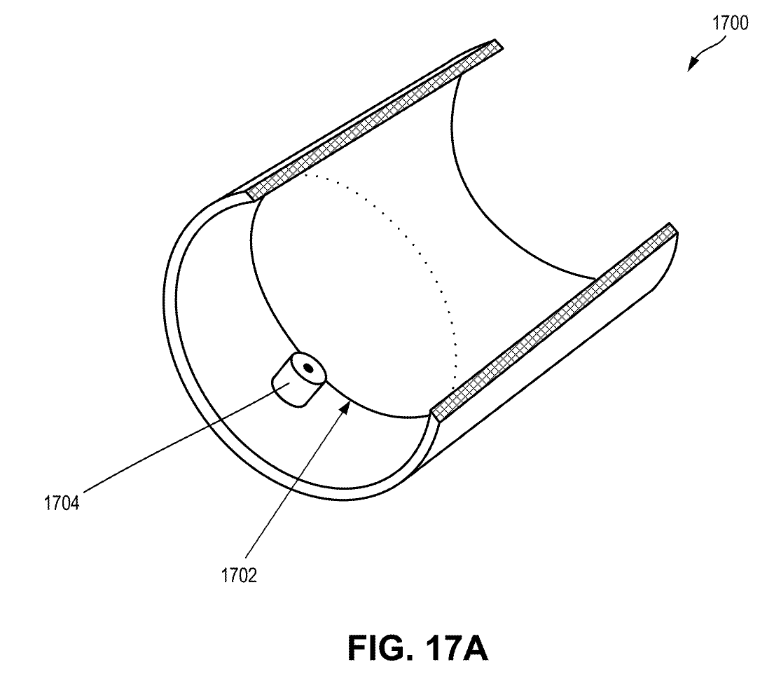

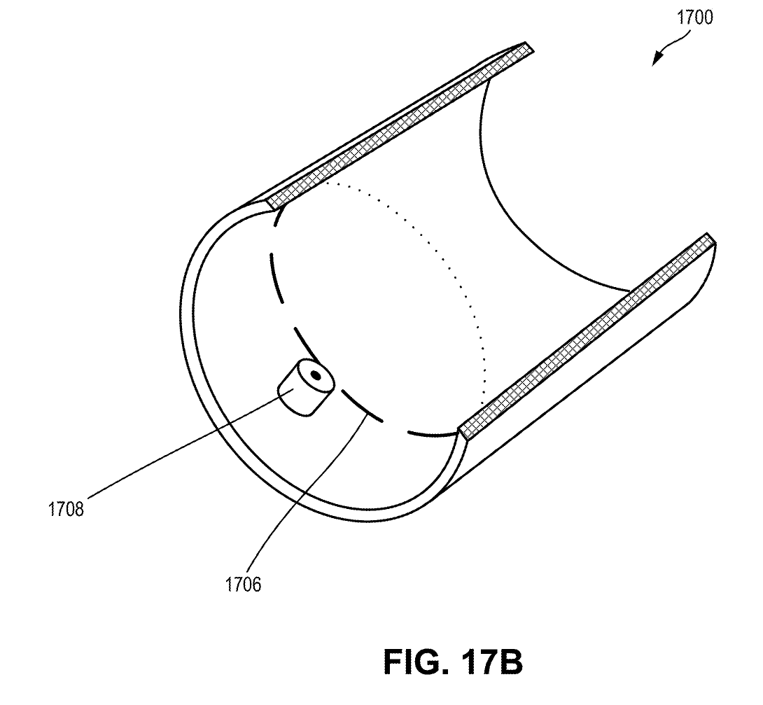

FIG. 17A illustrates a cutaway view of a combustion chamber 1700 showing where an annular plasma-distributing structure can be arranged, such as in annular combustor 1000. As discussed above, such a structure can be disposed along a circumference of the interior wall of the combustion chamber 1700. The solid, annular line 1702 in FIG. 17A represents where an edge of such an annular plasma-distributing structure would be located. In addition, a representative coaxial resonator 1704 is shown near the structure.

FIG. 17B illustrates a cutaway view of a combustion chamber 1700 showing where a plurality of plasma-distributing structure segments (such as segments 1610a-h of FIG. 16) can be arranged. As discussed above, such segments can be disposed along a circumference of the interior wall of the combustion chamber 1700. The dashed line 1706 in FIG. 17B represents edges of such segments. In addition, a representative coaxial resonator 1708 is shown near the structure.

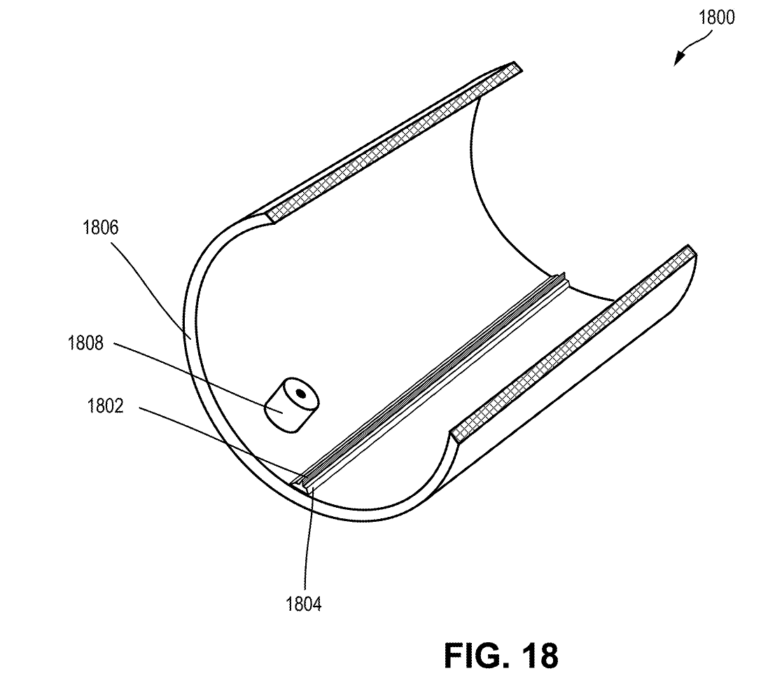

FIG. 18 illustrates a perspective view of a combustion chamber 1800 showing another possible arrangement of a plasma-distributing structure. As shown, an elongated, ridge-like plasma-distributing structure 1802 is located within the combustion chamber 1800 and coupled to a dielectric 1804. The dielectric 1804 is in turn coupled to the interior wall 1806 of the combustion chamber 1800. In addition, a representative coaxial resonator 1808 is shown near the structure.

In some implementations, multiple such elongated plasma-distributing structures can be disposed along the interior wall 1806 of the combustion chamber 1800. Further, in some implementations, one or more of such structures can extend the length of the combustion chamber 1800, in which case such structures can be configured to distribute a plasma corona along the length of the combustion chamber 1800. In other implementations, one or more of such structures can have a length that is less than the length of the combustion chamber 1800.

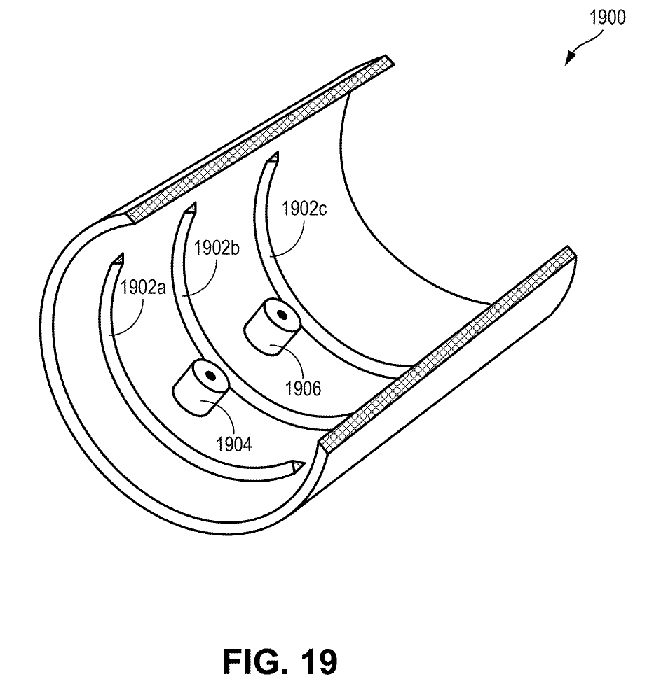

FIG. 19 illustrates a cutaway view of a combustion chamber 1900 including semi-annular plasma-distributing structures 1902a-c, each disposed along a portion of a circumference of the interior wall of the combustion chamber 1900. Further, in line with the discussion above, also shown are representative coaxial resonators: coaxial resonator 1904 arranged between structure 1902a and 1902b, and coaxial resonator 1906 arranged between structure 1902b and 1902c. Although not explicitly shown, each of structures 1902a-c is separated from the interior wall of the combustion chamber 1900 by an insulating material.

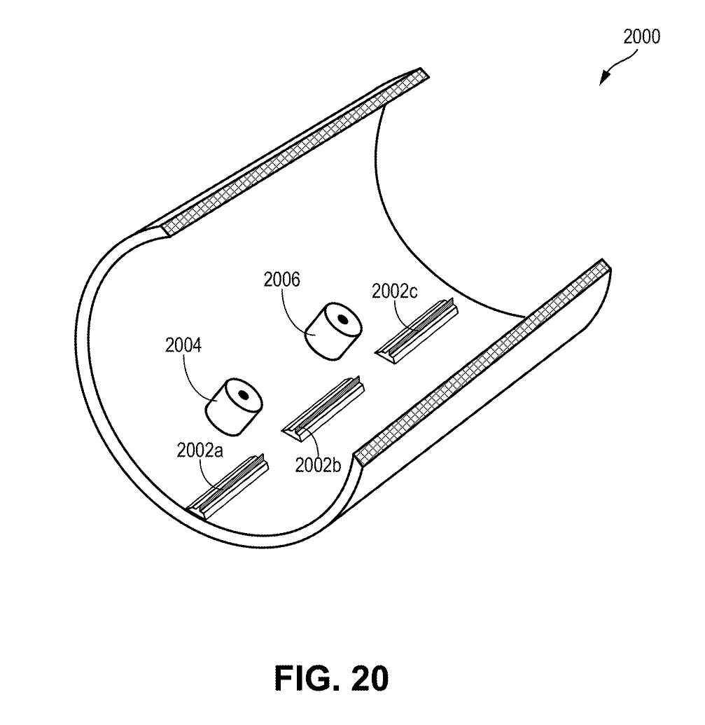

FIG. 20 illustrates a cutaway view of a combustion chamber 2000 including linear plasma-distributing structure segments 2002a-c, each disposed along a length of the interior wall of the combustion chamber 2000. Further, in line with the discussion above, also shown are representative coaxial resonators: coaxial resonator 2004 arranged between structure 2002a and 2002b, and coaxial resonator 2006 arranged between structure 2002b and 2002c. Although not explicitly shown, each of structures 2002a-c is separated from the interior wall of the combustion chamber 2000 by an insulating material.

In some implementations, the plasma-distributing structure can take the form of one or more helical ridges disposed around an interior wall of a combustion chamber, about a longitudinal axis of the combustion chamber. Plasma distribution using such a helical structure can provide various benefits in the context of ignition. For example, a helical plasma-distributing structure within the combustion chamber can increase the amount of time that a fuel/air mixture is in contact with a plasma corona, which can thereby increase performance and fuel economy.

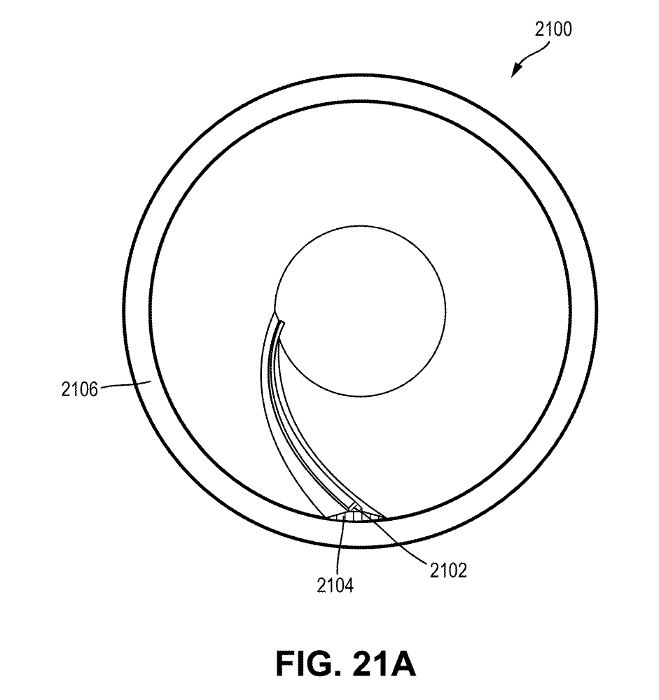

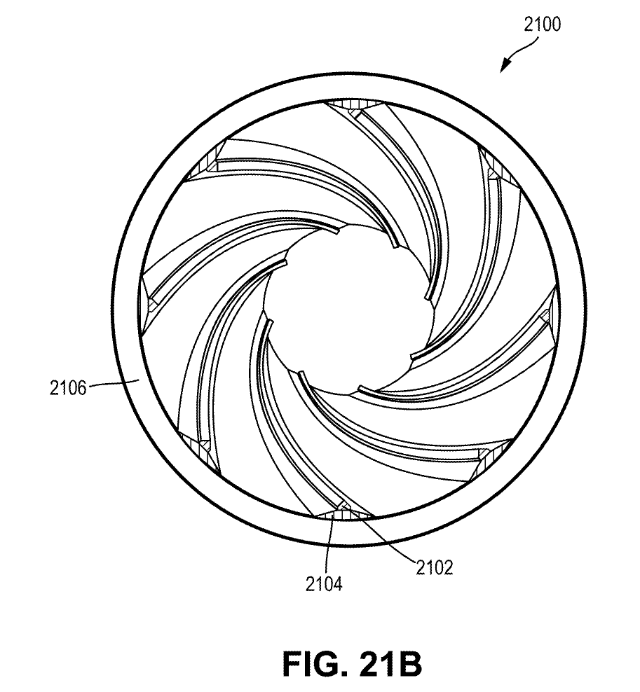

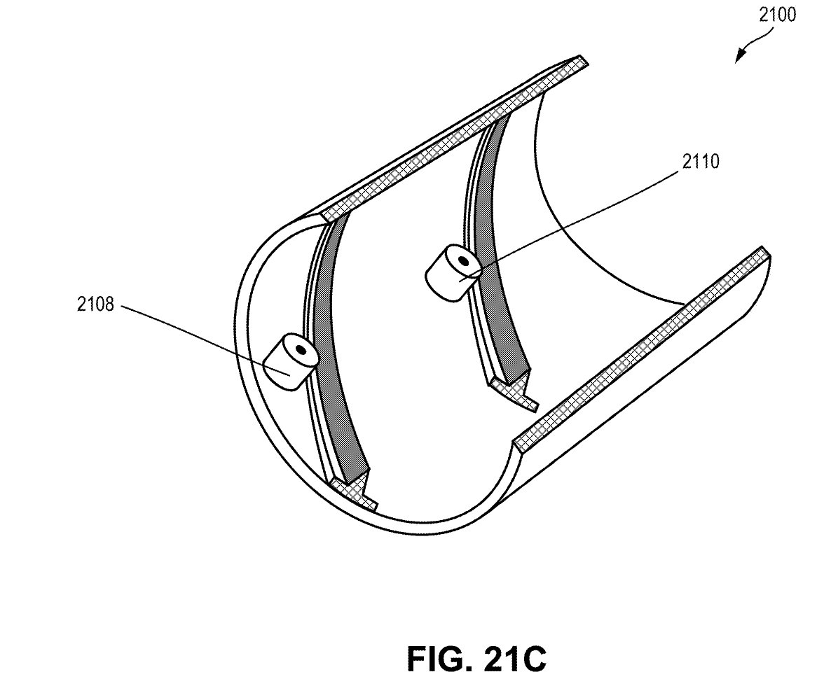

FIG. 21A illustrates a top-down view of a combustion chamber 2100. As shown, an elongated, ridge-like, helical plasma-distributing structure 2102 is located within the combustion chamber 2100 and coupled to a dielectric 2104. The dielectric 2104 is in turn coupled to the interior wall 2106 of the combustion chamber 2100.

In some implementations, multiple such helical plasma-distributing structures can be disposed along the interior wall 2106 of the combustion chamber 2100.

FIG. 21B is a top-down view of such an implementation, in which the combustion chamber 2100 includes multiple helical structures.

FIG. 21C is a cutaway view of another alternative implementation of the combustion chamber 2100 in which the combustion chamber 2100 includes multiple helical structures arranged differently than the helical structures in FIG. 21B. In addition, also shown in FIG. 21C are representative coaxial resonators 2108, 2110, each located near a respective helical structure.

As noted above, multiple different plasma-distributing structure configurations can be implemented in the same combustion chamber, one or more of which can include helical structures. In a particular example chamber that includes both helical structures and other structures, at least a portion of the length of the combustion chamber can include multiple helical plasma-distributing structures configured to be a primary source of plasma coronas for burning fuel. In addition, a portion of the combustion chamber can include an annular plasma-distributing structure configured for re-exciting plasma coronas at the helical plasma-distributing structures in case those plasma coronas go out, and perhaps additionally configured for burning any fuel that is unburnt by the time the fuel reaches the annular plasma-distributing structure. Other example implementations are possible as well.

Furthermore, in line with the discussion above, one plasma-distributing structure can be used to distribute an additional plasma corona to another plasma-distributing structure in various scenarios, such as when the plasma corona sustained at one of the two plasma-distributing structures goes out. In an example arrangement, an environment can include multiple plasma-distributing structures, where a first plasma-distributing structure is arranged proximate to where a plasma corona will be excited by a coaxial resonator and a second plasma-distributing structure is arranged proximate to where a plasma corona will be excited at the first plasma-distributing structure. As so arranged, and with the second plasma-distributing structure maintained at a predetermined voltage, excitation of an additional plasma corona at the first plasma-distributing structure can in turn cause excitation of yet another additional plasma corona at the second plasma-distributing structure.

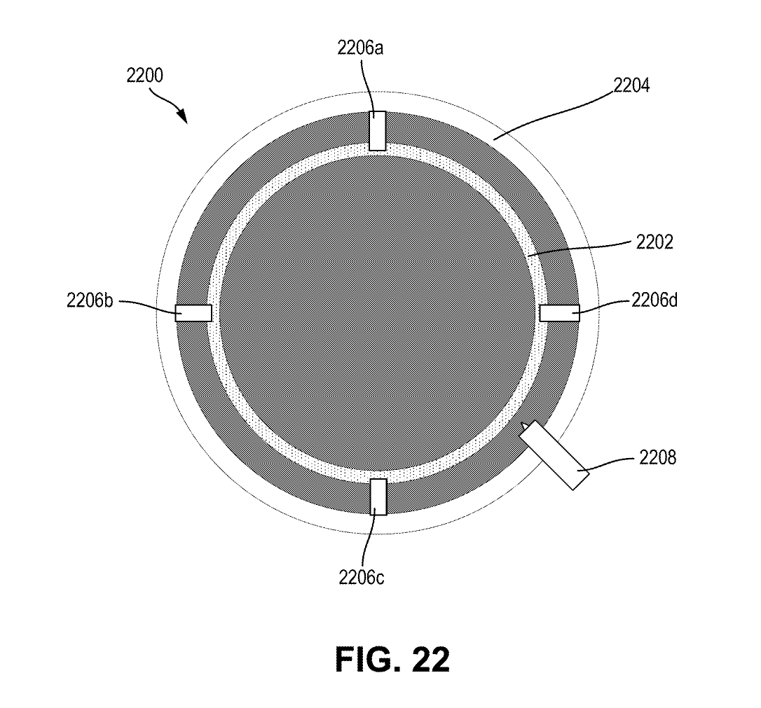

FIG. 22 illustrates a cross-sectional view of a combustion chamber 2200 within which an annular plasma-distributing structure 2202, such as a blade, is coupled to an interior wall 2204 of the combustion chamber 2200 by way of four struts 2206a-d made of insulating material. Each strut can be configured to couple to the plasma-distributing structure 2202 at one end of the strut. For instance, as shown, a portion of the plasma-distributing structure 2202 can be housed in each strut, such as in a slot. Further, each strut can be configured to couple to the interior wall 2204 at an opposite end of the strut. Still further, each strut can be configured to have dimensions that separate the annular plasma-distributing structure 2202 from the interior wall 2204 by a predetermined distance desired to avoid breakdown between the structure and the wall.

In some implementations, a plasma-distributing structure can be physically coupled to an electrode of a coaxial resonator. For instance, both the plasma-distributing structure and the electrode can be machined from the same material. In such implementations, the resonator system can include capacitors or other circuitry configured to control how the signal generator or other source of RF power impacts the voltage at which both the electrode and the plasma-distributing structure are maintained (for instance, such that the RF power does not negatively affect the voltage and lead to a plasma corona disappearing).

Furthermore, in any one or more of the implementations discussed in the present disclosure, fuel can be inputted into the combustion chamber by way of a fuel conduit. For instance, fuel can be inputted in a direction of the additional plasma corona(s) that is/are established at the plasma-distributing structure(s), although the fuel can additionally or alternatively be inputted in another direction. As a result, the additional plasma corona(s) can ignite the fuel (or, more particularly, a fuel/air mixture) so as to cause combustion of the fuel within the combustion chamber.

### X. Example Electrode/Concentrator Configurations for a Resonator

As a general matter, the electrode of the coaxial resonator can have a predetermined shape that is configured to affect the electric field concentration at the electrode, and thereby define an intensity, size, and/or shape of the plasma corona(s) excited by the coaxial resonator. In particular, the electrode of the coaxial resonator can be configured to include one or more concentrators—namely, portions of the electrode at which the electric field can be concentrated—each having a concentrator shape configured to define an intensity, size, and/or shape of the plasma corona(s) provided by the resonator. In some implementations, when the coaxial resonator is excited at or near resonance, an electromagnetic field can be highly concentrated near the one or more concentrators. These concentrators can be located at an end of the electrode that is distal to the location at which the electrode is electrically coupled to the inner conductor). Alternatively, concentrators can be located between the distal end of the electrode and the location at which the electrode is coupled to the inner conductor. Further, these concentrators can protrude or fan out from the electrode in a variety of directions. In some implementations, as discussed above, the electrode and one or more of its concentrators can protrude out, beyond the distal end of the outer conductor of the coaxial resonator, into the environment (for instance, a combustion chamber).

A concentrator can terminate at a point or edge. In some implementations, the concentrator can be tapered, whereas in other implementations the concentrator need not be tapered. In an example, the concentrator can taper to a tip (for example, the tip of a needle or tip of a cone) or can taper to a thin edge (for example, a sharp edge of a blade, or an edge of a top of a thin cylindrical rod). These and other examples can impact the plasma corona in various ways. For instance, in line with the discussion above, if a larger plasma corona is desired, a concentrator in the form of a blade edge can be more desirable compared to a concentrator that tapers to a thin, pin-or-needle-like point, as the blade edge can have a larger linear field concentration region, which can be configured to excite a longer plasma corona proximate to the blade edge.

In implementations where the concentrator includes an edge, the edge can be straight or curved in one or two dimensions. A concentrator can be shaped to include a single straight edge, such as a single blade edge, or a plurality of straight edges, such as a zigzag or sawtooth structure that includes straight edges having equal or varying lengths. A curved edge of a concentrator can take various forms. In some implementations, for instance, a curved edge of a concentrator can be cylindrically shaped, cone-shaped, wave-shaped, or helically shaped, arranged annularly about a center longitudinal axis of the inner conductor. Further, a curved edge of a concentrator can include an arc, or a complete circle, having a particular radius of curvature. As such, the radius of curvature can vary based on the desired field concentration and size of the plasma corona. For instance, a larger radius of curvature can result in a wider field concentration configured to excite a longer plasma corona proximate to the curved edge.

In some implementations, concentrators can protrude in one or more directions. For instance, a concentrator might protrude outward in a direction parallel to a longitudinal axis of the inner conductor and/or might protrude inward or outward in a direction perpendicular to the longitudinal axis of the inner conductor. In line with the discussion above, these protruding concentrators can have sawtooth structures, cone structures, needle structures, wave-shaped structures, and/or other types of structures that terminate at one or more points and/or edges.

Other concentrator configurations are possible as well. In one example, an electrode can include a concentrator in the form of two or more straight or curved blades whose points of intersection make up a straight or curved line, such as an X-shaped blade that tapers to straight edges that are distal to where the electrode is coupled to the inner conductor. In another example, a concentrator can include a plurality of thin needles that protrude away from the inner conductor, parallel to the longitudinal axis of the inner conductor and/or flared outward away from the longitudinal axis of the inner conductor. In a further example, a concentrator can include at least one cone that tapers away from the inner conductor, along and/or parallel to the longitudinal axis of the inner conductor, to a point. And in yet another example, an electrode can be toroid-shaped, which can include additional protruding concentrators in the shape of needles, cylindrical rods, cones, triangular blades, rectangular blades, etc. Concentrators can include other shapes as well, including but not limited to: hexagonal, flanged, tri-point, star, etc.

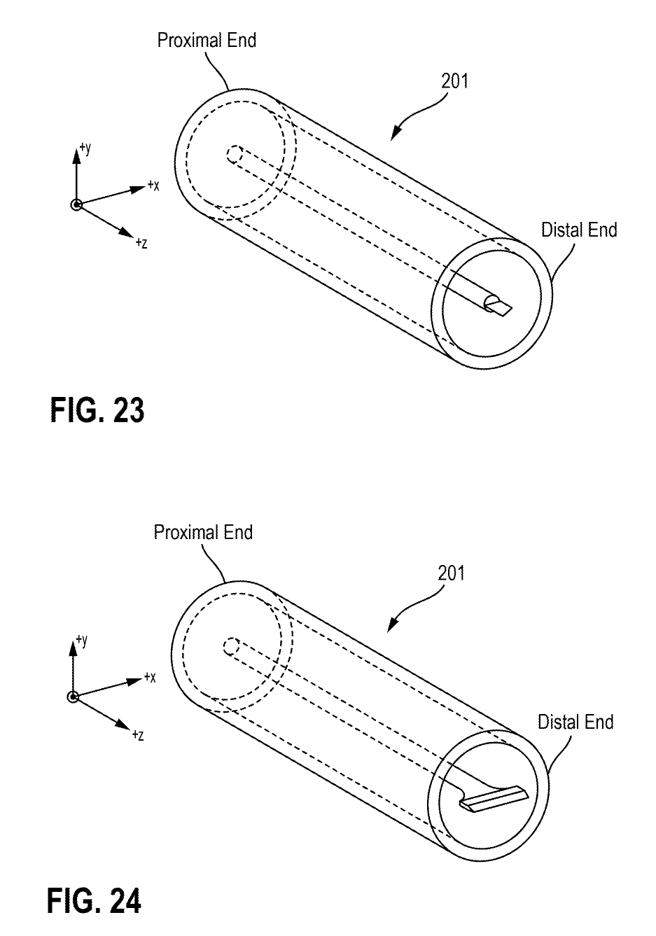

Without limitation, example concentrator configurations are illustrated in FIGS. 23-30. Each example is shown in the context of the coaxial resonator 201 of FIG. 2. Coaxial resonator 201 includes an outer conductor, an inner conductor, an electrode, and a dielectric. As noted above, it should be understood that, in some implementations, the electrode can be machined with the inner conductor as a single piece, and the electrode and the concentrator(s) can be electrically coupled to the inner conductor. Furthermore it should be understood that the concentrator(s) might or might not project beyond the distal end of the resonator.

FIG. 23 illustrates a perspective view of the coaxial resonator 201 having an electrode with a concentrator in the form of a thin blade that protrudes in the +z direction, away from a distal end of the inner conductor. In variations of this implementation, the inner conductor can taper to the thin blade by progressively transitioning from a cylinder to a flat blade that extends in the +z direction.

Similarly, FIG. 24 illustrates a perspective view of the coaxial resonator 201 having an electrode with a concentrator in the form of a wider and slightly thicker blade that protrudes in the +z direction, away from a distal end of the inner conductor, and that tapers to a thin edge. Further, the inner conductor tapers to the blade.

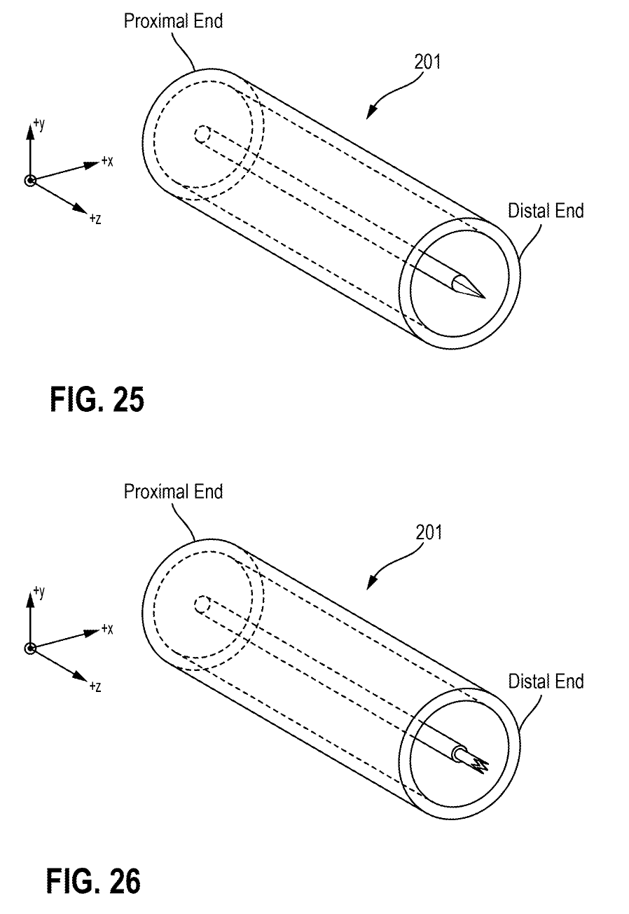

FIG. 25 illustrates a perspective view of the coaxial resonator 201 having an electrode with a concentrator in the form of a cone. In particular, once the inner conductor begins to protrude beyond the distal end of the outer conductor in the +z direction, the inner conductor progressively transitions from a cylinder to a cone.

FIG. 26 illustrates a perspective view of a coaxial resonator having an electrode with a hollow, cylindrical concentrator that is protruding outward from the inner conductor in the +z direction and whose terminus edge includes a plurality of sawtooth blades protruding in the +z direction and arranged annularly around a circumference of the concentrator.

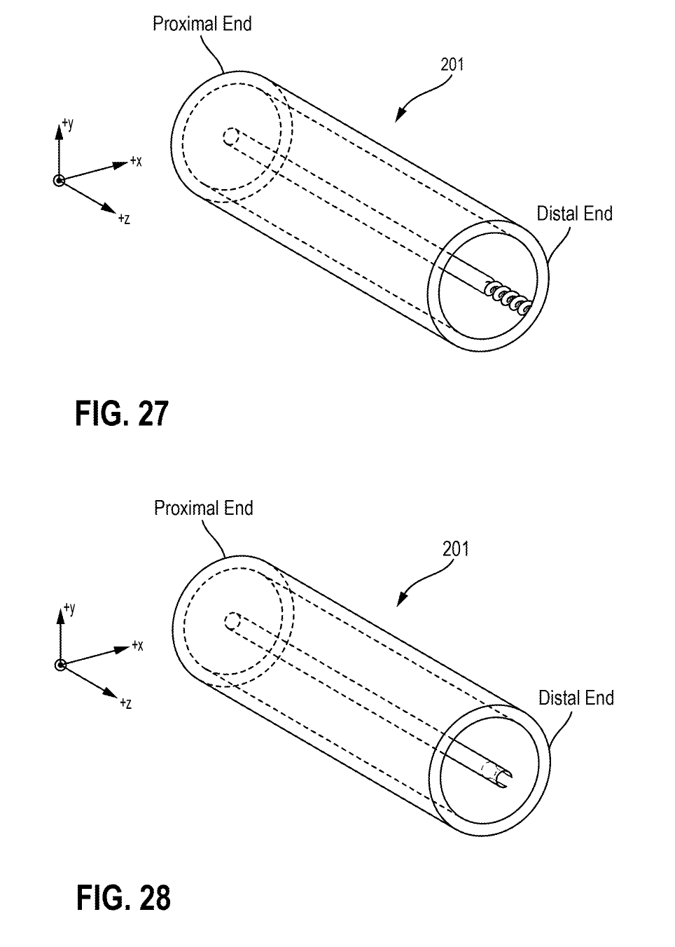

FIG. 27 illustrates a perspective view of a coaxial resonator having an electrode with a helically shaped concentrator, protruding outward from the inner conductor in the +z direction. Along a length of the concentrator, the concentrator tapers to curved edges, and a terminus of the concentrator tapers to a straight edge spanning the width of the concentrator. Further, as shown, each turn of the concentrator has the same radius of curvature. In other implementations, however, the turns of a helix structure can have different radii of curvature.

FIG. 28 illustrates a perspective view of a coaxial resonator having an electrode with a concentrator in the form of a portion of a thin, hollow cylinder that is protruding outward from the inner conductor in the +z direction and whose radius of curvature is equal to the radius of the inner conductor. Further, the concentrator has an arced terminus edge having a length less than a circumference of the cylinder.

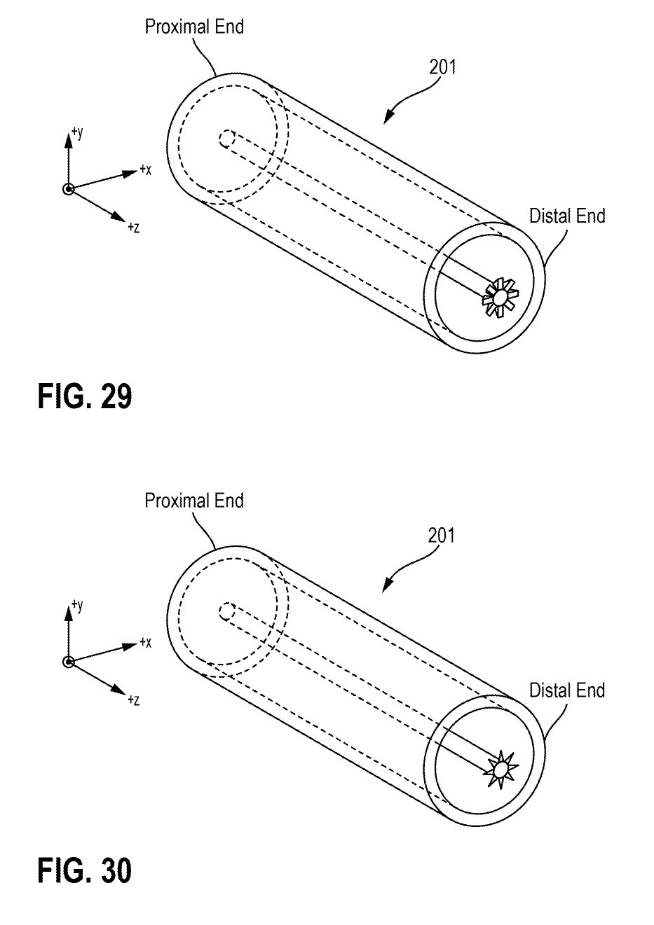

FIG. 29 illustrates a perspective view of the coaxial resonator 201 having an electrode with a plurality of rectangular-surface concentrators that protrude out of and away from the inner conductor in the +/−x directions and the +/−y directions, and that are arranged around the side of the inner conductor proximate to the distal end of the inner conductor. Further, each protruding concentrator has a straight edge. In variations of this implementation, a distal end of one or more of the concentrators can also be bent, angled, or flared so that they also extend in the +z direction, as opposed to being substantially parallel to the x-y plane.

FIG. 30 illustrates a perspective view of a coaxial resonator 201 having an electrode with pointed, triangular, blade-like concentrators that protrude out of and away from the inner conductor in the +/−x directions and the +/−y directions, and that are arranged annularly proximate to a circumference of the inner conductor. In variations of this implementation, a distal end of one or more of the concentrators can also be bent, angled, or flared so that they also extend in the +z direction, as opposed to being substantially parallel to the x-y plane.

### XI. Example Structures for Improved Fuel Combustion

As noted above, efficient and thorough combustion of fuel in a jet engine may improve various operating characteristics of the jet engine, including fuel efficiency, thrust levels, emissions, and transient response. One way to help achieve such efficient and thorough combustion is to guide the combustion of the fuel in the combustor of the jet engine.

As depicted in FIGS. 11 and 12, the combustor can have a proximal end facing a compressor of the jet engine and a distal end through which exhaust exits the combustor and enters a turbine of the jet engine. Fuel can be introduced into a combustion zone of the combustor to provide a combustible fuel/air mixture at or near the proximal end, and an igniter can be used to ignite the fuel/air mixture in the combustion zone.

When the combustible fuel/air mixture in the combustor is ignited, combustion of the fuel/air mixture can propagate along a flame path throughout the mixture. For instance, the igniter can ignite a portion of the fuel/air mixture that is proximate to the igniter, and the ignited fuel can generate a flame as the fuel heats and expands during combustion. The flame from the combusting fuel can heat nearby portions of the fuel/air mixture, thereby causing those nearby portions to also ignite and combust into a flame. As such, the combustion process can propagate throughout the fuel/air mixture as long as there is nearby combustible fuel/air mixture available to be combusted.

Without guidance, combustion may propagate along a flame path that leaves some unspent fuel in the combustor. For instance, as described above, fuel can be injected into the combustor in various ways to mix the fuel with air that enters the combustor from the compressor. The air from the compressor can enter the combustor at high speeds and can traverse the length of the combustor in a short amount of time. When the fuel is introduced into the air from the compressor, the fuel can also be accelerated to high speeds so that the fuel can also traverse the length of the combustor in a short amount of time. And when the fuel quickly traverses the length of the combustor, the fuel might not reside within the combustor long enough for combustion to propagate to all of the fuel before the fuel exits the combustor through the turbine.

One way to help address this issue can include guiding the fuel/air mixture along an elongated path so that it may take longer for the fuel to propagate through the combustor, thereby providing more time for combustion to propagate throughout the fuel before any unspent fuel exits the combustor. Examples of such elongated paths include paths that deviate from a straight path along the length of the combustor and/or multiple flame paths that extend along the length of the combustor. As noted above, combustion of the fuel can propagate to wherever there is nearby fuel to combust, so guiding the fuel/air mixture along the elongated path can also guide combustion of the fuel along an elongated flame path that partially or entirely coincides with the elongated path of the fuel/air mixture.

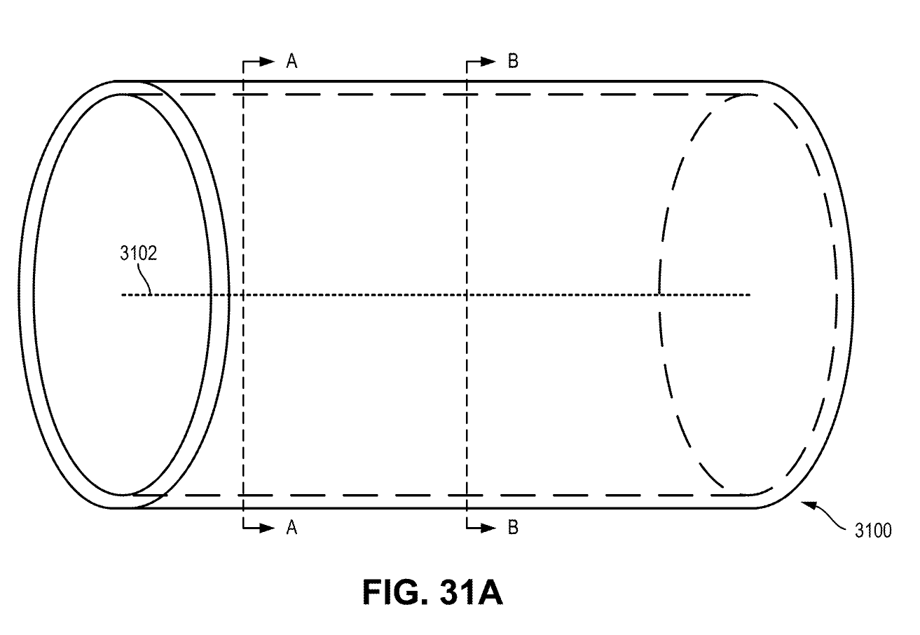

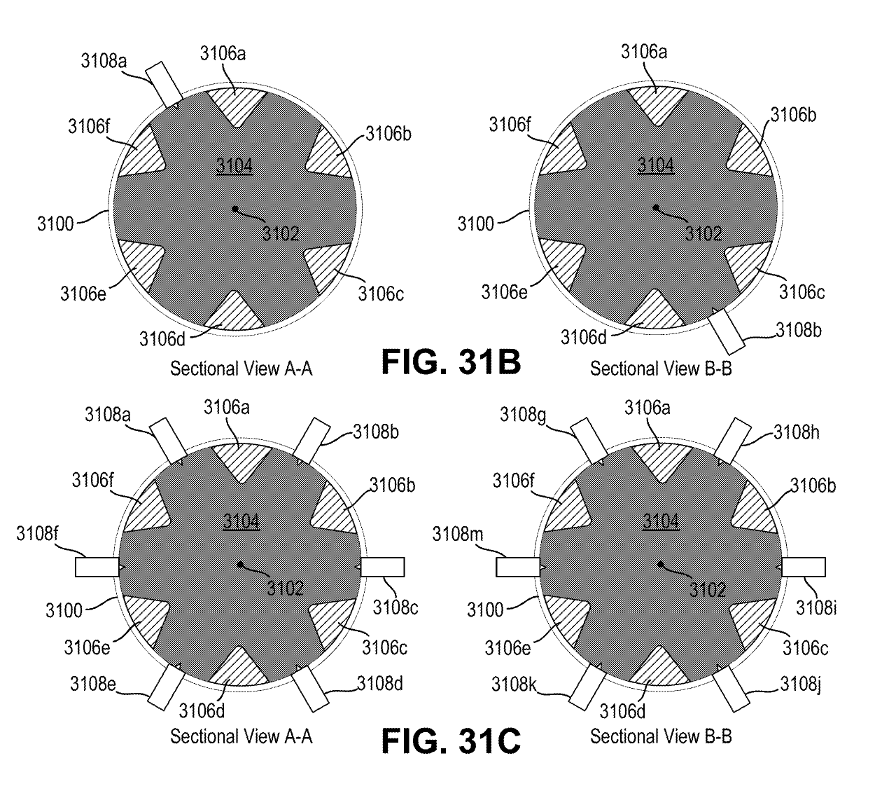

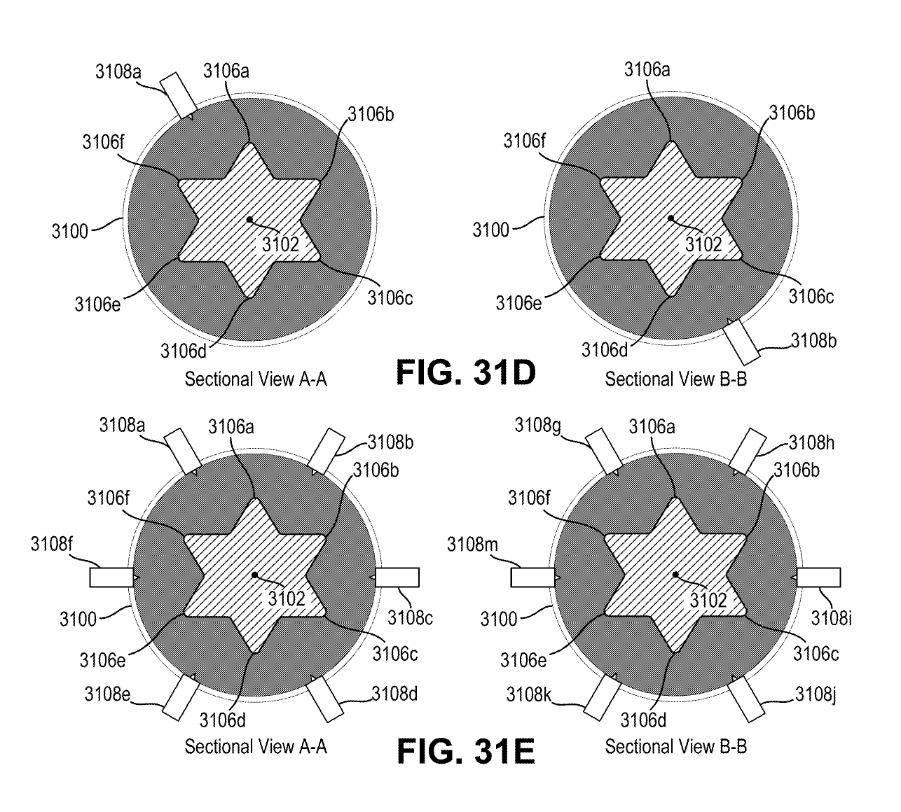

Example structures for guiding combustion along various flame paths will now be described particularly (by way of example) in the context of a cylindrical combustor, by reference to FIGS. 31A-E and 32A-E. It should be noted, however, that other combustor configurations are possible as well, including combustors of different shapes, such as rectangular-shaped combustors, funnel-shaped combustors, or the like. For instance, the combustor can be generally tubular in shape while having a diameter that varies along its length, similar to the combustor 904 depicted in FIGS. 11 and 12.

FIG. 31A illustrates an example combustor 3100. In some implementations, the combustor 3100 depicted in FIG. 31A can be a portion of a larger (for instance, longer) combustor 3100. FIGS. 31B-E illustrate multiple example cross-sectional views of the combustor 3100. Each cross-sectional view shows a cross-section of the combustor 3100 at a particular point along a length of the combustor 3100, the length running longitudinally and parallel to a longitudinal center axis 3102 of the combustor 3100. For instance, cross-section A-A is located near a proximal end of the combustor 3100, which can be near a fuel inlet that introduces fuel into the combustor. Cross-section B-B is located away from the proximal end of the combustor 3100 toward a distal end of the combustor 3100. In some examples, cross-section B-B can be located near a midpoint of the length of the combustor 3100. In other examples, cross-sections A-A and B-B can be located at various other points along the length of the combustor 3100.

Referring to FIG. 31B, example cross-sectional views of the combustor 3100 at cross-sections A-A and B-B are shown. In line with the discussion above, the combustor 3100 includes a combustion zone 3104 in which combustion of fuel occurs. As described above, in some implementations, a combustor can include a liner that surrounds and defines the combustion zone to act as a protective barrier that shields the interior walls of the combustor. Accordingly, in some implementations, the combustor 3100 can further include such a liner that surrounds and defines the combustion zone 3104.

In order to guide combustion of fuel in the combustion zone 3104, the combustor 3100 further includes a number of fins 3106a-f that protrude radially inward into the combustion zone 3104 toward the center axis 3102 of the combustor 3100. The fins 3106a-f can protrude radially inward from the interior walls of the combustor 3100, or in implementations of the combustor 3100 that include a liner, the fins 3106a-f can protrude radially inward from an interior surface of the liner. To enable the fins 3106a-f to safely protrude into the combustion zone 3104, the fins 3106a-f can be made from materials configured to withstand extended high temperature cycles, including various superalloys. The fins 3106a-f can extend partially or entirely along the length of the combustor 3100 and can be arranged in various patterns as described in more detail below. In each of the present examples, a total of six fins 3106a-f are shown, but other implementations can include additional or fewer fins, perhaps as few as one fin.

The fins 3106a-f can guide the fuel, and thus combustion of the fuel, by controlling a flow path for air that enters the combustor, such as by controlling a path of air that enters the combustor from the compressor of the engine. In particular, the fins 3106a-f define a number of channels between adjacent fins, and when air enters the combustor from the compressor, the fins 3106a-f can deflect the air and force the air into these channels. For instance, fin 3106a is offset from fin 3106b along a circumference of the combustor 3100 so that fins 3106a and 3106b define a channel between their radially-inward surfaces. And when air enters the combustion zone 3104, fins 3106a and 3106b can deflect at least some of the air into the channel defined between fins 3106a and 3106b. Air can similarly be directed into the remaining channels defined by the fins 3106a-f as well. When fuel is introduced into the combustion zone 3104, the fuel mixes with the air to form a fuel/air mixture. Thus, by directing the flow of air through the combustion zone 3104, the fins 3106a-f can also direct the flow of the fuel through the combustion zone 3104. In particular, the fins 3106a-f can direct the flow of the fuel along the channels defined by the fins 3106a-f. When the fuel is ignited, combustion of the fuel can propagate along the path of the fuel, such that combustion of the fuel can propagate along a flame path that partially or entirely coincides with the channels defined by the fins 3106a-f. In this manner, the channels defined by the fins 3106a-f can act as both a path for guiding fuel through the combustor 3100 and a flame path for guiding combustion of the fuel.

Further, directing portions of the fuel/air mixture along the channels defined by the fins 3106a-f can also cause other portions of the fuel/air mixture, such as portions of the fuel/air mixture closer to the center axis 3102 of the combustor 3100, to travel along a similar path. For instance, when various molecules of fuel or air move through the channels, they can collide with nearby molecules of fuel or air, and the collisions can transfer kinetic energy to those nearby molecules that cause the nearby molecules to move in a similar direction as the molecules in the channels, such as along a path that is approximately parallel to the channels. In some implementations, the fuel/air mixture near the center axis 3102 of the combustor 3100 can be further directed by extending the fins 3106a-f farther into the combustion zone 3104 toward the center axis 3102 of the combustor. Such extension of the fins 3106a-f can increase the cross-sectional areas of the channels defined by the fins 3106a-f, which can increase the amount of the fuel/air mixture that is directed into the channels. In some implementations, the fins 3106a-f can extend completely to the center axis 3102 and be joined at the center axis 3102, so that no other path outside of the channels exists for the fuel/air mixture. In this manner, all of the fuel and air introduced into the combustor 3100 can travel through the channels defined by the fins 3106a-f.

Fuel can be introduced into the combustion zone 3104 in various ways. In some implementations, one or more fuel inlets could be aligned with one or more of the fins 3106a-f and/or at least partially arranged within one or more of the fins 3106a-f. In particular, a fuel inlet could include or be arranged in a conduit through fin 3106a so that fuel passing through the fuel inlet could pass through fin 3106a to be introduced into the combustion zone 3104. In some implementations, the conduit could terminate at a tip of fin 3106a or at a sidewall of fin 3106a toward a channel adjacent to fin 3106a, such as the channel defined between fins 3106a and 3106b. In this manner, the fuel inlet could introduce the fuel proximate to the fins 3106a-f and/or at least partially along the flame path defined by the fins 3106a-f. For instance, the fuel inlet could introduce fuel through a sidewall of fin 3106a into the channel defined between fins 3106a and 3106b, or the fuel inlet could introduce fuel through the tip of fin 3106a toward the center axis 3102 of the combustor.

In line with the discussion above, a coaxial resonator can generate a plasma corona for igniting fuel in a jet engine combustor. Sectional view A-A of FIG. 31B includes a representative coaxial resonator 3108a configured to excite a plasma corona in the combustion zone 3104. In particular, a representative coaxial resonator can have a center conductor, an outer conductor, and a dielectric disposed between the center conductor and the outer conductor. An electrode, such as an electrode having a concentrator (for example a tip, a point, or an edge) for concentrating an electric field near the concentrator, can be electromagnetically coupled to the center conductor. For instance, as discussed above, the electrode and the concentrator can be electrically coupled to the center conductor or disposed sufficiently close to the center conductor that the electrode couples to one or more evanescent waves excited by the center conductor. The coaxial resonator then has a resonant wavelength based on an electrical length of the coaxial resonator. A radio-frequency power supply electromagnetically coupled to the coaxial resonator can then excite the coaxial resonator with a signal having a wavelength proximate to an odd-integer multiple of one-quarter of the resonant wavelength. This excitation can concentrate an electric field at the electrode, such as at the concentrator of the electrode, and can provide the plasma corona proximate to the electrode.

In the illustrated examples, at least a portion of the representative coaxial resonator can be coupled to and/or located within and/or proximate to the combustion zone 3104 and used to trigger excitation of a plasma corona within the combustion zone 3104. For instance, as depicted in FIG. 31B, the electrode of coaxial resonator 3108a extends into the combustion zone 3104 so that a plasma corona provided at the electrode of coaxial resonator 3108a is provided in the combustion zone 3104. In particular, coaxial resonator 3108a extends into the combustion zone 3104 between fins 3106a and 3106f so that the plasma corona provided by coaxial resonator 3108a can be provided between fins 3106a and 3106f.

In some implementations, various other configurations of the coaxial resonator can be used. For instance, resonator 3108a could be aligned with one or more of the fins 3106a-f and/or at least partially arranged within one or more of the fins 3106a-f. In particular, resonator 3108a could protrude into the combustor 3100 through fin 3106a or through a conduit in fin 3106a so that the electrode of resonator 3108a extends into the combustion zone 3104 from fin 3106a. In some implementations, the electrode of resonator 3108a could protrude from a tip of fin 3106a toward the center axis 3102, or the electrode of resonator 3108a could protrude from a side of fin 3106a toward a channel adjacent to fin 3106a, such as the channel defined between fins 3106a and 3106b. In this manner, resonator 3108a could provide a plasma corona proximate to the fins 3106a-f and/or at least partially along the flame path defined by the fins 3106a-f. For instance, resonator 3108a could provide the plasma corona at or near the tip of fin 3106a or into the channel defined between fins 3106a and 3106b.

Further, in some implementations, the coaxial resonator and/or a fuel inlet can be oriented so as to direct at least a portion of the fuel toward the electrode of the coaxial resonator. For example, a fuel injector can be configured to inject fuel through a fuel inlet in a fuel spray pattern, and the distal end of the electrode of coaxial resonator 3108a can be positioned within the fuel spray pattern. In this manner, when a radio-frequency power source excites coaxial resonator 3108a so as to provide a plasma corona in the combustion zone 3104, the plasma corona can ignite the fuel. For instance, the radio-frequency power source can excite coaxial resonator 3108a so as to provide a plasma corona proximate to the distal end of the electrode.

Further, in some implementations, an electrode of a coaxial resonator can be positioned downstream of a fuel inlet, such that the fuel that is input through the fuel inlet flows by the electrode and is ignited by the plasma corona. For instance, the fuel inlet can be positioned at a first position along the length of the combustor, and the electrode can be positioned at a second position along the length of the combustor, with the second position being closer to the distal end of the combustor than the first position. In addition, with this configuration, the fuel inlet can be positioned at a same or different angular position, relative to the center axis of the combustor, as the electrode.

Moreover, the orientation of a coaxial resonator with respect to a longitudinal axis of the combustor can vary, depending on the desired implementation. In an example, a longitudinal axis of the center conductor of coaxial resonator 3108a can be oblique to the longitudinal center axis 3102 of the combustor 3100, with a distal end of the center conductor being disposed toward a distal end of the combustor 3100. Orienting coaxial resonator 3108a in this manner can help to prevent fuel that is input into the combustor from blowing out the plasma corona. Alternatively, coaxial resonator 3108a can be oriented such that a longitudinal axis of the center conductor is perpendicular to the longitudinal center axis 3102 of the combustor 3100. Other examples are possible as well.

In any case, as described above, a coaxial resonator can provide a plasma corona in the combustion zone in order to ignite the fuel/air mixture and cause the fuel in the combustion zone to combust. As such, a plasma corona provided by coaxial resonator 3108a can ignite the fuel/air mixture in the channel defined between fins 3106a and 3106f. And because fins 3106a and 3106f can guide the fuel/air mixture through the channel defined between fins 3106a and 3106f, combustion of the fuel/air mixture can propagate along a flame path that coincides with the channel defined between fins 3106a and 3106f.

As further noted above, the fuel in the combustor may be combusted more thoroughly by elongating the fuel path and the flame path from combusting the fuel. In order to elongate the fuel path and the flame path, the fins 3106a-f can be arranged in various patterns that affect an overall length of the channels defined between the fins 3106a-f. For instance, in some implementations, the fins 3106a-f can be arranged in a helical or spiral pattern around the inner circumferential surface of the combustor 3100, similar to the rifling on the inside of a rifle barrel. By arranging the fins 3106a-f in a helical or spiral pattern, the channels defined between the fins 3106a-f can also be helical or spiral, and the fuel/air mixture that is deflected into the channels can travel along the helical or spiral paths of the channels. And when the fuel/air mixture in the channels is ignited, combustion can propagate throughout the fuel/air mixture in the channels along the helical or spiral pattern.

Sectional view B-B shows how the fins 3106a-f, when arranged in a helical or spiral pattern, can be rotationally offset from their positions at cross-section A-A at different cross-sections along the length of the combustor 3100. In particular, the fins 3106a-f at cross-section B-B are rotated clockwise by approximately 30-degrees relative to their positions at cross-section A-A. However, in other examples, the fins 3106a-f can be arranged in tighter or looser spiral patterns that result in a greater or lesser extent of rotation between cross-section A-A and cross-section B-B.

As further shown in sectional view B-B, one or more additional coaxial resonators similar to coaxial resonator 3108a can be included at various points along the length of the combustor 3100. For instance, sectional view B-B shows an additional coaxial resonator 3108b that is rotationally offset from coaxial resonator 3108a by approximately 180-degrees around the circumference of the combustor 3100. In line with the discussion above, coaxial resonator 3108b is aligned with and arranged within fin 3106c so that the electrode of resonator 3108b extends from the tip of fin 3106c to provide a plasma corona at or near the tip of fin 3106c. In other examples, coaxial resonator 3108b could be arranged within any of the fins 3106a-f or between any two of the fins 3106a-f and is not limited to being arranged within fin 3106c. In any case, coaxial resonator 3108b can supplement the combustion caused by coaxial resonator 3108a by providing an additional plasma corona to ignite any non-combusted fuel at or near coaxial resonator 3108b.

Further, in some implementations, multiple coaxial resonators similar to coaxial resonator 3108a can be included at various cross-sections along the length of the combustor 3100. For instance, as depicted in FIG. 31C, sectional view A-A can include six coaxial resonators 3108a-f arranged annularly around the circumference of the combustor 3100, each coaxial resonator positioned to provide a respective plasma corona in a respective channel between a respective pair of fins 3106a-f. Similarly, sectional view B-B can include an additional six coaxial resonators 3108g-m arranged annularly around the circumference of the combustor 3100, each coaxial resonator positioned to provide a respective plasma corona in a respective channel between a respective pair of fins 3106a-f. In other implementations, additional or fewer coaxial resonators could be included at cross-sections A-A and B-B. For instance, cross section A-A could include three coaxial resonators positioned to provide a respective plasma corona in alternating grooves, such as by including coaxial resonators 3108a, 3108c, and 3108e. Cross section B-B could similarly include three coaxial resonators positioned to provide a respective plasma corona in alternating grooves different from those in cross-section A-A, such as by including coaxial resonators 3108h, 3108j, and 3108m. Other examples are possible as well.

The coaxial resonators 3108a-m can be coupled to the combustor 3100 in various ways. For instance, the coaxial resonators 3108a-m can be coupled to the outer casing of the combustor 3100 and can extend through ports in the outer casing. In implementations where the combustor 3100 includes a liner, the coaxial resonators 3108a-m can be coupled to the liner and can extend through ports in the liner. Further, in some implementations, the coaxial resonators 3108a-m can be suspended within the combustor 3100. For instance, the combustor 3100 can include one or more brackets suspended in the combustor 3100 by one or more struts that extend from the outer casing of the combustor 3100, and the coaxial resonators 3108a-m can be mounted to the suspended brackets. The struts and/or the brackets can include conduits for electrical circuitry in order to electromagnetically couple the coaxial resonators 3108a-m to a radio-frequency power source for exciting the coaxial resonators 3108a-m as described above.

In these examples, any of the coaxial resonators at cross sections A-A and B-B can be selectively excited according to a desired sequence so as to provide plasma coronas at the desired sequence. For instance, each coaxial resonator can be electromagnetically coupled to a respective radio-frequency power source, and a controller can cause the respective radio-frequency power sources to excite the coaxial resonators in the desired sequence. In other examples, multiple coaxial resonators can be electromagnetically coupled to a single radio-frequency power source, and the controller can cause the single radio-frequency power source to selectively excite the coaxial resonators at the desired sequence.

The desired sequence can take various forms. For instance, referring to sectional view A-A in FIG. 31C, coaxial resonators 3108a-f can be excited sequentially in a clockwise or counter-clockwise sequence. As another example, some of the coaxial resonators, such as coaxial resonators 3108a, 3108c, and 3108e, can be excited at one time, and the remaining coaxial resonators 3108b, 3108d, and 3108f, can be excited at a subsequent time. Other examples are possible as well.

Further, in some implementations, coaxial resonators at different points along the length of the combustor 3100 can be excited at different times in accordance with the desired sequence. For instance, coaxial resonators at cross section B-B can be excited after coaxial resonators at cross section A-A. This can allow combustion to propagate from coaxial resonators at cross section A-A along the length of the combustor 3100 toward cross section B-B before exciting the coaxial resonators at cross section B-B. In some implementations, excitation of the coaxial resonators at cross section B-B can be delayed by a delay time that causes combustion propagating from coaxial resonators at cross section B-B to reach the distal end of the combustor at approximately the same time as combustion propagating from coaxial resonators at cross section A-A. The amount of delay time between exciting the coaxial resonators at cross section A-A and exciting the coaxial resonators at cross section B-B can depend on a velocity of the combustion propagation, which could depend on the type of fuel being combusted. For instance, for a given fuel, if it takes X milliseconds for combustion to propagate from cross section A-A to the distal end of the combustor and Y milliseconds for combustion to propagate from cross section B-B to the distal end of the combustor, then the coaxial resonators at cross section B-B can be excited Z milliseconds after the coaxial resonators at cross section A-A, where Z=X−Y.

FIGS. 31D and 31E illustrate other example cross-sectional views of the combustor 3100 at cross-sections A-A and B-B. In these examples, additional configurations of the fins 3106a-f are shown. Here, instead of protruding toward the center axis 3102 of the combustor 3100, the fins 3106a-f can be arranged centrally in the combustion zone 3104 and protrude radially outward, away from the center axis 3102 and toward the interior walls of the combustor 3100. The fins 3106a-f can be held in place in various ways. For instance, the fins 3106a-f can be suspended proximate to the center axis 3102 by using struts or some other type of standoffs that extend from the combustor 3100 or some other portion of the combustor. Further, while FIGS. 31D and 31E depict the fins 3106a-f as part of a single structure, in other examples the fins 3106a-f can be distinct structures. And, as noted above, the number, size, and shape of the fins 3106a-f can vary across examples and should not be limited to those depicted.

With the fins 3106a-f arranged centrally in the combustion zone 3104, the coaxial resonators 3108a-m can provide plasma coronas to ignite and combust the fuel in a similar manner as described above with respect to FIGS. 31B and 31C. In particular, the fins 3106a-f can define a number of channels between adjacent pairs of fins, such as between the radially outward surfaces of fins 3106a and 3106b. Air from the compressor can contact and be deflected by the fins 3106a-f, such that at least some of the air from the compressor is directed through the channels. When fuel is added to the air from the compressor to form a combustible fuel/air mixture, the fins 3106a-f similarly deflect the fuel/air mixture into the channels. And when the fuel/air mixture is ignited, combustion can propagate along the channels where the fuel/air mixture is present.

In the above examples, the fins 3106a-f are depicted as being triangular in shape. In particular, the fins 3106a-f are depicted as having sidewalls that define the channels between adjacent fins, and the sidewalls converge at the tips of the fins 3106a-f. As shown, the tips of the fins 3106a-f can be rounded or otherwise dulled. In line with the discussions above, high voltages can be applied to the electrodes of the resonators, and these high voltages can generate electric fields between the electrodes and various other conductive elements of the combustor 3100. By rounding the tips of the fins 3106a-f, the magnitude of the electric fields near the tips of the fins 3106a-f can be reduced, which can help reduce arcing between the electrodes and the fins 3106a-f. Further, in some implementations, the fins 3106a-f can take on other shapes. For instance, the fins 3106a-f can be rectangular, semicircular, or any other shape that can protrude into the combustion zone 3104 and define channels for guiding the flow of fuel and air through the combustor 3100.

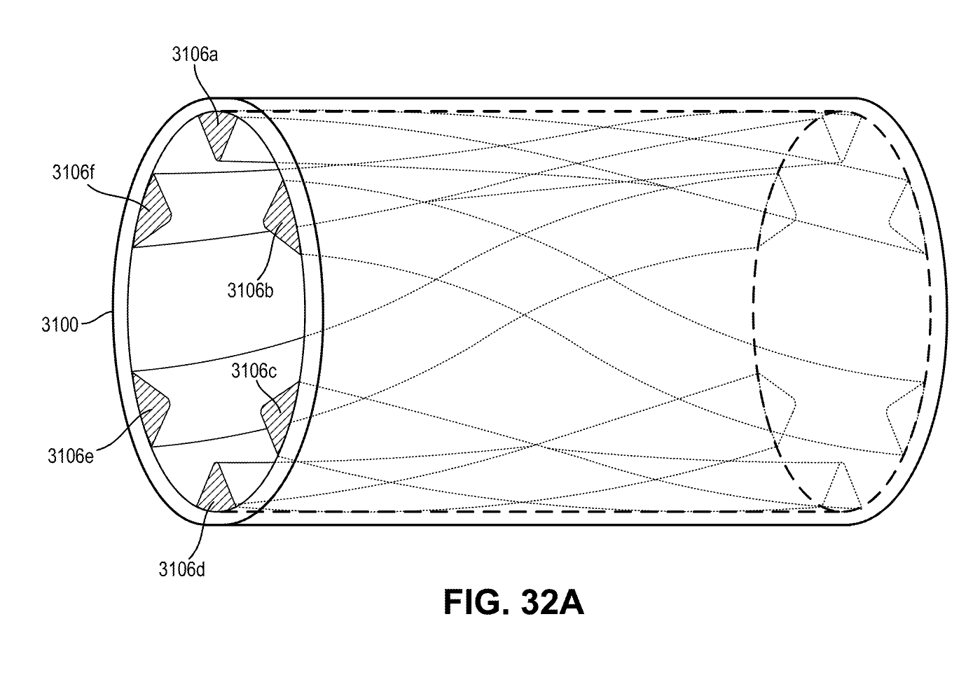

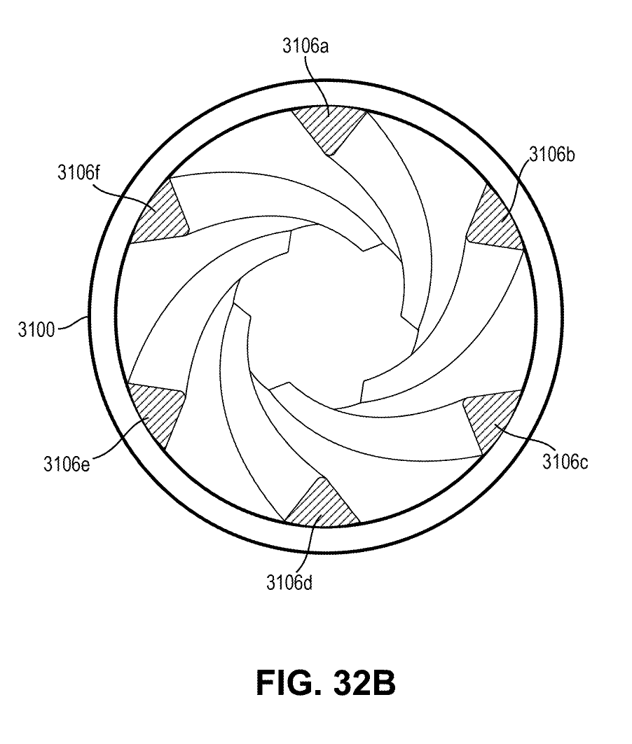

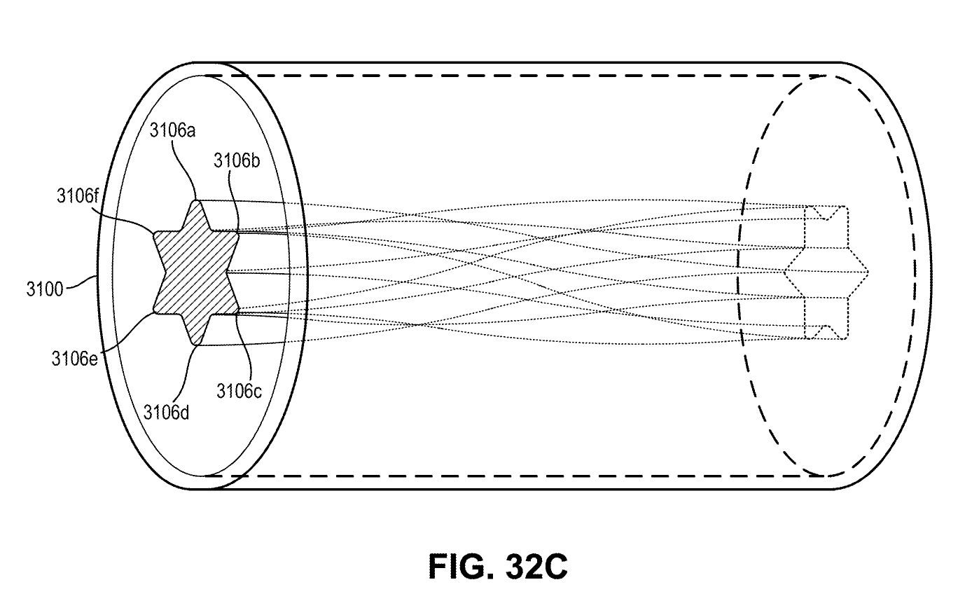

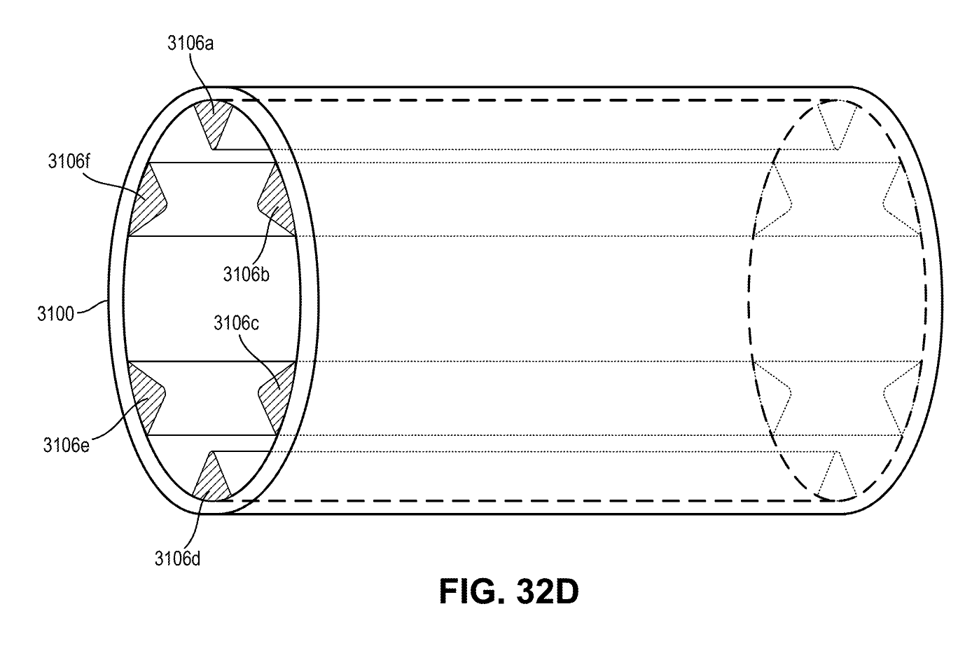

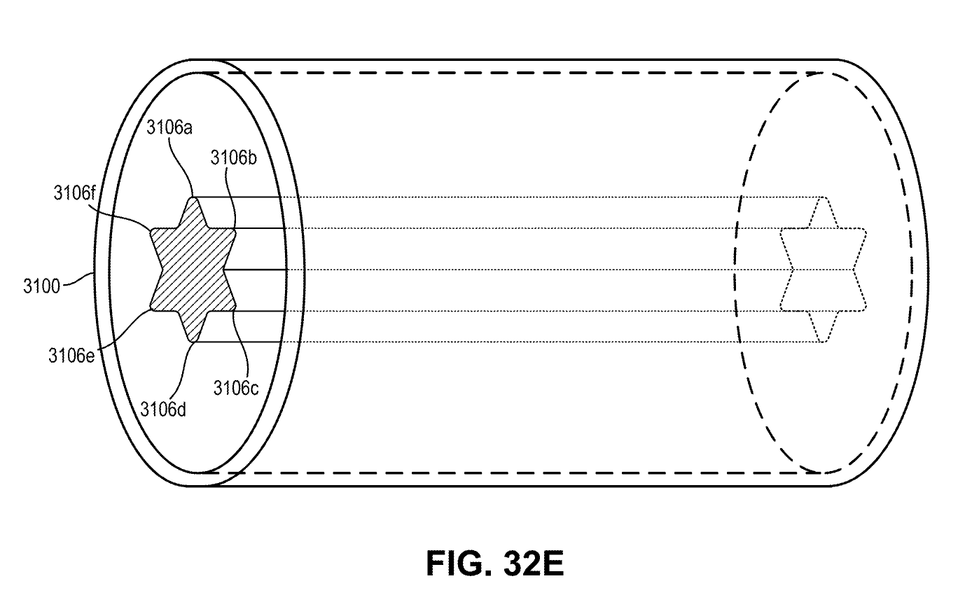

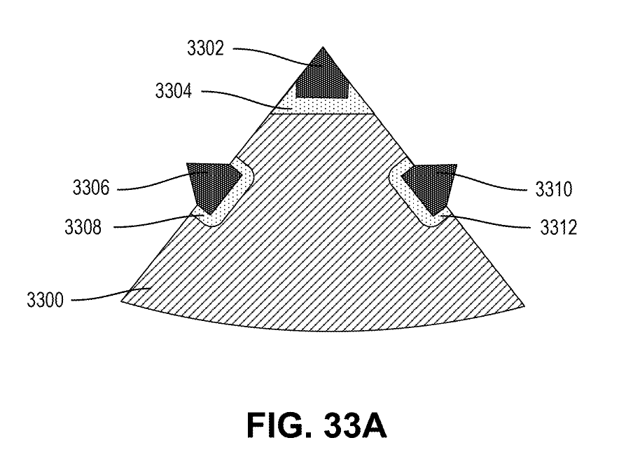

FIGS. 32A-32E next illustrate the combustor 3100 with various example configurations of fins 3106a-f for providing a flame path to guide combustion of fuel in the combustion zone 3104.

FIGS. 32A and 32B illustrate the combustor 3100 with fins 3106a-f protruding radially-inward from the inner surface of the combustor 3100, as described above with respect to FIGS. 31B and 31C. In particular, FIG. 32A illustrates a perspective view of the combustor 3100, and FIG. 32B illustrates an end-view of the combustor 3100, as viewed from the proximal end of the combustor 3100. FIG. 32C illustrates a perspective view the combustor 3100 with fins 3106a-f protruding radially-outward from the center axis of the combustor and toward the interior surface of the combustor 3100, as described above with respect to FIGS. 31D and 31E.

As depicted in FIGS. 32A-32C, and in line with the discussion above, the fins 3106a-f can be arranged in a helical or spiral pattern along the length of the combustor 3100. In particular, FIGS. 32A-32C show the fins 3106a-f rotating clockwise in a helical or spiral pattern by approximately 90-degrees over the length of the combustor 3100. However, in other examples, the fins 3106a-f can be arranged in a tighter or looser spiral pattern. For example, in some implementations, the fins 3106a-f can rotate less than 90-degrees over the length of the combustor 3100. And in other implementations, the fins 3106a-f can rotate more than 90-degrees over the length of the combustor 3100. For instance, the fins 3106a-f can undergo a full 360-degree rotation or even multiple rotations over the length of the combustor 3100.

With these example helical arrangements of fins 3106a-f, when the fuel/air mixture flows through the combustion zone 3104 inside the combustor 3100, the fuel/air mixture can be redirected by the fins 3106a-f along the helical channels defined by the fins 3106a-f, as described above. And when the fuel/air mixture is ignited, for instance using one or more coaxial resonators as described above, combustion of the fuel/air mixture can propagate throughout the fuel/air mixture along the helical channels defined by the fins 3106a-f, thereby forming a helical flame path. The helical flame path defined by the fins 3106a-f has a longer overall length than a linear flame path that extends the length of the combustor 3100. As such, by guiding the fuel along the helical path, it can take longer for the fuel to reach the distal end of the combustor, thereby providing additional time for combustion to propagate throughout the fuel along the helical flame path. This additional time for combustion can result in more thorough combustion of the fuel in the combustor.

In the above examples, redirecting the fuel/air mixture along a helical or other non-linear path can slow the rate at which the fuel/air mixture passes through the combustor, and this can cause a buildup in back-pressure exerted against the compressor as the compressor attempts to pump more air into the combustor. Accordingly, in some implementations, the combustor might not include fins arranged in a helical pattern, but could include fins arranged in other configurations instead.

FIGS. 32D and 32E, for instance, illustrate the combustor 3100 with fins 3106a-f arranged in a linear pattern along the length of the combustor 3100. In particular, FIG. 32D illustrates a perspective view of the combustor 3100 with linear fins 3106a-f protruding radially-inward from the inner surface of the combustor 3100, and FIG. 32E illustrates a perspective view of the combustor 3100 with linear fins 3106a-f protruding radially-outward from the center axis of the combustor and toward the interior surface of the combustor 3100.

While a linear arrangement of fins might not increase an overall length of travel for a fuel/air mixture as it passes through the combustor, the linear fins can still help improve the extent and uniformity of combustion in the combustor by providing multiple concurrent linear flame paths along which combustion can propagate. In particular, with respect to FIGS. 32D and 32E, linear fins 3106a-f can define a number of linear channels between adjacent pairs of fins 3106a-f. When air enters the combustor 3100 from the compressor, fins 3106a-f can deflect at least a portion of the air into the linear channels. One or more fuel inlets can introduce fuel into the combustor 3100 such that the fuel mixes with the air from the compressor to form a fuel/air mixture that is similarly deflected by fins 3106a-f into the linear channels as the fuel/air mixture traverses the length of the combustor 3100. One or more igniters, such as one or more of the coaxial resonators described above, can be used to ignite the fuel/air mixture in the linear channels, and combustion can propagate throughout the fuel/air mixture. Because the fuel/air mixture is directed along the linear channels, the combustion also propagates along the linear channels.

In some implementations, the combustor 3100 can include fin configurations that vary along the length of the combustor 3100. For instance, the combustor 3100 can include inwardly-protruding fins, such as those depicted in FIGS. 32A, 32B, and 32D, along a first segment of the length of the combustor 3100, and the combustor 3100 can include outwardly-protruding fins, such as those depicted in FIGS. 32C and 32E, along a second segment of the length of the combustor 3100. Additionally or alternatively, the combustor 3100 can include helical fins, such as those depicted in FIGS. 32A-32C, along a first segment of the length of the combustor 3100, and the combustor 3100 can include linear fins, such as those depicted in FIGS. 32D and 32E, along a second segment of the length of the combustor 3100. Any combination of these or other arrangements can be used as well.

In order to help further improve the extent and uniformity of combustion, the combustor 3100 can also include multiple fuel inlets to help distribute the fuel evenly among the linear channels and multiple igniters to help evenly distribute combustion of the fuel. For instance, multiple respective fuel inlets can be configured to introduce fuel into each respective linear channel defined by fins 3106a-f. Similarly, multiple respective coaxial resonators can be configured to provide a respective plasma corona into each respective linear channel defined by fins 3106a-f. In this manner, the fuel/air mixture can be distributed somewhat uniformly among the linear channels, and each linear channel of the fuel/air mixture can be concurrently ignited using the multiple coaxial resonators. Combustion can then propagate throughout the fuel/air mixture along each of the linear channels, thereby providing multiple concurrent flame paths—one for each channel. By concurrently combusting the fuel/air mixture over multiple flame paths, the overall combined length of the flame paths is longer than the length of the combustor 3100 itself, which can allow for more thorough combustion of the fuel/air mixture, as discussed above.

XII. Example Plasma-Distributing Structures in a Combustor with a Flame Path

In line with the discussion above, a combustor of a jet engine can include various structures for improving the efficiency and thoroughness of combustion in the combustor, which may improve various operating characteristics of the jet engine, such as fuel efficiency, thrust levels, emissions, and transient response. For instance, example combustors are described above in the context of guiding combustion along various paths by deflecting the fuel/air mixture in the combustor along one or more channels defined by protruding fins. Guiding combustion as described above can allow a flame to propagate more thoroughly throughout the fuel/air mixture, which can reduce an amount of unspent fuel that exits the combustor through the turbine. Further, example plasma-distributing structures are described above in the context of distributing a plasma corona to, and sustaining the plasma corona at, various locations in the combustor. As such, the example plasma-distributing structures can increase an amount of space within the combustor occupied by a plasma corona, which can expose a larger amount of the fuel/air mixture to the plasma corona for ignition and thereby increase the extent of combustion in the combustor.

Accordingly, in order to further improve fuel combustion in the combustor of the jet engine, plasma-distributing structures can be usefully employed in a jet turbine engine combustor having one or more fins that define a flame path for guiding combustion. Such plasma-distributing structures can be disposed at one or more locations along the length of the combustor—preferably within the flame path and/or in close proximity to the flame path—and can be used to increase an amount of space within the flame path that is occupied by a plasma corona, which can expose a larger amount of the fuel/air mixture to the plasma corona for ignition and thereby increase the extent of combustion in the combustor while the flame path guides the combustion.

As discussed above, to cause an additional plasma corona to be established at a plasma-distributing structure, the structure can be arranged proximate to where a plasma corona is provided, such as at or near a location of a plasma corona excited at a coaxial resonator and/or a plasma corona established at another such structure. Further, any such structure can be arranged such that, when dielectric breakdown occurs as described above, an additional plasma corona is established proximate to the plasma-distributing concentrator of the structure and at least partly within the flame path.

The shapes, sizes, and/or operating conditions of such plasma-distributing structures can be selected based on various factors, some of which can relate to conditions within and/or attributes of the combustor and/or other areas of the jet turbine engine. Example factors can include, but are not limited to: a shape of the combustor, a size of the combustor, an expected air pressure within the combustor, expected turbulence during travel, an expected speed of the aircraft, whether the combustor is connected to another combustor, and how far the structure might be from one or more coaxial resonators.

As an example, if an aircraft is predicted to travel at altitudes at which an air pressure in the combustor is predicted to exceed a predetermined threshold altitude, a controller can be configured to maintain a plasma-distributing structure in the combustor a at higher voltage, since a higher voltage might be needed to excite and then sustain an additional plasma corona at the plasma-distributing structure in higher-pressure scenarios. For instance, the controller can be configured such that, at a pressure of approximately 4 atmosphere (atm), the controller causes a plasma-distributing structure to be maintained at approximately 16 kV, whereas at a pressure of approximately 3 atm, the controller causes the plasma-distributing structure to be maintained at approximately 8 kV. Other examples are possible as well. Further, it will be understood that the operating conditions of the plasma-distributing structures, such as the predetermined voltage at which to maintain the plasma-distributing structures, can additionally or alternatively be selected based on the shape and/or size of the plasma-distributing structures.

In line with the discussion above, any plasma-distributing structure employed in a combustor having one or more fins defining a flame path can be coupled to a given fin or to the interior wall of the combustor by way of an insulating material, such as ceramic. As described above, such an insulating material can be configured to couple a plasma-distributing structure to the fin or to the interior wall of the combustor and also be configured to electrically insulate the plasma-distributing structure from the fin or from the interior wall of the combustor. In practice, the plasma-distributing structure can be coupled to the insulating material using any of the mechanical fixtures or other mechanical-based techniques described above, such as pressure fittings, threadings, tongue-in-groove structures, etc. Likewise, the insulating material and the fin (or the insulating material and the interior wall of the combustor) can be coupled using any such mechanical fixture or mechanical-based technique.

Furthermore, while a fin can be a conductor in some implementations (a superalloy, for instance), in alternative implementations, the fin can be a ceramic or other insulating material that can withstand high temperatures. In such implementations, a plasma-distributing structure can be coupled directly to the fin, though in variations of such implementations, still another insulating material can be disposed between the fin and the plasma-distributing structure.

In line with the discussion above, when one or more plasma-distributing structures are employed in a combustor having one or more fins that define a flame path, one or more coaxial resonators or other types of resonators can be used to trigger excitation of an additional plasma corona at each such plasma-distributing structure. Excitation of an additional plasma corona using a coaxial resonator can occur in any of the manners described above. Each such coaxial resonator could be arranged in any of the manners described above, or could be arranged in other manners. Additionally or alternatively to using coaxial resonators, any one or more of the techniques described above for directing a plasma corona, such as electromagnetism and air flow, could be employed in a combustor to facilitate establishing an additional plasma corona at any such structure within the combustor. Still additionally or alternatively, as discussed above, a plasma corona established at one such structure can be used to establish a plasma corona at another such structure.

Moreover, the electrode/concentrator of any coaxial resonator or other resonator included in a combustor having one or more fins can have various configurations, including, but not limited to, those described above. For example, a coaxial resonator can include an electrode having a sawtooth blade concentrator at which a plasma corona can be excited. Other examples are possible as well.

FIGS. 33A-33B depict example configurations of plasma-distributing structures in relation to a representative fin 3300 of a combustor. FIG. 33A, for instance, illustrates three example positions with respect to the fin 3300 at which a plasma-distributing structure can be disposed. In particular, structure 3302 is coupled to insulating material 3304, which is in turn coupled to a tip of the fin 3300. As shown, structure 3302 protrudes from the tip of the fin 3300 and includes a plasma-distributing concentrator that tapers to an edge. Further, structure 3306 is coupled to insulating material 3308, which is in turn coupled to a first side of the fin 3300, and structure 3310 is coupled to insulating material 3312, which is in turn coupled to a second side of the fin 3300. As shown, structure 3306 protrudes from the first side of the fin 3300, structure 3310 protrudes from the second side of the fin 3300, and structure 3306 and structure 3310 each include a plasma-distributing concentrator that tapers to an edge.

An example implementation can include any one or more of the three plasma-distributing structures depicted in FIG. 33A. Additionally or alternatively, a plasma-distributing structure can be positioned elsewhere with respect to the fin 3300. For example, a structure can be coupled to the fin 3300 at a position different from those depicted in FIG. 33A.

In operation, an additional plasma corona established at each plasma-distributing structure depicted in FIG. 33A can be at least partly within the flame path defined by the fin 3300. In some implementations, the flame path in which the additional plasma corona can be established can be defined by fin 3300 and one or more other fins of the combustor.

Next, FIG. 33B illustrates a perspective view of the fin 3300 showing various positions along the length of the fin 3300 at which plasma-distributing structures can be disposed. The fin 3300 shown in FIG. 33B can represent the entirety of a fin that is included in a combustor, or can represent a portion of such a fin. Further, although the fin 3300 is linear in FIG. 33B, it will be understood that the fin 3300 could additionally or alternatively be helical in shape or could take still other forms to help direct a flame path.

As shown, plasma-distributing structures 3314a-g are disposed at various positions along the length of the fin 3300. In line with the discussion above, each such structure can be considered to be one of a plurality of plasma-distributing structure segments, each having a respective plasma-distributing concentrator configured to sustain a respective additional plasma corona. In practice, each segment can be arranged proximate to where a plasma corona provided by a resonator or by another plasma-distributing structure would be. For example, a coaxial resonator (not shown) could be arranged within the combustor such that a plasma corona provided by the coaxial resonator would be proximate to structure 3314a. As another example, a plasma corona established at structure 3314a could cause a plasma corona to be established at structure 3314b without the assistance of a coaxial resonator. For instance, if structures 3314a and 3314b are positioned close enough, air flowing through the combustor in a direction from left to right may direct the plasma corona established by structure 3314a to be proximate to structure 3314b, which can cause a plasma corona to be established by structure 3314b when structure 3314b is at a sufficient voltage as discussed above. Other examples are possible as well.

An example implementation can include any one or more of plasma-distributing structures 3314a-g. Additionally or alternatively, one or more structures could be positioned elsewhere along the length of the fin 3300.

FIGS. 34A-34D illustrate the combustor 3100 with example configurations of fins 3106a-f for providing a flame path to guide combustion of fuel in the combustion zone. FIGS. 34A-34D additionally illustrate example ways in which one or more plasma-distributing structures can be integrated with the combustor 3100. In operation, an additional plasma corona could be established at respective plasma-distributing concentrators of such structures using one or more of the techniques described above. Each established additional plasma corona can be at least partly within the flame path defined by fins 3106a-f and used to assist with the combustion and guidance of fuel that is input into the combustor 3100.

FIGS. 34A-34C illustrate the combustor 3100 with fins 3106a-f protruding radially-inward from the inner surface of the combustor 3100, as described above with regard to FIG. 32B. In particular, FIGS. 34A-34C each illustrate an end-view of the combustor 3100, as viewed from the proximal end of the combustor 3100. As depicted in FIGS. 34A-34C, the fins 3106a-f can be arranged in a helical or spiral pattern along the length of the combustor 3100. In particular, similar to FIG. 32B described above, FIGS. 34A-34C show the fins 3106a-f rotating clockwise in a helical or spiral pattern by approximately 90-degrees over the length of the combustor 3100. However, as noted above, the fins 3106a-f can be arranged in a tighter or looser spiral pattern in other examples.

In line with the discussion above, FIGS. 34A-34C also depict examples of where plasma-distributing structures can be disposed in relation to the fins 3106a-f. In FIG. 34A, for example, plasma-distributing structures 3402a-f and insulating materials 3404a-f are disposed at each of the fins 3106a-f. For instance, insulating material 3404a is coupled to a top surface of fin 3106a, and structure 3402a is in turn coupled to insulating material 3404a. Further, structures 3402b-f and insulating materials 3404b-f are disposed in the same manner with regard to fins 3106b-f. As shown, each of the structures 3402a-f include plasma-distributing concentrators that taper to an edge.

As another example, in FIG. 34B, a plasma-distributing structure and an insulating material are disposed at some but not all of the fins, such as at every other fin, instead of at each of fins 3106a-f. For example, as shown in FIG. 34B, structure 3402b and insulating material 3404b are disposed at fin 3106b, structure 3402d and insulating material 3404d are disposed at fin 3106d, and structure 3402f and insulating material 3404f are disposed at fin 3106f. Each structure and insulating material shown in FIGS. 34A-34B has a helical or spiral pattern that mirrors that of the fin to which the structure and insulating material are coupled.

Further, as yet another example, in FIG. 34C, plasma-distributing structures 3402a-f and insulating materials 3404a-f are positioned between fins 3106a-f and protrude radially-inward from the interior wall of the combustor 3100 toward the center axis of the combustor 3100. For instance, insulating material 3404a is coupled to the interior wall and structure 3402a is in turn coupled to insulating material 3404a. Each of structures 3402b-f and insulating materials 3404b-f are coupled in the same manner. As shown, each of the structures 3402a-f includes a plasma-distributing concentrators that tapers to an edge.

Next, FIG. 34D illustrates a cross-sectional view of the combustor 3100 with fins 3106a-f protruding radially-outward from the center axis of the combustor 3100 and toward the interior wall of the combustor, similar to FIGS. 31D-31E, FIG. 32C, and FIG. 32E. In this example, fins 3106a-f could be arranged in a helical or spiral pattern along the length of the combustor 3100 as depicted in FIG. 32C, or could be arranged in a linear pattern along the length of the combustor 3100.

In line with the discussion above, FIG. 34D also depicts an example of where plasma-distributing structures can be disposed at fins 3106a-f. In particular, plasma-distributing structures 3402a-f and insulating materials 3404a-f are disposed at fins 3106a-f. For instance, insulating material 3404a is coupled to a top surface of fin 3106a, and structure 3402a is in turn coupled to insulating material 3404a. Further, structures 3402b-f and insulating materials 3404b-f are disposed in the same manner with regard to fins 3106b-f. Although not shown, it should be understood that, in other implementations, not every fin may include a plasma-distributing structure and insulating material. For instance, every other fin, or perhaps only one fin, can include such a structure and insulating material. Other examples are possible as well.

In some implementations, the desired plasma-distribution sequence described above can be applied in combustor of a jet turbine engine. A controller can cause a respective voltage to be provided to plasma-distributing structures in accordance with the sequence, so that conditions (such as an electric field concentrated at the structures) are suitable to cause additional plasma coronas to be established at the structures in accordance with the sequence. In practice, the controller can be programmed with data indicative of such a sequence, or can determine the sequence itself.

Such a sequence can be selected based on various factors that might be unique to a combustor of a jet turbine engine. For example, a sequence can be selected for use in a scenario in which a series of plasma-distributing structures are arranged in a combustor and define a desired path along which plasma coronas can propagate. In this scenario, the series of plasma-distributing structures can be powered according to the sequence, which can result in a sequential propagation of plasma coronas along the desired path. With respect to FIG. 33B, for instance, the sequence can be used to power plasma-distributing structures 3314a-g in the following order: 3314a, then 3314b, then 3314c, then 3314d, then 3314e, then 3314f, and lastly 3314g. As another example, a sequence can be selected to help prevent a flameout or partial flameout in a combustor in a scenario where a flameout or partial flameout might be likely (such as at threshold high altitudes). Other examples are possible as well.

### XIII. Example Methods

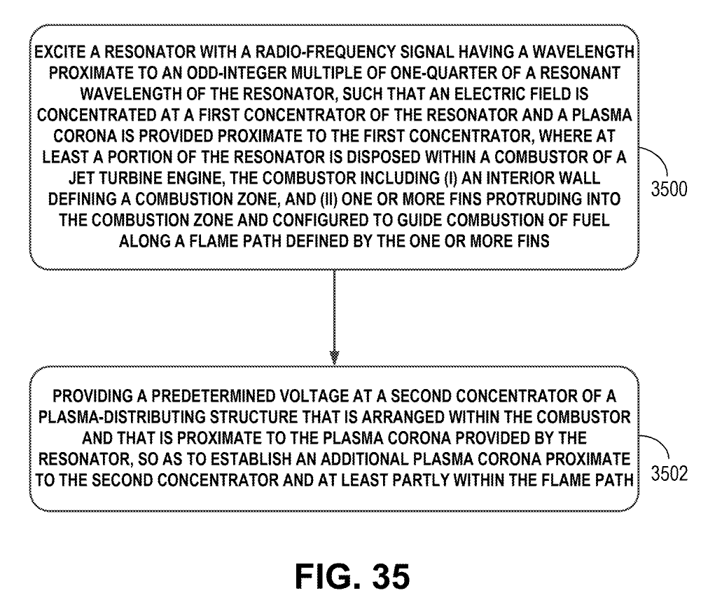

FIG. 35 is a flow chart depicting example operations of a representative method for controlling a system including a resonator and a plasma-distributing structure. By way of example, each of the example operations can be in line with the discussion above relating to plasma-distribution.

At block 3500, the method includes exciting a resonator with a radio-frequency signal having a wavelength proximate to an odd-integer multiple of one-quarter of a resonant wavelength of the resonator, such that an electric field is concentrated at a first concentrator of the resonator and a plasma corona is provided proximate to the first concentrator, where at least a portion of the resonator is disposed within a combustor of a jet turbine engine, the combustor including (i) an interior wall defining a combustion zone, and (ii) one or more fins protruding into the combustion zone and configured to guide combustion of fuel along a flame path defined by the one or more fins. As discussed above, the first concentrator can be a concentrator of an electrode of the resonator. Further, as discussed above, a radio-frequency power source configured to be electromagnetically coupled to the resonator can be further configured to excite the resonator in response to a controller instructing the radio-frequency power source to excite the resonator. Still further, as also discussed above, the arrangement of the one or more fins, and thus the flame path defined by the one or more fins, can take various forms. For example, the one or more fins can be arranged in a helical pattern to guide combustion of the fuel along a helical flame path. Additionally or alternatively, the one or more fins can protrude radially inward towards a center axis of the combustor.

At block 3502, the method includes providing a predetermined voltage at a second concentrator of a plasma-distributing structure that is arranged within the combustor and that is proximate to the plasma corona provided by the resonator, so as to establish an additional plasma corona proximate to the second concentrator and at least partly within the flame path.

As discussed above, any given plasma-distributing structure can be disposed at or protrude from a side of a fin or a tip of a fin. As also discussed above, the plasma-distributing structure can be coupled to an insulating material that is disposed between the plasma-distributing structure and an interior wall of the combustion chamber of the jet turbine engine. The insulating material can be configured to couple the plasma-distributing structure to the interior wall of the combustion chamber of the jet turbine engine. The insulating material can also be configured to electrically insulate the plasma-distributing structure from the interior wall of the combustion chamber of the jet turbine engine.

In some implementations, the plasma corona provided by the resonator can be directed to other locations with the help of electromagnetism, ferromagnetism, air flow through the jet turbine engine, and/or other techniques.

In some implementations, a common DC power source can provide the predetermined voltage at the second concentrator and also provide the predetermined voltage to the resonator as well. Alternatively, as another example, separate DC power sources can be used to provide the predetermined voltage at both the second concentrator and the resonator.

In some implementations, the combustor can also include at least one fuel inlet configured to introduce the fuel into the combustion zone for combustion. In such implementations, the method can include inputting, by a fuel conduit, through the at least one fuel inlet, the fuel into the combustion zone. When the fuel comes into contact with the additional plasma corona that is at least partly within the flame path, the additional plasma corona can ignite the fuel and cause combustion of the fuel (or, more particularly, a fuel/air mixture) along the flame path.

In some implementations, the plasma-distributing structure can include a plurality of segments, each having a respective second concentrator configured to sustain a respective additional plasma corona.

In some implementations, the plasma-distributing structure can be a first plasma-distributing structure of a plurality of such structures, and the predetermined voltage can be a first predetermined voltage. In such implementations, the combustor can include a second plasma-distributing structure. The second plasma-distributing structure can include a third concentrator and can be arranged within the combustor and proximate to where the additional plasma corona is established. As so arranged, the additional plasma corona established at the first plasma-distributing structure can be used to cause yet another plasma corona to be established at the second plasma-distributing structure at least partly within the flame path, provided that the third concentrator is at a second predetermined voltage (which may or might not be the same predetermined voltage as the first predetermined voltage). The first and second plasma-distributing structures can have similar or different shapes, sizes, orientations, etc., and can be positioned at various locations with respect to the one or more fins in the combustor, such as between two adjacent fins or protruding from a fin.

The particular arrangements shown in the figures should not be viewed as limiting. It should be understood that other implementations can include more or less of each element shown in a given figure. Further, some of the illustrated elements can be combined or omitted. Yet further, an illustrative implementation can include elements that are not illustrated in the figures.

A step or block that represents a processing of information can correspond to circuitry that can be configured to perform the specific logical functions of a method or technique as presently disclosed. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer-readable medium such as a storage device including a disk, hard drive, or other storage medium.

The computer-readable medium can also include non-transitory computer-readable media such as computer-readable media that store data for short periods of time like register memory, processor cache, and random access memory (RAM). The computer-readable media can also include non-transitory computer-readable media that store program code and/or data for longer periods of time. Thus, the computer-readable media can include secondary or persistent long term storage, like read only memory (ROM), optical or magnetic disks, compact-disc read only memory (CD-ROM), for example. The computer-readable media can also be any other volatile or non-volatile storage systems. A computer-readable medium can be considered a computer-readable storage medium, for example, or a tangible storage device.

While various examples and implementations have been disclosed, other examples and implementations will be apparent to those skilled in the art. The various disclosed examples and implementations are for purposes of illustration and are not intended to be limiting, with the true scope being indicated by the claims.

What is claimed is:

1. A system comprising:
a combustor of a jet turbine engine, the combustor including (i) an interior wall defining a combustion zone, and (ii) one or more fins protruding into the combustion zone and configured to guide combustion of fuel along a flame path defined by the one or more fins;
a radio-frequency power source;
a resonator configured to be electromagnetically coupled to the radio-frequency power source and having a resonant wavelength, the resonator including:
a first conductor,
a second conductor,
a dielectric between the first conductor and the second conductor, and
an electrode configured to be electromagnetically coupled to the first conductor and including a first concentrator, wherein the resonator is configured to provide a plasma corona proximate to the first concentrator when excited by the radio-frequency power source with a signal having a wavelength proximate to an odd-integer multiple of one-quarter (¼) of the resonant wavelength; and
a plasma-distributing structure including a second concentrator, the plasma-distributing structure being arranged within the combustor and proximate to where the plasma corona is provided by the resonator,
wherein when the radio-frequency power source excites the resonator with the signal, an electric field is concentrated at the first concentrator and the plasma corona is provided proximate to the first concentrator, and
wherein when the plasma corona is provided proximate to the first concentrator and the plasma-distributing structure is at a predetermined voltage, an additional plasma corona is established proximate to the second concentrator and at least partly within the flame path.

2. The system of claim 1, wherein the flame path is a helical flame path, and wherein the one or more fins are arranged in a helical pattern to guide combustion of the fuel along the helical flame path.

3. The system of claim 1, wherein the flame path is a linear flame path, and wherein the one or more fins are arranged in a linear pattern to guide combustion of the fuel along the linear flame path.

4. The system of claim 1, wherein the one or more fins protrude radially inward from the interior wall toward a center axis of the combustor.

5. The system of claim 1, wherein the one or more fins are suspended in the combustion zone proximate to a center axis of the combustor.

6. The system of claim 1, the combustor further including at least one fuel inlet configured to introduce the fuel into the combustion zone for combustion,
wherein when the fuel is introduced into the combustion zone, one or more of the plasma corona or the additional plasma corona causes combustion of the fuel along the flame path.

7. The system of claim 6, wherein the at least one fuel inlet is aligned with the one or more fins so as to introduce the fuel (i) proximate to the one or more fins and (ii) at least partially along the flame path.

8. The system of claim 6, wherein the at least one fuel inlet is at least partially arranged within the one or more fins.

9. The system of claim 1, further comprising a controller configured to carry out operations that include:
causing the predetermined voltage to be provided at the second concentrator; and
causing the radio-frequency power source to excite the resonator with the signal.

10. The system of claim 1, wherein the resonator is selected from the group consisting of: a coaxial resonator, a dielectric resonator, a rectangular-waveguide cavity resonator, a parallel-plate resonator, and a gap-coupled microstrip resonator.

11. The system of claim 1, further comprising a direct-current power source configured to provide the predetermined voltage at the first concentrator and the second concentrator.

12. The system of claim 1, wherein the second concentrator tapers to an edge or a point.

13. The system of claim 1, wherein the plasma-distributing structure is disposed at a given fin of the one or more fins.

14. The system of claim 13, wherein the plasma-distributing structure protrudes from the given fin into the flame path.

15. The system of claim 14, wherein the plasma-distributing structure protrudes from a tip of the given fin.

16. The system of claim 1, further comprising an insulating material configured to couple the plasma-distributing structure to a given fin of the one or more fins and further configured to electrically insulate the plasma-distributing structure from the given fin.

17. The system of claim 1, wherein the one or more fins include two fins, wherein the plasma-distributing structure is positioned at the interior wall, between the two fins, and protrudes radially inward from the interior wall toward a center axis of the combustor.

18. The system of claim 1, wherein a shape of the second concentrator is selected to cause the additional plasma corona to have a predetermined shape.

19. The system of claim 1, wherein the plasma-distributing structure includes a plurality of segments, each having a respective second concentrator configured to sustain a respective additional plasma corona.

20. The system of claim 19, wherein each segment of the plurality of segments is electrically coupled to a direct-current power source, the system further comprising a controller configured to carry out operations including:
causing the direct-current power source to sequentially bias the respective segments with the predetermined voltage, according to a desired plasma-distribution sequence, so as to cause the additional plasma corona to be established sequentially at the respective segments according to the desired plasma-distribution sequence.

21. The system of claim 20, wherein the direct-current power source includes a plurality of direct-current power sources, each corresponding to a respective segment of the plurality of segments and configured to bias the respective segment with the predetermined voltage.

22. The system of claim 20, wherein the direct-current power source includes:
a single direct-current power source configured to bias the plurality of segments with the predetermined voltage.

23. The system of claim 20, wherein the direct-current power source further includes:
a plurality of switches, each switch of the plurality of switches corresponding to a respective segment and being configured to control biasing of the respective segment with the predetermined voltage.

24. The system of claim 1, wherein the plasma-distributing structure is a first plasma-distributing structure and the predetermined voltage is a first predetermined voltage, the system further comprising:
a second plasma-distributing structure including a third concentrator, the second plasma-distributing structure being arranged within the combustor and proximate to where the additional plasma corona is established,
wherein when the additional plasma corona is established and the second plasma-distributing structure is at a second predetermined voltage, another additional plasma corona is established proximate to the third concentrator and at least partly within the flame path.

25. A system comprising:
a combustor of a jet turbine engine, the combustor including (i) an interior wall defining a combustion zone, and (ii) one or more fins protruding into the combustion zone and configured to guide combustion of fuel along a flame path defined by the one or more fins;
a radio-frequency power source; and
a resonator configured to be electromagnetically coupled to the radio-frequency power source and having a resonant wavelength, the resonator including:
a first conductor,
a second conductor,
a dielectric between the first conductor and the second conductor, and
an electrode configured to be electromagnetically coupled to, and disposed at, a distal end of the first conductor, the electrode including a concentrator disposed within the combustor and having a concentrator shape configured to define a shape of a plasma corona provided by the resonator,
wherein the resonator is configured such that, when the resonator is excited by the radio-frequency power source with a signal having a wavelength proximate to an odd-integer multiple of one-quarter (¼) of the resonant wavelength, the resonator provides the plasma corona proximate to the concentrator and at least partly within the flame path.

26. The system of claim 25, further comprising a controller configured to carry out operations, the operations including:
causing the radio-frequency power source to excite the resonator with the signal.

27. The system of claim 25, wherein the concentrator shape defines a structure selected from the group consisting of: a single linear blade, a single curved blade, a cross-shaped blade, one or more sawtooth protrusions, one or more cone protrusions, one or more needle protrusions, one or more helical protrusions, and one or more wave-shaped protrusions.

28. A method comprising:
exciting a resonator with a radio-frequency signal having a wavelength proximate to an odd-integer multiple of one-quarter (¼) of a resonant wavelength of the resonator, such that an electric field is concentrated at a first concentrator of the resonator and a plasma corona is provided proximate to the first concentrator, wherein at least a portion of the resonator is disposed within a combustor of a jet turbine engine, the combustor including (i) an interior wall defining a combustion zone, and (ii) one or more fins protruding into the combustion zone and configured to guide combustion of fuel along a flame path defined by the one or more fins; and
providing a predetermined voltage at a second concentrator of a plasma-distributing structure that is arranged within the combustor and that is proximate to the plasma corona provided by the resonator, so as to establish an additional plasma corona proximate to the second concentrator and at least partly within the flame path.

29. The method of claim 28, the combustor further including at least one fuel inlet configured to introduce the fuel into the combustion zone for combustion, the method further comprising:
inputting, by a fuel conduit, through the at least one fuel inlet, the fuel into the combustion zone, whereby the additional plasma corona that is at least partly within the flame path ignites the fuel so as to cause combustion of the fuel along the flame path.
